(19) United States
(12) Patent Application Publication
(10) Pub. No.: US 2025/0013715 A1
(43) Pub. Date: Jan. 9, 2025

(54) METHODS AND SYSTEMS FOR SOLVING A PROBLEM USING QUBIT COUPLED CLUSTER AND BINARY ENCODING OF QUANTUM INFORMATION

(71) Applicant: OTI LUMIONICS INC., Mississauga (CA)

(72) Inventors: Artur IZMAYLOV, Mississauga (CA); Robert A. LANG, Mississauga (CA); Scott Nicholas GENIN, Mississauga (CA); IIya RYABINKIN, Mississauga (CA)

(73) Assignee: OTI LUMIONICS INC., Mississauga, ON (CA)

(21) Appl. No.: 18/708,567

(22) PCT Filed: Nov. 10, 2022
(86) PCT No.: PCT/IB2022/060806

§ 371 Date: May 8, 2024

Related U.S. Application Data
(60) Provisional application No. 63/277,784, filed on Nov. 10, 2021.
(60) Provisional application No. 63/278,368, filed on Nov. 11, 2021.

(51) Int. Cl. G06F 17/16

(52) U.S. Cl. CPC G06F 17/16

(57) ABSTRACT

A method for encoding quantum information comprising at least one Kronecker product of Pauli X, Y, Z matrices, an identity matrix e and a phase term comprises providing binary indices for each term and using them in a binary representation of the Kronecker product, including first and second arrays corresponding to respective digits of a two-digit binary code. The encoding method provides computational and storage advantages. A set of ILC entanglers can be generated using the encoding method. Entanglers encoded in a binary representation can be conveniently prioritized and selected for a provided Hamiltonian, including in a multiple loop iterative fashion, to provide a set of quantum logic gates in a quantum circuit of a quantum computer.

### RELATED APPLICATIONS

The present disclosure is a US national stage application under 35 U.S.C. § 371 of International Application No. PCT/US2022/060806, filed on Nov. 10, 2022, which claims the benefit of priority to US Provisional Patent Application Nos. 63/277,784 filed Nov. 10, 2021 and 63/278,368 filed Nov. 11, 2021, the contents of each of which are incorporated herein by reference in their entirety.

### TECHNICAL FIELD

The present disclosure relates to quantum computation under a Variational Quantum Eigensolver (VQE) framework, and in particular, relates to methods and systems to improve a process of finding a solution of a problem using at least one of: a quantum computer and a quantum-inspired algorithm, and encoding of quantum information.

### BACKGROUND

A large number of practical applications, including without limitation, molecular simulation in chemistry, big data analysis in finance services, and pattern recognition in machine leaning, may involve a computational problem.

In some non-limiting examples, these computational problems may be complicated and challenging, and expose limitations of classical computers in various aspects, including without limitation, processing power, processing time, and computational cost. In some non-limiting examples, computation using at least one of: a classical computer, and a conventional numerical method, may suffer from scaling issues, and an exact solution may scale with a system size, in some non-limiting examples, exponentially, which may not be processed efficiently due to limited computing resources, such that accuracy may be compromised in that an approximate solution may be achieved but with a reduced computational cost. In some non-limiting examples, in molecular simulations, electrons, protons, and neutrons—all quantum mechanical in nature—may interact in many-body interactions that may encounter challenges to model with high accuracy on a classical computer. In some non-limiting applications, an NP hardness (non-deterministic polynomial-time hardness) may be used to define a difficulty and a complexity of a computational problem.

Classical computers may represent information in binary variables as 0 and 1, called bits, and may, in some non-limiting examples, perform gate operations upon these bits in certain combinations, to represent numerical data.

Quantum computers, which harness the phenomena of quantum mechanics, have been developed to solve computational problems in various industries that may be challenging for at least one of: a classical computer, and a conventional numerical method. In some non-limiting examples, quantum computers may have applicability to find solutions of at least certain computational problems, including without limitation, certain types of NP hard problems, with substantially high accuracy in acceptable, including without limitation, polynomial, processing time.

Quantum computers may use quantum bits, also referred to as qubits, to encode quantum information. In some non-limiting examples, a qubit may be a two-state system. However, rather than a conventional bit which is either 0 or 1, a qubit may have a probability of being in a state 0 and a probability of being in a state 1, and thus may comprise a quantum mechanical superposition of both 0 and 1.

In some non-limiting examples, a state of a qubit may be represented as a linear combination of states 0 and 1 scaled by coefficients, where the square of the coefficient for one of: state 0, and state 1, may be the probability of measuring the corresponding state. In some non-limiting applications, a state of a qubit may be represented by a vector on a Bloch sphere, where the north and south poles of the sphere may represent the states 0 and 1, respectively, and rotations of the vector on the Bloch sphere may indicate changes in the relative probability of each state.

In some non-limiting examples, quantum information may be encoded by a physical system capable of quantum effects. In some non-limiting examples, the quantum effects may include, without limitation, at least one of: superposition between quantum states, and entanglement with at least one qubit. In some non-limiting applications, such quantum effects may potentially allow more information to be encoded in a qubit than a classical bit.

By way of non-limiting example, physical implementations of qubits may include one of: superconducting charge qubits, superconducting flux qubits, superconducting phase qubits, nuclear spin states, atomic spin states, electron spin states, electron number states, squeezed states of light, polarization encoded photons, and quantum dot spin states.

In some non-limiting examples, a quantum computer may compute operations, including without limitation, transformations, by way of non-limiting example, gate operations, simultaneously on each of the encoded states of a qubit, which may result in increased processing speed as a result of inherent parallelization due to the phenomenon of superposition. Such inherent parallelization may contribute to reduce the computational cost of the computational problems in at least certain non-limiting examples.

However, scientific and engineering challenges in terms of, including without limitation, at least one of: hardware capabilities of currently available quantum computers, and complexity of quantum computing processes, may impose a practical limit on the applicability of quantum computing in some non-limiting examples. In some non-limiting examples, there may be an aim to develop quantum computing systems and methods that solve problems accurately with at least one of: a reduced computational complexity, and a reduced storage space.

### BRIEF DESCRIPTION OF THE DRAWINGS

Examples of the present disclosure will now be described by reference to the following figures, in which identical reference numerals in different figures indicate at least one of: identical, and in some non-limiting examples, at least one of: analogous, and corresponding, elements and in which:

FIG. 1 shows a non-limiting example method of solving a problem using a QMF ansatz according to an example.

FIG. 2A-2D show non-limiting examples of quantum circuits constructed based on various entanglement schemes according to some examples.

FIG. 3 shows a non-limiting example implementation of a QCC/iQCC method for solving a problem according to an example;

FIG. 4 shows a non-limiting example method of providing a qubit Hamiltonian according to an example;

FIG. 5 shows a non-limiting example method of obtaining a constrained qubit Hamiltonian by implementing a constraint using a projector according to an example;

FIG. 6 shows a non-limiting example method of selecting entanglers for a qubit Hamiltonian using a Direct Interaction Set (DIS) method according to an example;

FIG. 7 shows a non-limiting example method of solving a QMF problem using a quantum annealer according to an example;

FIG. 8 shows a non-limiting example method of selecting normalizing entanglers for a qubit Hamiltonian according to an example;

FIG. 8A shows a non-limiting example implementation of the QCC/iQCC method for solving a problem using a set of normalizing entanglers according to an example;

FIG. 9 shows a non-limiting example method of selecting ILC entanglers for a qubit Hamiltonian according to an example;

FIG. 10 shows a non-limiting example method for factorizing a unitary transformation entangling more than two qubits according to an example;

FIG. 11 shows a non-limiting example of a method for encoding quantum information on a classical computer according to an example;

FIG. 12 shows a non-limiting example of a method for generating a set of ILC entanglers for a qubit Hamiltonian using binary encoding according to an example;

FIG. 12A shows a non-limiting example implementation of the QCC/iQCC method for solving a problem using a set of ILC entanglers according to an example;

FIGS. 13A and 13B show a comparison of iQCC procedures in an example scenario according to an example; and

FIGS. 14A and 14B show comparison of iQCC procedures in an example scenario according to an example; and

FIG. 15 shows a classical computer system configured to control operation of a quantum computer or a quantum processing unit within the quantum computer according to an example.

In the following detailed description, reference is made to the accompanying figures, which form a part hereof. In the figures, similar symbols typically identify similar components, unless the context dictates otherwise. The illustrative examples described in the detailed description, figures, and claims are not meant to be limiting. Other examples may be utilized, and other changes may be made, without departing from the scope of the subject matter presented herein. It will be readily understood that aspects of the present disclosure, as generally described herein, and illustrated in the figures, may be arranged, substituted, combined, separated, and designed, in a wide variety of different configurations, all of which are explicitly contemplated herein.

In the present disclosure, for purposes of explanation and not limitation, specific details are set forth to provide a thorough understanding of the present disclosure, including, without limitation, at least one of particular: architectures, interfaces, and techniques. In some instances, detailed descriptions of well-known systems, technologies, components, devices, circuits, methods, and applications are omitted to not obscure the description of the present disclosure with unnecessary detail.

Further, it will be appreciated that block diagrams reproduced herein can represent conceptual views of illustrative components embodying the principles of the technology.

Accordingly, the system and method components have been represented where appropriate by conventional symbols in the drawings, showing only those specific details that are pertinent to understanding the examples of the present disclosure, to not obscure the disclosure with details that will be readily apparent to those having ordinary skill in the relevant art having the benefit of the description herein.

Any drawings provided herein may not be drawn to scale and may not be considered to limit the present disclosure in any way.

Any feature or action shown in dashed outline may in some examples be considered as optional.

### SUMMARY

According to a broad aspect of the present disclosure, there is disclosed a method for encoding, on a classical computer, quantum information comprising at least one Kronecker product of a plurality of terms selected from: an identity matrix e, a Pauli Xmatrix, a Pauli Y matrix, and a Pauli Z matrix, wherein the at least one Kronecker product comprises a phase term, comprising actions of: providing binary indices for each of: the Pauli Xmatrix, the Pauli Y matrix, the Pauli Z matrix, and the identity matrix e, and for the phase term, and storing the Kronecker product in a binary representation using the binary indices.

In some non-limiting examples, the phase term may be selected from one of: positive (+), negative (−), imaginary (i), and negative imaginary (−i).

In some non-limiting examples, the action of providing may comprise assigning a two-digit code, wherein each digit in the code is one of 0 and 1.

In some non-limiting examples, each of the Pauli Xmatrix, the Pauli Y matrix, the Pauli Z matrix, and the identity matrix e may be assigned a different binary index that is a code selected from:

$$\begin{matrix}1 \\ 0\end{matrix} , \begin{matrix}1 \\ 1\end{matrix} , \begin{matrix}0 \\ 1\end{matrix} , and \begin{matrix}0 \\ 0\end{matrix} .$$

In some non-limiting examples, a first digit and a second digit of the binary index of the Pauli Xmatrix, and the Pauli Z matrix may be different.

In some non-limiting examples, the binary index for Pauli Xmatrix may be one of

$$\begin{matrix}1 \\ 0\end{matrix} and \begin{matrix}0 \\ 1\end{matrix} ,$$

and the binary index for Pauli Z matrix may be the other of

$$\begin{matrix}1 \\ 0\end{matrix} and \begin{matrix}0 \\ 1\end{matrix} .$$

In some non-limiting examples, the binary indices for the Pauli Xmatrix, the Pauli Y matrix, the Pauli Z matrix, and the identity matrix e may be respectively assigned as:

$$x = \begin{matrix}1 \\ 0\end{matrix} , y = \begin{matrix}1 \\ 1\end{matrix} , z = \begin{matrix}0 \\ 1\end{matrix} , and e = \begin{matrix}0 \\ 0\end{matrix} .$$

In some non-limiting examples, each of a positive (+) phase, a negative (−) phase, a imaginary (i) phase, and a negative imaginary (−i) phase may be assigned a different binary index that is a code selected from:

$$\begin{matrix}1 \\ 0\end{matrix} , \begin{matrix}1 \\ 1\end{matrix} , \begin{matrix}0 \\ 1\end{matrix} , and \begin{matrix}0 \\ 0\end{matrix} .$$

In some non-limiting examples, the binary index for the phase term may be assigned as:

$$\begin{matrix}0 \\ 0\end{matrix}$$

for a positive (+) phase;

$$\begin{matrix}1 \\ 1\end{matrix}$$

for a negative imaginary (−i) phase

$$\begin{matrix}0 \\ 1\end{matrix}$$

for a negative (−) phase; and

$$\begin{matrix}1 \\ 0\end{matrix}$$

for an imaginary (i) phase.

In some non-limiting examples, the binary representation may comprise a set of the binary indices of the Kronecker product, including the binary index of the phase term thereof.

In some non-limiting examples, the binary index of the phase term may be stored as a first one in the set.

In some non-limiting examples, a binary representation of the Kronecker product may comprise a first array and a second array, wherein elements of the first array correspond to a first digit, and corresponding elements of the second array correspond to a second digit, of the codes for the Pauli matrices and the identity matrix.

In some non-limiting examples, the method may further comprise actions of: generating a set of candidate entanglers for a qubit Hamiltonian; wherein at least one of the qubit Hamiltonian and the candidate entanglers comprises the at least one Kronecker product, such that the at least one of the qubit Hamiltonian and the candidate entanglers is encoded in the binary representation.

In some non-limiting examples, the qubit Hamiltonian may be in a form of a linear equation comprising at least one Pauli operator.

In some non-limiting examples, the qubit Hamiltonian may be an Ising-decomposed Hamiltonian.

In some non-limiting examples, the set of candidate entanglers may comprise at least one Pauli entangler.

In some non-limiting examples, the candidate entanglers may be pairwise products of each Pauli term of the qubit Hamiltonian.

In some non-limiting examples, the candidate entanglers may comprise a set of Involutory Linear Combination (ILC) entanglers expressed as A={\hat{T}₁, \hat{T}₂, . . . }, subject to: [symbol] αᵢ\hat{T}ᵢ)²=\hat{1}; and Σᵢαᵢ²=1, where: a sum of the square of coefficients constitutes a normalized vector, all the entanglers \hat{T}ᵢ∈A are mutually anti-commutative, and the entangler \hat{T}ᵢ is a Pauli word.

According to a broad aspect of the present disclosure, there is disclosed a method of generating a set of Involutory Linear Combination (ILC) entanglers using a classical computer, comprising actions of: providing a provided Hamiltonian comprising Pauli words; encoding the Pauli words in a binary representation; selecting at least one Xₖ operator, where Xₖ is a Pauli X string comprising only X Pauli terms; constructing at least one Zₖ operator; and generating the set of ILC entanglers from the at least one Xₖ operator and the at least one Zₖ operator; wherein the provided Hamiltonian is an Ising-decomposed Hamiltonian.

In some non-limiting examples, the set of ILC entanglers may be expressed as A {\hat{T}₁, \hat{T}₂, . . . }, subject to: [symbol] αᵢ\hat{T}ᵢ)²=\hat{1}; and Σᵢαᵢ²=1, where: a sum of the square of coefficients constitutes a normalized vector, all the entanglers \hat{T}ᵢ∈A are mutually anti-commutative, and the entangler \hat{T}ᵢ is a Pauli word.

In some non-limiting examples, the Ising-decomposed Hamiltonian may be given by: H=I₀+Σₖ₌₀Iₖ(Z)Xₖ where: Iₖ(Z) is a qubit Hamiltonian in a Pauli polynomial form comprising only Pauli Z terms.

In some non-limiting examples, the action of encoding may comprise an action of mapping the Pauli words to vectors of 0 and 1.

In some non-limiting examples, the action of encoding may comprise an action of arranging the operators of Xₖ in the binary representation into a matrix M, such that the columns of Mare bit strings for the operators of Xₖ.

In some non-limiting examples, the action of selecting may comprise an action of converting the matrix M to a reduced row-echelon form M_{rref}.

In some non-limiting examples, the action of converting may comprise converting rows of the matrix M into a set of Pauli elementary operators.

In some non-limiting examples, the action of constructing may comprise constructing the at least one Zₖ operator in an operator form.

In some non-limiting examples, the action of constructing may be based on the at least one Xₖ operators selected.

In some non-limiting examples, the action of constructing may comprise actions of: building binary vectors of the at least one Zₖ operator for each primary and secondary column in M_{rref}; and changing the binary vectors back to its operator form in a matrix representation using the binary encoding.

In some non-limiting examples, the action of generating may comprise an action of: deriving the ILC entanglers from the at least one selected Xₖ operator and the at least one constructed Zₖ operator.

In some non-limiting examples, the Ising-decomposed Hamiltonian may provide a variational upper bound for a target eigenvalue thereof; the method further comprising actions of: determining, at a quantum computer operably coupled with the classical computer, corresponding amplitudes of the ILC entanglers, as a first iteration of the method; repeating the first iteration of the action of determining, until a first stopping condition has been met.

In some non-limiting examples, the action of determining comprises an action of, if the first stopping condition has been met, obtaining a first expectation value of the provided Hamiltonian based on the set of ILC entanglers and the determined amplitude obtained in a current instance of the first iteration, and wherein the first expectation value gives an estimate of the target eigenvalue of the provided Hamiltonian.

In some non-limiting examples, the method may further comprise actions of: dressing the provided Hamiltonian, at the classical computer, to obtain a transformed Hamiltonian using the set of ILC entanglers and the determined amplitudes, wherein the transformed Hamiltonian forms the provided Hamiltonian, wherein at least the actions of providing, encoding, selecting, constructing, generating, determining; repeating, and dressing form a second iteration of the method; restarting the second iteration by returning to the action of providing, using the transformed Hamiltonian as the provided Hamiltonian, until a second stopping condition has been met.

In some non-limiting examples, the action of restarting comprises an action of, if the second stopping condition has been met, calculating a second expectation value of the provided Hamiltonian based on the transformed Hamiltonian obtained in a current instance of the second iteration, and wherein the second expectation value gives an estimate of the target eigenvalue of the provided Hamiltonian.

According to a broad aspect of the present disclosure, there is disclosed a method for selecting a set of normalizing entanglers for a provided Hamiltonian comprising at least one Pauli term, the method comprising, at a classical computing system, actions of: generating a set of candidate entanglers; calculating a value of a commutator of each candidate entangler with the qubit Hamiltonian; and selecting a set of normalizing entanglers; wherein the provided Hamiltonian is a qubit Hamiltonian.

In some non-limiting examples, the set may be generated from at least one of: a Direct Interaction Set (DIS), and an Involutory Linear Combination (ILC) set.

In some non-limiting examples, the action of generating may comprise an action of calculating pairwise products of each Pauli term of the provided Hamiltonian.

In some non-limiting examples, the action of calculating may comprise an action of performing a search in all the pairwise products based on: H=Σᵢ₌₁^{N}cᵢPᵢ, H×H.

In some non-limiting examples, the action of selecting may comprise an action of filtering for entanglers that commute with every Pauli word in the provided Hamiltonian.

In some non-limiting examples, the method may further comprise an action of choosing at least one entangler that lowers an expectation value of the provided Hamiltonian.

In some non-limiting examples, the action of choosing may follow at least one of: the action of generating, and the action of selecting.

In some non-limiting examples, at least one of the provided Hamiltonian and the candidate entanglers may be encoded in a binary representation.

In some non-limiting examples, the provided Hamiltonian may provide a variational upper bound for a target eigenvalue thereof; and the method may further comprise actions of: determining, at a quantum computer operably coupled with the classical computing system, corresponding amplitudes of the normalizing entanglers, as a first iteration of the method; repeating the first iteration of the action of determining, until a first stopping condition has been met.

In some non-limiting examples, wherein the action of determining comprises an action of, if the first stopping condition has been met, obtaining a first expectation value of the provided Hamiltonian based on the selected set of entanglers and the determined amplitude obtained in a current instance of the first iteration, and wherein the first expectation value gives an estimate of the target eigenvalue of the provided Hamiltonian.

In some non-limiting examples, the method may further comprise actions of: dressing the provided Hamiltonian, at the classical computing system, to obtain a transformed Hamiltonian using the selected set of normalizing entanglers and the determined amplitudes, wherein the transformed Hamiltonian forms the provided Hamiltonian, and wherein at least the actions of: generating, calculating, selecting, determining; repeating, and dressing, form a second iteration of the method; restarting the second iteration by returning to the action of providing, using the transformed Hamiltonian as the provided Hamiltonian, until a second stopping condition has been met.

In some non-limiting examples, the action of restarting comprises an action of, if the second stopping condition has been met, calculating a second expectation value of the provided Hamiltonian based on the transformed Hamiltonian obtained in a current instance of the second iteration, and wherein the second expectation value gives an estimate of the target eigenvalue of the provided Hamiltonian.

According to a broad aspect of the present disclosure, there is disclosed a method of solving a problem using a quantum computer operably coupled with a classical computing system, comprising actions of: providing, at the classical computing system, a provided Hamiltonian, wherein an expectation value of the provided Hamiltonian provides a variational upper bound for a target eigenvalue thereof; selecting, at the classical computing system, a set of entanglers; determining, at the quantum computer, corresponding amplitudes of the entanglers, as a first iteration of the method; repeating the first iteration of the action of determining, until a first stopping condition has been met; wherein the provided Hamiltonian is a qubit Hamiltonian.

In some non-limiting examples, the action of determining may comprise an action of, if the first stopping condition has been met, of obtaining a first expectation value of the provided Hamiltonian based on the selected set of entanglers and the determined amplitude obtained in a current instance of the first iteration, and the first expectation value may give an estimate of the target eigenvalue of the provided Hamiltonian and comprises a solution to the problem.

In some non-limiting examples, the method may further comprise actions of: dressing the provided Hamiltonian, at the classical computing system, to obtain a transformed Hamiltonian, wherein the transformed Hamiltonian forms the provided Hamiltonian, and wherein at least the actions of: providing, selecting, determining; repeating, obtaining, and dressing, form a second iteration of the method; restarting the second iteration by returning to the action of providing, using the transformed Hamiltonian as the provided Hamiltonian, until a second stopping condition has been met.

In some non-limiting examples, the action of restarting may comprise an action of, if the second stopping condition has been met, calculating a second expectation value of the provided Hamiltonian based on the transformed Hamiltonian obtained in a current instance of the second iteration, wherein the second expectation value gives an estimate of the target eigenvalue of the provided Hamiltonian, and comprises a solution to the problem.

In some non-limiting examples, the first stopping condition may be one of: reaching a threshold change of the expectation value of the provided Hamiltonian between first iterations; performing a number of first iterations; evaluating a pre-set number of entanglers; and achieving a pre-set threshold for the expectation value of the provided Hamiltonian.

In some non-limiting examples, the second stopping condition may be one of: reaching a threshold change of the expectation value of the provided Hamiltonian between second iterations; performing a number of second iterations; evaluating a pre-set number of entanglers; and achieving a pre-set threshold for the expectation value of the provided Hamiltonian.

In some non-limiting examples, the provided Hamiltonian may be in a form of a linear equation comprising Pauli words.

In some non-limiting examples, the provided Hamiltonian may be encoded and stored in a binary representation, at the classical computing system.

In some non-limiting examples, the action of providing may comprise an action of transforming a fermionic Hamiltonian into a qubit Hamiltonian.

In some non-limiting examples, the provided Hamiltonian may be constrained with respect to an operator and an eigenvalue of the operator.

In some non-limiting examples, the operator may be at least one of: a number operator, and a spin operator, wherein the spin operator is at least one of: a total spin-squared operator, and a projection of a total spin operator.

In some non-limiting examples, the selected set of entanglers may be represented, on the quantum computer, as multi-qubit entanglement gates in a quantum circuit.

In some non-limiting examples, the selected set of entanglers may comprise at least one Pauli entangler, which takes a form of a Pauli word.

In some non-limiting examples, the selected set of entanglers may be encoded and stored in a binary representation, at the classical computing system.

In some non-limiting examples, the action of selecting may comprise selecting at least one of: entanglers from a Direct Interaction Set (DIS), normalizing entanglers that commute with every term in the provided Hamiltonian, and entanglers that form an Involutory Linear Combination (ILC) set.

In some non-limiting examples, an instance of the second iteration in which normalizing entanglers are selected may be performed one of: before, after, and alternating with, an instance of the second iteration in which DIS entanglers are selected.

In some non-limiting examples, an instance of the second iteration in which ILC entanglers are selected may be performed one of: before, after, and alternating with, an instance of the second iteration in which DIS entanglers are selected.

In some non-limiting examples, an instance of the second iteration in which ILC entanglers are selected may occur if a pre-determined condition is met after an instance of the second iteration in which DIS entanglers are selected, and wherein such condition comprise one of: a change of expectation value of the Hamiltonian between iterations being no more than a threshold value; a total sum of the gradients for all DIS entanglers reaching a threshold value; and growth of the terms in the Hamiltonian reaching a threshold value.

In some non-limiting examples, such condition may be an energy change being no more than about 0.001 Ha.

In some non-limiting examples, such condition may be the total sum of the gradients reaching 0.002.

In some non-limiting examples, a number of ILC entanglers per instance of the second iteration may be at least a number of the DIS entanglers in an immediately previous instance of the second iteration.

In some non-limiting examples, the number of ILC entanglers may be n times the number of DIS entanglers, where n is one of: 2, 3, 4, 5, 6, 7, 8, 9, 10, 20, 30, 40, 50, 100, 1,000, 5,000, and 10,000.

In some non-limiting examples, the selected entangler may be factorized into at least three entanglers, each of which involves a reduced number of qubits.

In some non-limiting examples, the action of dressing may use the selected set of entanglers, and the determined amplitude.

In some non-limiting examples, the eigenvalue may be a ground-state energy.

In some non-limiting examples, the quantum computer may comprise one of: a universal quantum computer, and a quantum annealer.

According to a broad aspect, there is disclosed a quantum computer comprising: a plurality of qubits; a qubit Hamiltonian; and a quantum circuit comprising a set of quantum logic gates to perform gate operations; wherein the quantum logic gates are constructed based at least on a set of entanglers comprising at least one of: at least one entangler selected from a Direct Interaction Set (DIS); at least one entangler that commutes with every term of the Hamiltonian; and at least one entangler selected from an Involutory Linear Combination (ILC) set.

In some non-limiting examples, the quantum computer may be operably coupled with a classical computer.

In some non-limiting examples, at least one of the qubit Hamiltonian and the entanglers may be encoded in a binary representation on the classical computer.

### DETAILED DESCRIPTION

The present disclosure generally provides methods and systems to improve a process of finding a solution of a problem using at least one of: a quantum computer and a quantum-inspired algorithm.

In some non-limiting examples, the methods and systems disclosed herein may be used to solve a quantum chemistry problem, including without limitation, an electronic structure problem, and a quantum mechanical simulation of a molecular system, including without limitation, molecular dynamics simulation. While quantum chemistry problems may be provided herein as non-limiting illustrative examples, those having ordinary skill in the relevant art will appreciate that the methods and systems disclosed herein may be applicable to solve problems in various applications, including without limitation, drug discovery, economic modeling, and computer simulations of, by way of non-limiting example, protein folding, quantum systems, and ecological habitats.

In some non-limiting examples, a solution to a quantum chemistry problem may comprise at least one of: the structure, and properties, of matter.

In some non-limiting examples, matter may comprise at least one of: atoms, molecules, and groups thereof. In some non-limiting examples, matter may comprise extended states of matter, including without limitation, condensed matter.

In some non-limiting examples, molecules may comprise at least one of: a main group element, a transition metal element, and a post-transition metal element.

In some non-limiting examples, molecules may comprise at least one of: a polymer, a molecular crystal, an organo-metallic compound, a small molecule, and an organic compound.

In some non-limiting examples, an organo-metallic compound may comprise at least one of: an organo-metallic complex, and a metal coordination complex. In some non-limiting examples, such complex may be formed by a metallic coordination center, and ligands surrounding such coordination center. In some non-limiting examples, the coordination center may comprise at least one of: an atom, and an ion. In some non-limiting examples, the coordination center may comprise at least one of: strontium (Sr), calcium (Ca), lanthanum (La), erbium (Er), samarium (Sm), europium (Eu), hafnium (Hf), bismuth (Bi), neodymium (Nd), gadolinium (Gd), praseodymium (Pr), holmium (Ho), iridium (Ir), zinc (Zn), rhodium (Rh), aluminum (Al), beryllium (Be), rhenium (Re), ruthenium (Ru), boron (B), phosphorus (P), copper (Cu), osmium (Os), gold (Au), and platinum (Pt). In some non-limiting examples, in complexes, including without limitation, metal coordination complexes, a bond, including without limitation, a dative bond, may be formed between the coordination center and at least one atom of the surrounding ligands. In some non-limiting examples, the bonds may comprise those formed between a metallic atom of the coordination center and at least one of: a carbon (C), a nitrogen (N), and an oxygen (O) atom of the surrounding ligands. In some non-limiting examples, such bonds may comprise those formed between one of: Al and O, Al and N, Zn and O, Zn and N, Zn and C, Be and O, Be and N, Ir and N, Ir and C, Ir and O, Cu and N, B and C, Pt and N, Pt and O, Os and N, Ru and N, Re and N, Re and O, Re and C, Cu and P, Au and N, and Os and C. In some non-limiting examples, bonds may comprise those of organic compounds, including without limitation, one of between: C and C, C and N, C and O, C and H, C and P, O and H, N and H, and O and N.

In some non-limiting examples, molecules may comprise fullerenes. In some non-limiting examples, a fullerene may comprise at least one of: C₆₀, C₇₀, C₇₆, C₈₄, single-wall carbon nanotubes, and multi-wall carbon nanotubes.

In some non-limiting examples, molecules may comprise at least one of: materials for organic photo-voltaics, and opto-electronic materials.

In some non-limiting examples, an opto-electronic material may comprise an organic material, including without limitation, a small-molecule organic material, an organic-inorganic hybrid material, and an organic polymer. In some non-limiting examples, the organic material may comprise a polycyclic aromatic compound, which may, in some non-limiting examples, comprise at least one heteroatom, including without limitation, N, sulfur (S), O, P, fluorine (F), Silicon (Si) and Al. In some non-limiting examples, the opto-electronic material may comprise a quantum dot. In some non-limiting examples, the opto-electronic material may be used in the manufacture of opto-electronic devices, including without limitation, electro-luminescent devices, including without limitation, organic light-emitting diode (OLED) devices.

In some non-limiting examples, a property may comprise at least one of: an absolute energy, a relative energy, a ground state, an excited state, an ionization potential, a charge density distribution, a dipole, a higher-multipole moment, a polarization tensor, a highest occupied molecular orbital gap (HOMO)—lowest unoccupied molecular orbital (LUMO) gap, an ionization potential, an isoelectronic surface, an infrared spectrum, an ultraviolet-visible (UV-Vis) spectrum, a spectrum in any other wavelength range of the electromagnetic spectrum, a vibrational frequency, a reactivity, a collision cross-section, a thermodynamic property, a potential energy surface, a bond energy, a bond length, a bond angle, a rate of reaction, and a time evolution of any of the foregoing properties, including without limitation: a charge transport, an adiabatic chemical dynamic, a vibronic coupling, a folded space optimization, and various calculation steps thereof.

In some non-limiting examples, the methods disclosed herein may be performed on a computer that is capable of at least one of: performing, and simulating, qubit operations, including without limitation, quantum gate operations, used to perform such methods. In some scenarios where a problem to be solved is one of: an Ising problem, and a quadratic unconstrained boundary optimization (QUBO)-type problem, one of: a quantum annealer, and a computer operable to simulate a quantum annealer, including without limitation, a simulated annealer, may be used. In some scenarios where a problem may be solved using a qubit mean-field (QMF) ansatz, one of: a quantum computer, and any computer operable to simulate qubit operations of a quantum computer, may be used.

As used herein, one of: a quantum gate, and a quantum logic gate may refer to any one of: a device, and process, that may perform one of: a logic operation, and a gate operation, on a qubit as part of a quantum circuit. In some non-limiting examples, quantum gates may be represented as unitary matrices. In some non-limiting examples, logic operations on a set of qubits may comprise, without limitation, at least one of: superposition gates, and entanglement gates.

In some non-limiting examples, superposition gates may act upon a qubit to achieve at least one of: a superposition, and change in a relative probability, of each of the two basis states, including without limitation, the two pole states in a Bloch sphere. In some non-limiting examples, superposition gates may comprise, without limitation, one of: Pauli Operators (X, Y, Z), Hadamard gates, and rotation gates (RX, RY, RZ).

In some non-limiting examples, entanglement gates, including without limitation, at least one of: cZgates, and CNOT gates, may couple a plurality of qubits.

In some non-limiting examples, varying types of quantum computers may be capable of implementing at least a subset of the gates listed herein. Those having ordinary skill in the relevant art will appreciate that in some non-limiting examples, other types of gates not listed herein may be appropriate.

As used herein, reference to one of: a quantum computer, and a quantum processing unit (QPU), may be a reference to any device that harnesses at least one quantum effect, including without limitation, at least one of: superposition, and entanglement, to perform a computation. In some non-limiting examples, a quantum computer may comprise at least one qubit. In some non-limiting examples, a quantum computer may comprise a QPU comprising at least one qubit.

In some non-limiting examples, a circuit model of quantum computing may be employed, in which a quantum computer may be viewed as performing a set of logic operations on a set of qubits for the purpose of solving a problem. In some non-limiting examples, a quantum computer may comprise operations for manipulating at least one of: the superposition, and entanglement, of the qubits, including without limitation, one of: electrical pulses, and photons. In some non-limiting examples, a potential energy of a qubit may be controllably varied. In some non-limiting examples, the potential energy may comprise at least one of: one-qubit bias terms, and multiple-qubit coupling terms.

In some non-limiting examples, a quantum computer may be a non-classical computer, which may be capable of using at least one quantum effect to perform a computation.

In some non-limiting examples, a quantum computer may be a universal quantum computer. As used herein, a universal quantum computer may refer to a quantum computer that may simulate the operation of any other quantum computer. In some non-limiting examples, a non-classical computer may not be a universal quantum computer. In some non-limiting examples, a quantum computer, which may not be a universal quantum computer, may be capable of simulating a gate operation that it may not directly perform.

In some non-limiting examples, a quantum computer may be a quantum annealer. As used herein, a quantum annealer may refer to a type of non-classical computer that may solve a class of optimization problems by exploiting quantum mechanical fluctuations. In some non-limiting examples, the quantum annealer may be limited to X and Z operations. In some non-limiting examples, quantum annealers may be limited to solving binary optimization problems in the form of, by way of non-limiting example, one of: a Higher Order Ising problem, and a Higher Order Binary Optimization problem, including without limitation, an Ising problem, and a QUBO problem. In some non-limiting examples, quantum annealers may have applicability in some scenarios calling for obtaining a highly accurate solution with a fast speed.

In some non-limiting examples, a quantum computer may comprise one of: an adiabatic quantum computer, a quantum gate array, a one-way quantum computer, a topological quantum computer, a quantum Turing machine, a superconductor-based quantum computer, a trapped ion quantum computer, a trapped atom quantum computer, an optical lattice, a quantum dot computer, a spin-based quantum computer, a spatial-based quantum computer, a Loss-DiVincenzo quantum computer, a nuclear magnetic resonance (NMR)-based quantum computer, a solution-state NMR quantum computer, a solid-state NMR quantum computer, a solid-state NMR Kane quantum computer, an electrons-on-helium quantum computer, a cavity-quantum-electrodynamics-based quantum computer, a molecular magnet quantum computer, a fullerene-based quantum computer, a linear optical quantum computer, a diamond-based quantum computer, a nitrogen vacancy (NV) diamond-based quantum computer, a Bose-Einstein condensate-based quantum computer, a transistor-based quantum computer, and a rare-earth-metal-ion-doped inorganic crystal-based quantum computer.

In some non-limiting examples, a quantum computer may comprise one of: an Ising solver, an optical parametric oscillator (OPO), and a gate model of quantum computing.

Varying forms of quantum computers have been proposed and realized, including without limitation, Q by IBM Corporation, the 2000Q quantum computer of D-Wave Systems, the Digital Annealer by Fujitsu, the 19Q-Acorn by Rigetti, and the quantum photonic processors of Xanadu Quantum Technologies.

In some non-limiting examples, the methods described herein may be performed on a classical computer, including without limitation, one of: a central processing unit (CPU), a multiprocessor, a microcontroller, a reduced instruction set computer (RISC), a graphics processing unit (GPU), a digital signal processor (DSP), an application-specific integrated circuit (ASIC), and a floating point gate array (FPGA), using a quantum-inspired algorithm. In some non-limiting examples, a quantum-inspired algorithm may have applicability in some scenarios where a Higher Order Binary Optimization problem may be solved, including without limitation, one of: an Ising, a QUBO, and a high order binary optimization (HOBO) problem. In some non-limiting examples, a quantum-inspired algorithm may involve executing, on a classical computer, including without limitation, a simulated annealer, a particular process, including without limitation, at least one of: simulated annealing, parallel tempering, and simulated quantum annealing. In some non-limiting examples, simulated annealing may use classical thermal fluctuations to guide a qubit Hamiltonian, which may, in some non-limiting examples, be represented in Pauli Zrotations, to a target eigenstate, including without limitation, a ground state. In some non-limiting examples, simulated annealing may be performed without using quantum effects.

Methods and systems disclosed herein may be used in combination with methods and systems operable to solve a problem disclosed in commonly assigned International Patent Publication No. WO2019/229527, which is incorporated herein by reference in its entirety.

### Alpha Beta Orbital Blendinq

In some non-limiting examples, in molecular applications, an Alpha Beta Orbital Blending method may be used to study entanglement between qubits.

In some non-limiting examples, perceived alpha and beta molecular orbitals of a molecule may be mapped onto qubits, such that one of: each qubit, and a group of qubits, may represent one of: an alpha, and a beta, spin molecular orbital. In some non-limiting examples, alternating qubits may be respectively represented as alpha and beta spin orbitals, such that a beta qubit may be arranged in between each neighboring alpha qubits, and vice versa. In some non-limiting examples, adjacent qubits may be represented as one of alpha, and beta, spin orbitals.

In some non-limiting examples, each alpha qubit may be entangled with at least one other alpha qubit, and each beta qubit may be entangled with at least one other beta qubit. In some non-limiting examples, entanglement ansatz schemes may be based on entangling appropriate sigma and pi bonding orbitals.

### Pauli Word

A Pauli word may refer to a product of at least one Pauli operator on different qubits. In some non-limiting examples, a Pauli word A may be represented by:

$${\hat{P}}_{I} = … {\hat{ω}}_{P}^{( I )} {\hat{ω}}_{R}^{( I )} \qquad ( E1 )$$

where:
\hat{ω}_{R}^{(I)} is one of: Pauli operators X Y, 2, and an Identity operator, acting on the R^{th} qubit.

In some non-limiting examples, the Pauli word may comprise a product of two Pauli operators on two qubits. In some non-limiting examples, the Pauli word may be of the form of one of: X_{P}X_{R}, X_{P}Z_{R}, Z_{P}Z_{R}, X_{P}Y_{R}, Y_{P}Z_{R}, Y_{P}Y_{R}, and Z_{P}Z_{R}, where P and R are different qubit indices. In some non-limiting examples, the Pauli word may comprise a product of one of: three Pauli operators, four Pauli operators and one of no more than: 5, 10, and 100 Pauli operators.

In some non-limiting examples, an entangler is a multi-qubit operator acting on at least two qubits. In some non-limiting examples, an entanglement operation may be an operation on at least two qubits. In some non-limiting examples, an entanglement operator may take the form of a unitary operator parameterized as:

$${\hat{U}}_{ENT} = exp ( - i τ {\hat{T}}_{k} ) \qquad ( E2 )$$

where:
τ is an amplitude of the entanglement operator, and
\hat{T}ₖ is an entangler.

In some non-limiting examples, the Pauli word may be a generator of entanglement, such that the unitary operator may be represented as:

$${\hat{U}}_{ENT} = {e}^{- i τ {\hat{P}}_{I}} \qquad ( E3 )$$

In some non-limiting examples, the amplitude τ may be related to a microwave pulse duration. In some non-limiting examples, the amplitude τ may be a time evolution of the unitary operator, which in some non-limiting examples, may be imaginary. In some non-limiting examples, the amplitude τ may comprise a rotation of the entanglement operator, which may, in some non-limiting examples, arise from a sequence of gate operations.

### Hamiltonian

In some non-limiting examples, a system under analysis, including without limitation, a molecular system, may be represented by a Hamiltonian. In some non-limiting examples, a Hamiltonian of a system may be an operator that corresponds to a total energy of that system, including both kinetic energy and potential energy. In some non-limiting examples, a spectrum of the Hamiltonian may be an energy spectrum of that system, and a set of eigenvalues of the Hamiltonian may be a set of possible outcomes obtainable from a measurement of the system's total energy.

A Hamiltonian may take various forms. In some non-limiting examples, it may be formulated by taking into account various characteristics of the system under analysis, including without limitation, one of: single, and multiple, particles in the system, interaction between particles, a type of potential energy, and one of: a time-varying, and a time-independent potential.

In some non-limiting examples, a qubit Hamiltonian, also referred to as a Hamiltonian in a qubit space, may be used to represent the system to solve a problem by quantum computing.

### Variational Quantum Eigensolver (VQE)

In some non-limiting examples, hybrid quantum-classical algorithms that engage both classical computers and quantum computers may have applicability in at least some scenarios where at least one of: a quantity, and a quality, of quantum resources is limited.

In some non-limiting examples, such hybrid quantum-classic algorithm may comprise a Variational Quantum Eigensolver (VQE) algorithm that may, in some non-limiting examples, provide a close approximation to a system under analysis, in an iterative manner, using the variational principle. In some non-limiting examples, the VQE may have increased applicability in some scenarios where there are hardware restrictions and computational limits in, without limitation, a number of available qubits, qubit connectivity, fidelity of quantum gates, and coherence time.

In some non-limiting examples, the VQE algorithm may be used to find an eigenstate, including without limitation, a ground state, of the system. In some non-limiting examples, the VQE algorithm may construct a trial wavefunction Ψ representing a unitary transformation, represented by a parametrized unitary operator U, acting on a reference wavefunction |ϕ [symbol] , which may represent an initial state of qubits, as follows:

$$\vert Ψ 〉 = U \vert ϕ 〉 \qquad ( E4 )$$

In some non-limiting examples, the parametrized unitary operator U may be optimized variationally to provide an estimate for a target eigenvalue of the system. In some non-limiting examples, the target eigenvalue may be found by minimizing an expectation value of a Hamiltonian of the system, which may be represented as:

$$F = 〈 Ψ \vert H \vert Ψ 〉 \qquad ( E5 )$$

where:
H is the Hamiltonian of the system under analysis.

In some non-limiting examples, the unitary operator may utilize various parametrization. In some non-limiting examples, the unitary operator U may define an ansatz of the wavefunction W and in some non-limiting examples, may impact the accuracy of the computation.

In some non-limiting examples, the VQE algorithm may be performed using a Unitary Coupled Cluster (UCC) ansatz based on a coupled cluster theory. In some non-limiting examples, the UCC ansatz may contain a cluster operator, which may, in some non-limiting examples, be exponential. In some non-limiting examples, the cluster operator may form a linear combination of excited determinants. In some non-limiting examples, the cluster operator may be characterized by a number of excitations comprised before truncation, including without limitation, only single excitations (“singles”/Coupled Cluster Singles (CCS)); single and double excitations (“singles and doubles”/Coupled Cluster Single-double (CCSD)); singles, doubles, and triples excitations (Coupled Cluster Single-Double-Triple (CCSDT)); and singles, doubles, triples, and quadruples excitations (Coupled Cluster Single-Double-Triple-Quadruple (CCSDTQ)). In some non-limiting examples, the inclusion of all excitations in the system may yield a formally exact solution, but may, in some non-limiting examples, be computationally expensive. In some non-limiting examples, the excitations included may be truncated at a number that may be chosen in part based on the computational cost, leading to an approximate treatment. In some non-limiting examples, a complete active space (CAS) calculation, including without limitation, CAS-CI (configuration interaction), CAS—Coupled Cluster, CAS-CISD, and CAS-DMRG, may be implemented. In some non-limiting examples, a CAS calculation may comprise a full configuration interaction calculation within a subspace of “active” molecular orbitals, such that some orbitals may not be considered in calculation. In some non-limiting examples, a set of active orbitals may be chosen to include a set of one of: occupied, partly occupied, and virtual, orbitals likely to be involved in bonding.

While it will be appreciated that coupled cluster-type calculations may, in some non-limiting examples, contribute to a fast convergence to an exact eigenvalue, the UCC ansatz may, in some non-limiting examples, have reduced applicability in at least some scenarios since the cluster operator, constructed as a fermionic operator, may limit types of problems to be solved. Further, the UCC ansatz may, in some non-limiting examples, have certain computational inconvenience and thus may be exponentially hard for a classical computer even at a low rank due to non-commutativity of involved operators and redundant terms in qubit representation.

In some non-limiting examples, an ansatz having n-qubit trial states, which may take into account hardware conditions, may be parametrized below:

$$Ψ ( θ ) = {\prod }_{q = 1}^{n} [ {U}^{q , d} ( θ ) ] \times {U}^{ENT} \times … \times {\prod }_{q = 1}^{n} [ {U}^{q , 1} ( θ ) ] \times {U}^{ENT} \times {\prod }_{q = 1}^{n} [ {U}^{q , 0} ( θ ) ] \vert 00 … 0 〉 \qquad ( E6 )$$

and may be similar to that disclosed in Kandala et al. Nature 549, 242 (2017), which is incorporated by reference in its entirety herein.

In some non-limiting examples, a product of individual qubit rotations U^{q,i}(θ) may be shown by:

$${U}^{q , i} ( θ ) = {e}^{{iz}_{q} {θ}_{1}^{q , i}} {e}^{{ix}_{q} {θ}_{2}^{q , i}} {e}^{{iz}_{q} {θ}_{3}^{q , i}} , 0 \leq i \leq d , \qquad ( E7 )$$

where:
θ₁^{q}, θ₂^{q}, and θ₃^{q} are respectively, the Euler angles of the q^{th} spin;
x^{q} is an X rotation gate of the q^{th} spin;
z^{q} is a Z rotation gate of the q^{th} spin; and
d is an ansatz depth parameter which, in some non-limiting examples, may comprise at least one of: a depth scheme, and an ansatz depth parameter, that may define a number of iterations over which the entanglement scheme may be repeated. In some non-limiting examples, the depth scheme may comprise a number of iterations sufficient to reach computational accuracy.

In some non-limiting examples, an entanglement operator may be shown by:

$${U}^{ENT} = exp ( - i τ {\hat{H}}_{o} ) \qquad ( E8 )$$

where:
τ is a fixed amplitude, and
Ĥ₀ is a multi-qubit operator.

In some non-limiting examples, the product of U^{q,i}(θ) may be interleaved with the actions of U^{ENT}, in an alternating sequence, to arrive at Equation (E6).

In some non-limiting examples, in the example ansatz of Equation (E6), a computational workflow may comprise X and Z rotation gates (by the rotations in U_{q,i}) and an entanglement gate. In some non-limiting examples, the ansatz of Kandala et al. may comprise n×(3d+2) gate operations in total, and may, in some non-limiting examples, reach chemical accuracy with an ansatz depth of about 16.

In some non-limiting examples, the convergence of ansatz, represented by Equation (E6), to an exact solution, may call for the presentation of a multi-qubit unitary transformation as a product of one-, and two-qubit, unitary transformations. Further, the pre-defined generators of entanglement may not lead to a fast convergence, since in some non-limiting examples, the system under analysis may affect the efficiency of entanglers.

As a result of the foregoing, in some non-limiting examples, by taking into both hardware-, and system-dependent, considerations, a universal ansatz may be chosen that may have applicability to find an accurate solution at the low rank.

QCC and iQCC Method

In some non-limiting examples, a qubit coupled cluster (QCC) method, which is under the VQE framework, may utilize a QCC ansatz, which may be constructed directly in a qubit space, instead of a UCC ansatz.

In some non-limiting examples, the QCC ansatz may be expanded to comprise a number of entanglers. In some non-limiting examples, for a number of entanglers indexed by k, the QCC ansatz may be represented as:

$$\hat{U} ( τ ) = {\prod }_{k}^{Nent} exp ( - i {τ}_{k} {T}_{k} / 2 ) \qquad ( E9 )$$

where:
Tₖ is the entangler, and in some non-limiting examples, may be comprised of products of Pauli words, whose length may vary from two to the number of qubits N_{q};
Nₑₙₜ is a number of entanglers that is no greater than 4^{Nq}−3N_{q}−1 that is, a total number of possible entanglers; and
τₖ is the corresponding amplitude of the entangler Tₖ, which may, in some non-limiting examples, have a real value.

In some non-limiting examples, a QCC wavefunction may be constructed by acting a multi-qubit transformation defined by the QCC ansatz, including without limitation, as represented by Equation (E9), on an initial reference state |ϕ [symbol] . In some non-limiting examples, the QCC wavefunction may be represented as:

$$Ψ = \hat{U} ( τ ) \vert ϕ 〉 = {\prod }_{k} exp ( - i {τ}_{k} {T}_{k} / 2 ) \vert ϕ 〉 \qquad ( E10 )$$

In some non-limiting examples, a spin coherent state, also referred to as a Bloch (Coherent) State, may be used to describe quantum states of a qubit. In some non-limiting examples, a spin coherent state for the n^{th} qubit may be represented as:

$$\vert {Ω}_{n} 〉 = cos ( {θ}_{n} / 2 ) \vert α 〉 + {e}^{i φ n} sin ( {θ}_{n} / 2 ) \vert β 〉 \qquad ( E11 )$$

where:
φₙ, θₙ are respectively azimuthal and polar angles for the n^{th} qubit on the Bloch sphere; and
   |α [symbol] , |β [symbol] are respectively “up” and “down” eigenstates of the Zₙ operator.

In some non-limiting examples, the initial reference state |ϕ [symbol] of the QCC ansatz may be parametrized as a direct product of qubit spin coherent states, such that a mean-field treatment may be performed on the qubit Hamiltonian:

$$\vert Ω 〉 = \prod n \vert {Ω}_{n} 〉 = \vert ( {φ}_{1} , {θ}_{1} ) 〉 … \vert ( {φ}_{n} , {θ}_{n} ) 〉 \qquad ( E12 )$$

where:
   |Ω [symbol] is a mean-field wavefunction.

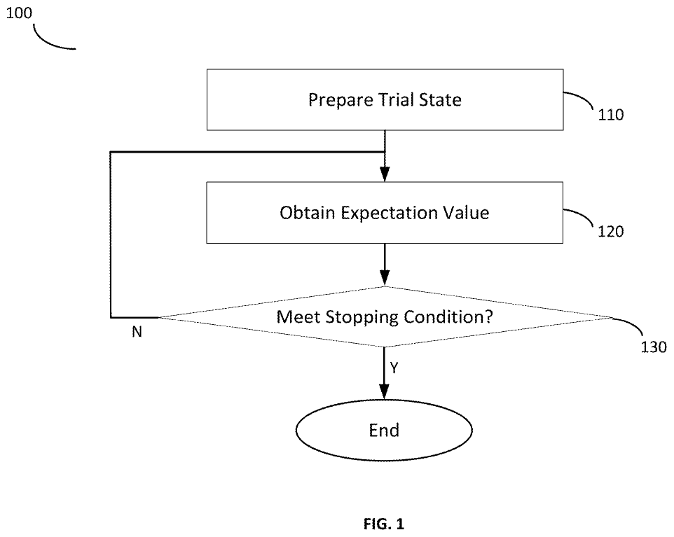

In some non-limiting examples, the mean-field wavefunction may be obtained by implementing a QMF ansatz on a quantum computer. FIG. 1 shows a non-limiting example method 100 of solving a problem using a QMF ansatz according to an example. The method 100 comprises actions of: preparing a trial state 110, obtaining an expectation value of the Hamiltonian 120, and determining if a stopping condition has been met 130. If not, processing resumes at action 120. Otherwise, processing is completed.

In some non-limiting examples, in action 110, a trial state may be prepared to initialize the quantum computer. In some non-limiting examples, the trial state may be prepared using a VQE. In some non-limiting examples, other procedures for preparing trial states may be applicable. In some non-limiting examples, the trial state may be prepared by an initial estimate of angles of qubits, a Hamiltonian, and a QMF ansatz.

In some non-limiting examples, the initial estimate of the angles may be made on a classical computer operably coupled with the quantum computer, and provided to the quantum computer by the classical computer.

In some non-limiting examples, the Hamiltonian may be provided to, including without limitation, embedded on, the quantum computer, such that a measurement topology, which may be used to yield a distribution of measurements characteristic of the solutions to the Hamiltonian, may be generated. In some non-limiting examples, in a universal gate quantum computer, where the Hamiltonian may be used to generate the measurement topology, a set of one-qubit rotations, including without limitation, X, Y, and Z gates, may be generated, to rotate the qubits into a trial state before measurement. In some non-limiting examples, the rotation may give the quantum computer its characteristic distribution of measurements. In some non-limiting examples, in an annealer, the Hamiltonian may be physically embedded, including without limitation, as at least one of: qubit coupling, and bias.

In some non-limiting examples, the QMF ansatz may be implemented to set a quantum circuit on the quantum computer. In some non-limiting examples, the QMF ansatz may be implemented by adopting a parameterization of the Hilbert space of an individual qubit, including without limitation, spin coherent states, as described herein. In some non-limiting examples, spin coherent states may parameterize the Hilbert space in so-called “Bloch states” defined by one of: a raising, and lowering, spin operator acting on a particle with spin j in spherical polar coordinates, rather than Euler angles. In some non-limiting examples, the energy of an analogously presented Hamiltonian, using such a parametrization, was found to be an upper bound to the exact energy, as described, by way of non-limiting example, in Lieb et al. Commun. Math. Phys. 31, 327 (1973), which is herein incorporated by reference in its entirety. In some non-limiting examples, direct product of states |Ω [symbol] may provide a basis for an n-qubit system, and a target eigenvalue, including without limitation, a ground-state energy, may be bound from above by an expectation value E_{QMF}:

$${E}_{0} \leq 〈 Ω \vert \hat{H} \vert Ω 〉 = {\sum }_{I} {C}_{I} {F}_{I} ( {n}_{1}^{ω} , … {n}_{n}^{ω} ) \qquad ( E13 )$$

$${E}_{QMF} = {\sum }_{I} {C}_{I} {F}_{I} ( {n}_{1}^{ω} , … {n}_{n}^{ω} ) \qquad ( E14 )$$

In some non-limiting examples, the right hand side Σ_{I}C_{I}F_{I}(n₁^{ω}, . . . nₙ^{ω}) of Equations (E13) and (E14) may comprise a QMF expectation value functional, and each F_{I} may be obtained from P_{I}, in Equation (E1), by substitution of ωᵢ→Jnᵢ^{ω}. In some non-limiting examples, operator products of ωᵢ may be converted to ordinary numerical products. In some non-limiting examples, nᵢ^{ω} may be shorthand for w component of the unit vector on a Bloch sphere, where n=(cos φ sin θ, sin φ sin θ, cos θ)→(Xᵢ, Yᵢ, Zᵢ). In some non-limiting examples, the QMF ansatz may comprise X and Z rotation gates acting upon n qubits without at least one of: additional entanglement gates, and an ansatz depth parameter d of Kandala et al. As such, the QMF ansatz may be an independent-qubit model. In some non-limiting examples, the QMF ansatz may be implemented similarly to the VQE of Kandala et al., where effectively d=0. In some non-limiting examples, implementation of the QMF ansatz may scale with 2×n gates linearly.

In some non-limiting examples, in action 120, the expectation value of the Hamiltonian may be obtained by measuring expectation values for each term of the Hamiltonian and summing them.

In some non-limiting examples, in action 130, there may be a determination of whether a stopping condition is met. If so, processing is completed. If not, processing resumes at action 120 by varying the angles to minimize the expectation value obtained as a result of action 120. In some non-limiting examples, the stopping condition may be reaching a criterion. In some non-limiting examples, the criterion may comprise a threshold value of a control parameter. In some non-limiting examples, the criterion may comprise a predetermined number of iterations. In some non-limiting examples, the criterion may comprise a predetermined calculation time, including without limitation a time at which the qubits have lost coherence. In some non-limiting examples, the criterion may comprise a minimum, including without limitation, a local minimum and a global minimum. In some non-limiting examples, the minimized expectation value may comprise a solution to the problem.

As a result of the foregoing, the QCC wavefunction may be parametrized as:

$$Ψ = \hat{U} ( τ ) \vert Ω 〉 = {\prod }_{k} exp ( - i {τ}_{k} {T}_{k} / 2 ) \vert Ω 〉 \qquad ( E15 )$$

In some non-limiting examples, a factor of ½ may, in some non-limiting examples, be introduced for computational convenience.

In some non-limiting examples, the QCC wavefunction may be implemented on a quantum computer, including without limitation, a universal quantum computer, as a quantum circuit to perform calculations by a set of gate operations. In some non-limiting examples, the entanglers, which may be at least one of: determined by a user, and selected based on certain criteria, may be represented as multi-qubit entanglement gates in the circuit.

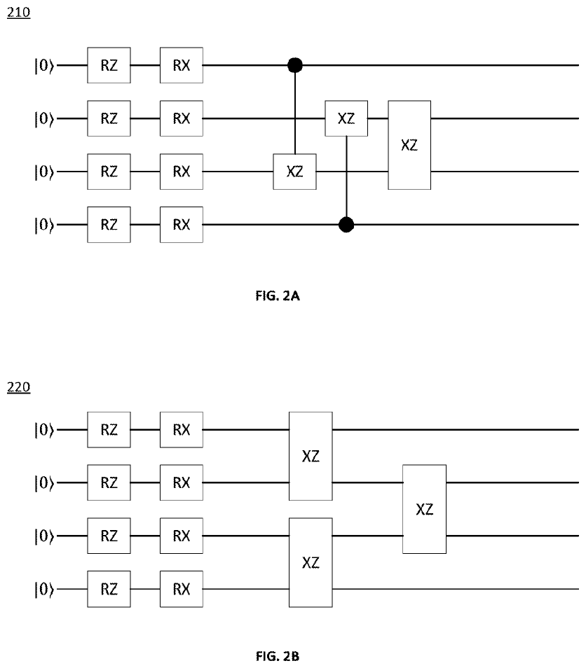

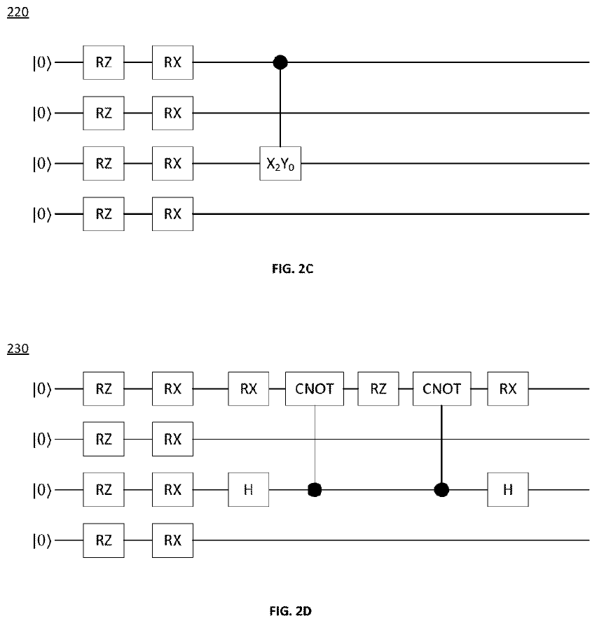

FIG. 2A-2D show non-limiting examples of quantum circuits constructed based on various entanglement schemes according to some examples. In some non-limiting examples, an initial state of a qubit may be set as |0 [symbol] .

In some non-limiting examples, entanglers may be generated based on the alpha-beta molecular orbital blending schemes. In some non-limiting examples, each qubit may represent one of: an alpha, and a beta, spin molecular orbital. In some non-limiting examples, the nearby orbitals may be molecular orbitals, which may be directly one of: above, and below, the current orbital in question based on an eigenvalue, including without limitation, an energy value. In a quantum circuit 200, as shown in FIG. 2A, alternating qubits may be represented as alpha and beta spin orbitals, such that a beta qubit may be arranged in between each neighboring alpha qubit. The quantum circuit 200 may be constructed in such a way that each alpha qubit may be entangled with at least one alpha qubit, which may not be adjacent to such alpha qubit, and that each beta qubit may be entangled with at least one beta qubit, which may not be adjacent to such beta qubit. In a quantum circuit 210, as shown in FIG. 2B, two adjacent qubits may be represented as alpha spin orbitals, and the other two adjacent qubits may be represented as beta spin orbitals. The quantum circuit 210 may be constructed in such a way that each alpha qubit may be entangled with at least one adjacent alpha qubit, and each beta qubit may be entangled with at least one adjacent beta qubit.

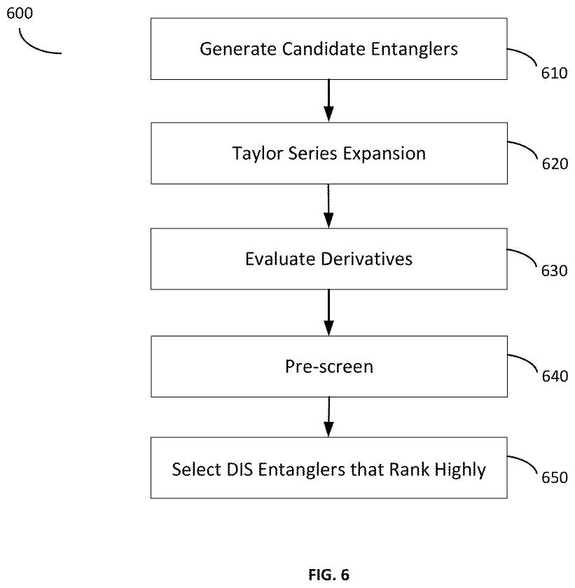

In some non-limiting examples, entanglers may be selected by various methods 600, 800, 900, as will be discussed later in FIGS. 6, 8 and 9. By way of non-limiting examples, FIG. 2C shows a quantum circuit 220 comprising an entanglement gate representing an entangler, by way of non-limiting examples, x₂y₀, selected based on rankings of Pauli word operators. In some non-limiting examples, Pauli word operators may be decomposed into a set of quantum logical gates comprising, without limitation, at least one of: CNOT, RZ, RX, and Hadamard gates. By way of non-limiting example, the Pauli word entangler represented by x₂y₀ may be decomposed into a set of gates comprising two CNOT gates, an RZ gate, two RX gates, and two Hadamard gates, as shown in the quantum circuit 230 in FIG. 2D. It will be understood by those having ordinary skill in the art that in some non-limiting examples, the exact selection of quantum gates in a quantum circuit may not be exactly the same as those obtained as a result of decomposition of an original entangler, and in some non-limiting examples, may be modified based on hardware and the native set of gates that a certain type of quantum computers may use natively, which in some non-limiting examples may be at least one of: RX, RZ, CNOT, and Hadamard, gates, for a universal quantum computer.

In some non-limiting examples, the reference state |Ω [symbol] and the cluster amplitude τ may be variationally optimized together under the VQE framework.

In some non-limiting examples, the expectation value of a qubit Hamiltonian for the QCC parameterization of the wavefunction represented by Equation (E15) may be given by:

$$E ( τ , Ω ) = 〈 Ψ \vert \hat{H} \vert Ψ 〉 = 〈 Ω \vert {\hat{U} ( τ )}^{†} \hat{H} \hat{U} ( τ ) \vert Ω 〉 \qquad ( E16 )$$

In some non-limiting examples, the general VQE scheme may provide a variational upper bound for a target eigenvalue, including without limitation, a ground-state energy, of the system with the Hamiltonian. In some non-limiting examples, the minimization of the expectation value may yield an estimate of a target eigenvalue. In some non-limiting examples, estimates may be used to optimize the control parameters, in some non-limiting examples, in a gradient descent algorithm. In some non-limiting examples, the control parameters may be minimization of the energy of a quantum state. In some non-limiting examples, the control parameters may be an operator that commutes with the Hamiltonian. In some non-limiting examples, the minimization of the expectation value, with respect to the amplitudes τ and angles in Ω, may yield an estimate for the target eigenvalue.

$${E}_{QCC} = {min}_{Ω , τ} 〈 Ω \vert {\hat{U} ( τ )}^{†} \hat{H} \hat{U} ( τ ) \vert Ω 〉 \qquad ( E17 )$$

In some non-limiting examples, the expectation value of the qubit Hamiltonian may be determined by measuring an expectation value of each single term of the Hamiltonian. In some non-limiting examples, the measured expectation value may be fed into an energy optimizer, in some non-limiting examples, running on a classical computer, to perform the minimization.

In some non-limiting examples, Equation (E17) may be rewritten as:

$${E}_{QCC} = {min}_{τ} \{ {min}_{Ω} 〈 Ω \vert {\hat{H}}_{d} ( τ ) \vert Ω 〉 \} \qquad ( E18 )$$

and thus, may define a canonically transformed Hamiltonian, also referred to as a “dressed” Hamiltonian:

$${\hat{H}}_{d} ( τ ) = {\hat{U} ( τ )}^{†} \hat{H} \hat{U} ( τ ) \qquad ( E19 )$$

In some non-limiting examples, the above QCC procedure of obtaining E_{QCC} may be performed iteratively by utilizing the dressed Hamiltonian as a starting point for each iteration.

Without wishing to be bound by any particular theory, it may be postulated that the QCC/iQCC method may, by constructing the generators of the ansatz directly in qubit space, bypass a fermionic construction, leading to savings of quantum resources. Further, it has now been found that, by reformulating the QCC procedure iteratively under the iQCC scheme, the unitary component in the ansatz may be included sequentially at the operator level rather than in the state preparation, such that the amplitudes may be optimized sequentially, leading to a reduced number of quantum circuits. In some non-limiting examples, in molecular applications, there may be some scenarios calling for employing an entanglement ansatz in fermionic construction based on the alpha-beta orbital blending method.

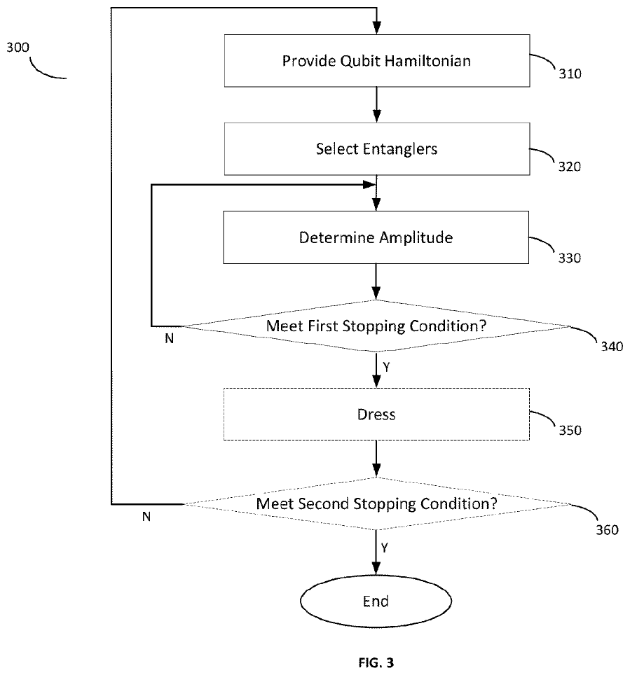

Turning now to FIG. 3, there is shown a non-limiting example implementation 300 of the QCC/iQCC method for solving a problem, according to an example. The method 300 comprises actions of: providing a qubit Hamiltonian 310, selecting a set of entanglers 320, determining corresponding amplitudes of the entanglers 330, and determining if a first stopping condition has been met 340. If not, processing resumes at action 330. Otherwise, processing is completed. In some non-limiting examples, the method 300 may further comprise, after action 340, an action of determining if a second stopping condition has been met 360. If it is determined at action 360 that a second stopping condition has been met, processing is completed. If not, processing resumes at action 310. In some non-limiting examples, an action of dressing to obtain a transformed Hamiltonian 350 may precede the action 360.

In some non-limiting examples, in action 310, a qubit Hamiltonian that is suitable for the problem to be solved may be provided. In some non-limiting examples, an expectation value of the provided Hamiltonian may provide a variational upper bound for a target eigenvalue thereof. In some non-limiting examples, the qubit Hamiltonian H may assume a general form of a linear equation comprising Pauli operators X, Y, Z

$$\hat{H} = {\sum }_{I} {C}_{I} {\hat{P}}_{I} \qquad ( E20 )$$

where:
C_{I} is at least one coefficient; and
P_{I} is at least one Pauli word given by Equation (E1).

In some non-limiting examples, the at least one coefficient C_{I} may be spatially dependent.

In some non-limiting examples, the qubit Hamiltonian may be derived from an electronic Hamiltonian.

In some non-limiting examples, the qubit Hamiltonian may be a mean-field Hamiltonian in qubit space.

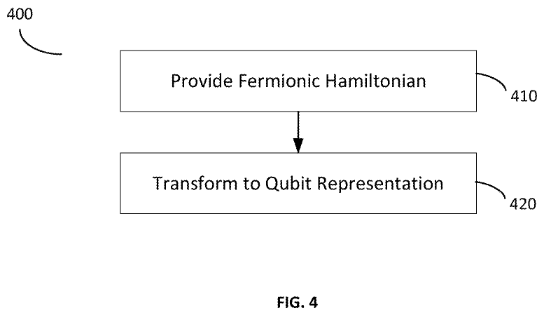

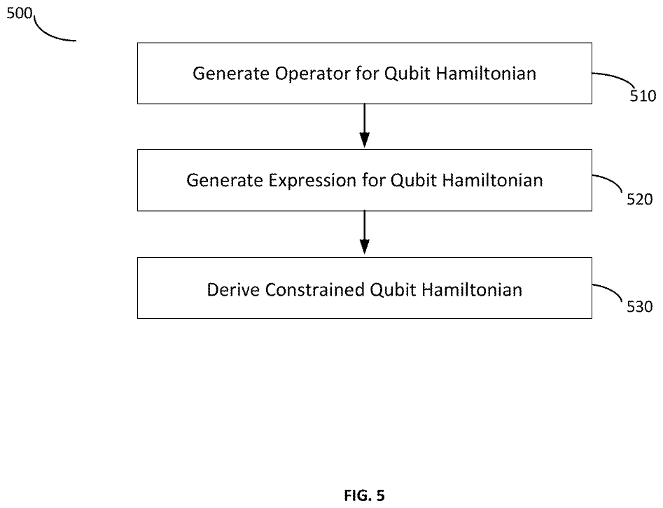

In some non-limiting examples, the action 310 of providing the qubit Hamiltonian may be obtained by transforming a fermionic Hamiltonian into a qubit representation, which may be further discussed in FIG. 4.

In quantum chemistry applications, the qubit Hamiltonian may be a molecular Hamiltonian in qubit space, where the qubit may be assumed to be realized as at least one spin state; however, other implementations of qubits may be possible. In some non-limiting examples, the qubit Hamiltonian may comprise a spin orbital Hamiltonian.

In some non-limiting examples, in action 320, a set of entanglers included in the unitary operator, which may be translated into a sequence of quantum circuit operations, may be selected according to one of the following considerations:
a system-dependent consideration, including without limitation, selecting at least one entangler that may provide the fastest convergence toward a target eigenvalue of the Hamiltonian, including without limitation, the lowest eigenvalue, which in some non-limiting examples, may be a ground-state energy; and
a hardware-dependent consideration, including without limitation, selecting at least one entangler that may be efficiently implemented as at least one quantum gate with the lowest noise and largest coherence times.

In some non-limiting examples, the entanglers may be selected in such a way that they may improve implementation of the unitary transformation represented by the unitary operator on a quantum computer by, including without limitation, at least one of: reducing a number of circuit operations, using circuit operations suitable for a particular quantum hardware, and reducing errors.

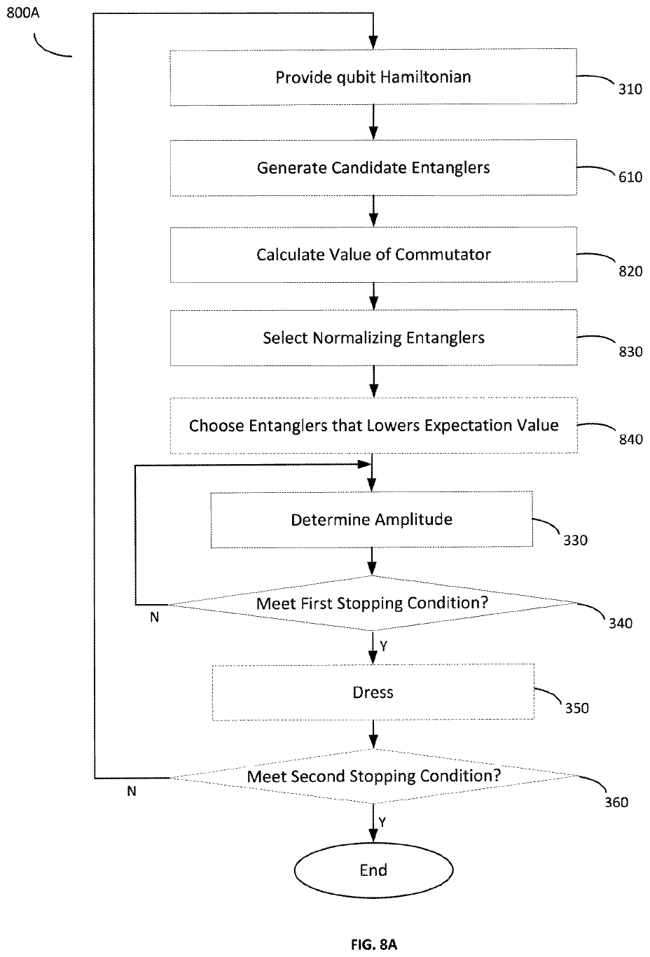

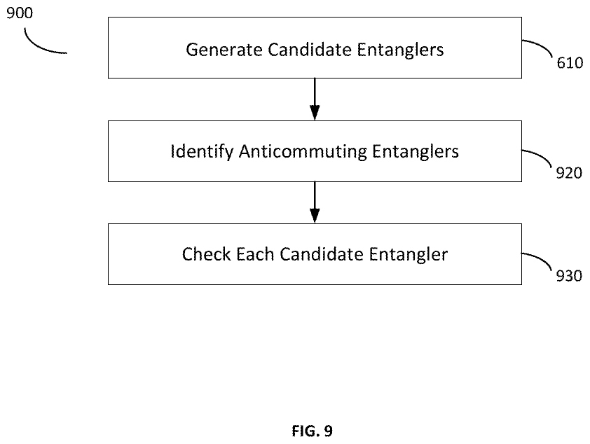

In some non-limiting examples, the entanglers may be selected by various appropriate methods, including without limitation, at least one of the methods 600 (FIG. 6), 800 (FIG. 8), and 900 (FIG. 9), as described herein.

In some non-limiting examples, the entangler(s) Tₖ selected may be Pauli entangler(s). In some non-limiting examples, the Pauli entangler may take a form of a Pauli word Pₖ, whose length may vary from two to the number of qubits. In some non-limiting examples, a general entangler may be decomposed to a form comprising Pauli words.

In some non-limiting examples, the selection of entanglers may be performed on a classical computing system.

In some non-limiting examples, once the selection of entanglers is made, the ansatz parametrized by the unitary operator may be implemented on a quantum computer, and thus the corresponding quantum circuit may be used to execute to produce the QCC wavefunction Ψ, and perform the QCC calculations.

In some non-limiting examples, in action 330, calculations may be performed to determine corresponding amplitudes τₖ of the selected entanglers. In some non-limiting examples, a set of amplitudes τₖ may be returned.

In some non-limiting examples, in action 340, there may be a determination of whether a first stopping condition is met. If so, processing is completed. If not, processing resumes at action 330 to optimize the amplitude, such that the amplitude that minimizes the target eigenvalue of the qubit Hamiltonian may be found.

In some non-limiting examples, the first stopping condition may be:
reaching a threshold change of the expectation value of the qubit Hamiltonian between iterations. In some non-limiting examples, this may be represented as:

$$E ( {τ}_{M} ) - E ( {τ}_{M + 1} ) = {ε}_{τ} \qquad ( E21 )$$

where:
εᵣ is a threshold condition.

In some non-limiting examples, the threshold change may be small enough such that the expectation value for the amplitude obtained in the (M+1)^{st} iteration is found to be close to the expectation value for the amplitude obtained from the M^{th} iteration.

In some non-limiting examples, in fermionic applications, including without limitation, molecular orbital calculations, cr may be in a range of one of between about: 10⁻⁵-10⁻⁹ Hartree, 10⁻⁶-10⁻⁹ Hartree, 10⁻⁷-10⁻⁹ Hartree, and 10⁻⁸-10⁻⁹ Hartree.

In some non-limiting examples, the expectation value of the qubit Hamiltonian may be evaluated, including without limitation, at one of: a quantum computer, and a quantum simulator, which in some non-limiting examples, may be operably coupled with the classical computing system.

It will be appreciated, by those having ordinary skill in the relevant art, that in some non-limiting examples, other first stopping conditions may be applicable, including without limitation, one of: performing a number of iterations, evaluating a pre-set number of entanglers, and achieving a pre-set threshold for an expectation value of the qubit Hamiltonian.

In some non-limiting examples, the optimization of the amplitudes may be performed on one of: a quantum computer, and a classical computing system.

In some non-limiting examples, the QCC procedure of FIG. 3 may be applied once and end at a first instance of action 340, once the amplitude is optimized.

In such scenario, the minimized expectation value, obtained, based on the set of entanglers selected in action 320, and the amplitude optimized, as a result of actions 330 and 340, may give an estimate of the target eigenvalue, and may comprise a solution to the problem.

Without wishing to be bound by any particular theory, such approach may have reduced applicability in some scenarios calling for, including without limitation, finding a functional trade-off between: a set of entanglers Tₖ (which may, in some non-limiting examples, comprise a longer set) to obtain a satisfactory solution (including without limitation, a lower target eigenvalue), and an ability of a quantum computer to operate with the selected set of entanglers Tₖ. In some non-limiting examples, there may be scenarios calling for applying the QCC procedure iteratively. In such scenarios, the method may be referred to as an Iterative QCC (iQCC) method.

In some non-limiting examples, in action 350, the Hamiltonian provided in action 310 may be dressed to obtain a transformed Hamiltonian. In some non-limiting examples, the coefficients in the Hamiltonian may be updated through the dressing procedure. In some non-limiting examples, starting from Equation (E15), both the set of entanglers selected in action 320, and the corresponding amplitudes optimized as a result of actions 330 and 340, may be used to dress the original Hamiltonian, represented as Equation (E19).

In some non-limiting examples, dressing may be carried out on a classical computer.

In some non-limiting examples, the original Hamiltonian may be dressed by transforming the original Hamiltonian with a unitary transformation and then subjecting the unitarily transformed Hamiltonian to a Euler expansion represented as:

$$\begin{matrix}\hat{H} [ τ ; T ] = exp ( i τ T / 2 ) H exp ( - i τ T / 2 ) \\ = H - \frac{1}{2} i sin τ [ H , T ] + \frac{1}{2} ( 1 - cos τ ) T [ H , T ] \\ = ( cos ( τ / 2 ) + i sin ( τ / 2 ) T ) H ( cos ( τ / 2 ) - i sin ( τ / 2 ) T ) \\ = H + sin ( τ ) / 2 ( TH - HT ) + ( 1 - cos ( τ ) ) / 2 ( THT - H )\end{matrix} \qquad ( E22 )$$

It has now been found that in some non-limiting examples where entanglers are not trotterized, at each iteration, a closed expression may exist for the transformed Hamiltonian due to the involutory property of the entanglers.

In some non-limiting examples, the operator product contained in the transformed Hamiltonian may be evaluated on a classical computer using, without limitation, Pauli polynomial manipulation. In some non-limiting examples, the transformed Hamiltonian obtained after evaluation may be of the same structure as the original Hamiltonian. In some non-limiting examples, the transformed Hamiltonian may contain more terms than the original Hamiltonian. In some non-limiting examples, if all three of the terms in Equation (E22) are algebraically independent, a 3-fold increase in a number of terms of the transformed Hamiltonian may be expected. It has now been found that in some non-limiting examples, expansion of the length of the Hamiltonian may be less pronounced because summands [H, (TH−HT), (THT−H)] may share at least one common term.

It has now been found that in some scenarios where all the entanglers Tₖ are exhausted in a dressing action in the N^{th} iteration, the transformed Hamiltonian H to be provided for use in a next iteration may be characterized by the result of the target eigenvalue in the N^{th} iteration that may be computed solely using the Bloch state |Ω [symbol] , without entangling gates, that is:

$$E ( N ) ≡ 〈 Ψ \vert H \vert Ψ 〉 = 〈 Ω \vert {\hat{U} ( τ )}^{†} \hat{H} \hat{U} ( τ ) \vert Ω 〉 = 〈 Ω \vert H ( N + 1 ) \vert Ω 〉 \qquad ( E23 )$$

In some non-limiting examples, in action 360, there may be a determination of whether a second stopping condition is met. If so, processing is completed. If not, processing resumes at action 310, where the transformed Hamiltonian obtained in the previous iteration may be substituted for the provided Hamiltonian of action 310 for a subsequent iteration, since the transformed Hamiltonian obtained by a sequence of unitary transformations may possess the same exact eigenvalue as the original Hamiltonian.

Therefore, in some non-limiting examples, H(N+1) may be used in place of the original H(N), as a starting point for a new iteration of the iQCC procedure, in which a new set of entanglers Tₖ(N+1) may be obtained and converted into a quantum circuit, and an optimization cycle may be run to determine new amplitudes τₖ(N+1) and the Bloch angles. By virtue of the variational principle, a new expectation value E(N+1) thus obtained, may be no more than about the expectation value in previous iteration E(N) as illustrated:

$$E ( N + 1 ) \underline{<} E ( N ) \qquad ( E24 )$$

and, in some non-limiting examples, be closer to the exact eigenvalue, which may improve description of the system under analysis.

In some non-limiting examples, the second stopping condition may be: reaching a threshold change of an expectation value of the qubit Hamiltonian between iterations. In some non-limiting examples, the threshold change may be small enough such that the expectation value of the Hamiltonian in the (N+1)^{st} iteration is found to be close to the expectation value of the Hamiltonian obtained from the previous iteration.

In some non-limiting examples, this may be represented as:

$$E ( N ) - E ( N + 1 ) = {ε}_{H} \qquad ( E25 )$$

where:
ε_{H} is a threshold condition.

In some non-limiting examples, in fermionic applications, including without limitation, molecular orbital calculations, ε_{H} may be in a range of one of between about: 10⁻⁵-10⁻⁹ Hartree, 10⁻⁶-10⁻⁹ Hartree, 10⁻⁷-10⁻⁹ Hartree, and 10⁻⁸-10⁻⁹ Hartree.

It will be appreciated, by those having ordinary skill in the relevant art, that in some non-limiting examples, other second stopping conditions may be applicable, including without limitation, one of: performing a number of iterations, evaluating a pre-set number of entanglers, and reaching a pre-set threshold for a target eigenvalue of the qubit Hamiltonian (including without limitation, the Hamiltonian becoming intractable).

In some non-limiting examples, the minimized expectation value, obtained by iteratively applying the QCC procedure, may give an estimate of the target eigenvalue, and may comprise a solution to the problem.

In some non-limiting examples, the methods and systems disclosed herein may be applicable to a Hartree-Fock (HF) method, which may, in some non-limiting examples, express a wavefunction as a determinant of a number of spin-orbitals in a computational basis. In some non-limiting examples, the methods and systems disclosed herein may be applied to at least one of: a post-HF method, a density functional theory (DFT) method, a time-dependent HF method, a time dependent density functional theory (TD-DFT) method, and other types of quantum chemical calculation methods.

FIG. 4 shows a non-limiting example method 400 of providing a qubit Hamiltonian according to an example. In some non-limiting examples, the method 400 may be used to set up a quantum chemistry problem, including without limitation, a many-body fermionic problem. In some non-limiting examples, the qubit Hamiltonian obtained as a result of the method 400 may be used in action 310 of the method 300 of FIG. 3. The method 400 comprises actions of: providing a fermionic Hamiltonian 410, and transforming the fermionic Hamiltonian to a qubit representation 420.

In some non-limiting examples, in action 410, a fermionic Hamiltonian may be provided in a form suitable to represent a system under analysis and the problem to be solved. In some non-limiting examples, the fermionic Hamiltonian may be expressed in a computational basis that may be convenient for computation.

In some non-limiting examples, the computational basis may be derived from different sources, including without limitation: Fock-orbitals, molecular orbitals (MO), atomic orbitals (AO), Huckel orbitals, Kohn-Sham orbitals, and MP2 natural orbitals. In some non-limiting examples, when using atomic orbitals, the basis functions may be provided from, without limitation, at least one of: Gaussian-type orbitals, Slater-type orbitals (STO), and numerical atomic orbitals. In some non-limiting examples, a basis set may comprise a minimal basis set, including without limitation, a STO-nG basis set that is derived from a minimal Slater-type orbital basis set, where n is an integer of at least 1. In some non-limiting examples, the Slater-type basis set may comprise polarized versions thereof. In some non-limiting examples, a basis set may comprise a split valence basis set, including without limitation, a Pople basis set, including without limitation, one of: 3-21G, 3-21G*, 3-21G**, 3-21+G, 3-21++G, 3-21+G*, 3-21+G**, 4-21G, 4-31G, 6-21G, 6-31G, 6-31G*, 6-31+G*, 6-31G(3df, 3pd), 6-311G, 6-311G*, and 6-311+G*. In some non-limiting examples, a basis set may comprise a Dunning-type basis set, including without limitation, at least one of: cc-pVDZ, cc-pVTZ, cc-pVQZ, cc-pV5Z, aug-cc-pVDZ, and cc-pCVDZ.

In some non-limiting examples, a fermionic Hamiltonian in the second-quantized form, which may operate in Fock space, may be provided. In some non-limiting examples, by providing the fermionic Hamiltonian in such a form, quantum many-body states may be represented in a Fock state basis, which discusses the occupation of each single-particle state by a certain number of identical particles.

In some non-limiting examples, the fermionic Hamiltonian in the second-quantized form may be derived by one- and two-electron integrals. In some non-limiting examples, the fermionic Hamiltonian in the second quantized form may be expressed as:

$$\hat{H} = {\sum }_{i , j} {h}_{i , j} {a}_{i}^{†} {a}_{j} + \frac{1}{2} {\sum }_{i , j , k , l} {h}_{i , j , k , l} {a}_{i}^{†} {a}_{j}^{†} {a}_{k} {a}_{l} \qquad ( E26 )$$

where:
i, j, k, l are each an index of one of: a spin orbital, and an MO being acted upon,
aᵢ^{†}, aᵢ are respectively, a fermionic creation operator and a fermionic annihilation operator, and
h_{i,j} is the one-electron integral, and
h_{i,j,k,l} is the two-electron integral.

While a second-quantized fermionic Hamiltonian is provided herein as a non-limiting example, those having ordinary skill in the relevant art will appreciate that, in some non-limiting examples, Hamiltonians may be formulated in various other forms, including without limitation, one of a higher-order Hamiltonian, and a lower-order Hamiltonian.

In some non-limiting examples, action 410, including the computation of the one- and two-electron integrals, may be carried out on a classical computer and the result thereof may be sent to a quantum computer. In some non-limiting examples, the one- and two-electron integrals may be directly calculated on a quantum computer.

In some non-limiting examples, in action 420, the fermionic Hamiltonian obtained as a result of action 410 may be transformed into a qubit representation by adopting a fermion-to-qubit transformation. In some non-limiting examples, the transformation may comprise a basis transformation.

In some non-limiting examples, the fermionic Hamiltonian may be transformed into a qubit representation by a Jordan-Wigner (J-W) transformation, through which interacting fermions are mapped to spin operators. In some non-limiting examples, the creation and annihilation operators may be mapped to operations on the qubits in terms of Pauli operators:

$${\hat{Q}}^{+} = \vert 1 〉 〈 0 \vert = 1 / 2 ( X - iY ) \qquad ( E27 )$$

$${\hat{Q}}^{-} = \vert 0 〉 〈 1 \vert = 1 / 2 ( X + iY ) \qquad ( E28 )$$

In some non-limiting examples, the creation and annihilation operators, which respectively create and annihilate electrons from their orbitals, may be mapped in an occupation number basis, such that each qubit may store an occupation number of an orbital indexed by the qubit. In some non-limiting examples, the J-W representation, which may, in some non-limiting examples, preserve occupation behavior, may result in non-locality of a parity operator.

In some non-limiting examples, the fermionic Hamiltonian may be transformed into a qubit representation by mapping the fermionic operators into operators in a parity basis. In some non-limiting examples, the parity basis may result in non-locality of an occupation number operator.

In some non-limiting examples, the number of qubit operations to simulate a single fermionic operator may scale in one of: an identical, and similar, manner in the occupation number basis and the parity basis, which in some non-limiting examples, may scale as O(k), where k is a number of single-particle states.

In some non-limiting examples, the fermionic Hamiltonian may be transformed into a qubit representation by a Bravyi-Kitaev (B-K) transformation, in which qubits may store partial sums of an occupation number and a parity.

In some non-limiting examples, a B-K transformation may reduce the scaling of the number of qubit operations used to simulate a single fermionic operator to, in some non-limiting examples, O(log k), including without limitation, as detailed in Seeley et al., J. Chem. Phys. 137, 224109 (2012), which is incorporated by reference in its entirety herein. In some non-limiting examples, the B-K transformation may combine aspects of both a parity basis and an occupation number basis, such that both the parity and the occupation number operators may be evaluated on a reduced set of qubits that may be updated for any single operation. In some non-limiting examples, partial sums may be evaluated up to an index containing a full parameterization of an occupation number operator and a parity operator of the qubit under consideration.

In some non-limiting examples, the qubit Hamiltonian obtained as a result of action 420 may assume a general form represented as Equation (E20).

In some non-limiting examples, the qubit Hamiltonian derived herein may be isospectral with respect to the fermionic Hamiltonian. In some non-limiting examples, eigenvalues of the qubit Hamiltonian may be eigenvalues of the fermionic Hamiltonian, such that a target eigenstate of the qubit Hamiltonian may be a solution to the problem.

While the present disclosure provides a non-limiting example of providing a qubit Hamiltonian by transforming a fermionic Hamiltonian, involving a fermion-to-qubit transformation, including without limitation, J-W, parity encoding, and B-K, transformation, those having ordinary skill in the relevant art will appreciate that other fermion-to-qubit transformations may be appropriate, and that a Hamiltonian in a form other than a fermionic Hamiltonian may be formulated depending on the system under analysis and the problem to be solved, in order to obtain a qubit Hamiltonian in a general form expressed in Equation (E20).

In some non-limiting examples, quantum computing systems and techniques, including without limitation, simulated annealing techniques, may have noise associated therewith. In some non-limiting examples, such noise may cause measurement of a qubit to be inaccurate, including without limitation, reading a qubit, that should be 0, as 1. In some non-limiting examples, the VQE algorithm may be susceptible to this noise, resulting in at least one of: an expectation value higher than an exact target eigenvalue, and a slowing down of the time to convergence.

In some non-limiting examples, the noise may be caused by, without limitation, at least one of: an unwanted state, and a state with an unwanted value, contained in a qubit Hamiltonian. In some non-limiting examples, the qubit Hamiltonian may be transformed by adding a penalty functional to penalize certain states by, without limitation, one of: removing an unwanted state, and shifting an unwanted value for a state to an acceptable value.

FIG. 5 shows a non-limiting example method 500 of obtaining a constrained qubit Hamiltonian by implementing a constraint using a projector according to an example. In some non-limiting examples, the method 500 may be used to at least one of: remove, and shift, certain states of a qubit Hamiltonian. In some non-limiting examples, such state may be, including without limitation, at least one of: spin, and number, states. In some non-limiting examples, the constrained qubit Hamiltonian obtained as a result of the method 500 may be provided as a qubit Hamiltonian for use in action 310 of method 300.

In some non-limiting examples, a projector, as an observable in quantum mechanics, may be expressed as:

$$P = \vert {ψ}_{i} 〉 〈 {ψ}_{i} \vert \qquad ( E29 )$$

where:
   |ψᵢ [symbol] is a common set of eigenfunctions possessed by operators that commute the qubit Hamiltonian.

The method 500 comprises actions of: generating at least one operator for a qubit Hamiltonian 510, generating an expression for the qubit Hamiltonian based on the at least one operator, and a target eigenvalue thereof 520, and deriving a constrained qubit Hamiltonian 530.

In some non-limiting examples, in action 510, at least one operator, that commutes with the qubit Hamiltonian, may be generated for the qubit Hamiltonian. In some non-limiting examples, the generated operator may comprise at least one Pauli word. In some non-limiting examples, the generated operator may share the same Pauli terms as the qubit Hamiltonian, resulting in a calculation of the values of these operators with one of: minimal, and no additional, computational cost.

In some non-limiting examples of fermionic applications, at least one of: a number operator, and a spin operator, may be generated. In some non-limiting examples, such generated operator(s) may be generated using, without limitation, at least one of: B-K transformation, and J-W transformation, on their fermionic spin and number operators.

In some non-limiting examples, the number operator may be represented as:

$$\hat{N} = {\sum }_{i} {a}_{i}^{†} {a}_{i} \qquad ( E30 )$$

where:
aᵢ^{†} and aᵢ are respectively, a fermionic creation operator and a fermionic annihilation operator.

In some non-limiting examples, a constraint on a number operator may be:

$${ℰ}_{N} ( {Ω}_{1} , … , {Ω}_{4} , μ ) = {E}_{QMF} ( {Ω}_{1} , … , {Ω}_{4} ) + {\frac{μ}{2} [ {N}_{QMF} ( {Ω}_{1} , … , {Ω}_{4} ) - 1 ]}^{2} \qquad ( E31 )$$

where:
μ is a penalty parameter and in some non-limiting examples, may be at least about 1.

In some non-limiting examples, the spin operator may be at least one of: a total spin-squared operator S², and a projection of a total spin operator S_{z}.

In some non-limiting examples, a constraint on a total spin operator may be:

$${ℰ}_{s} ( {Ω}_{1} , … , {Ω}_{4} , μ ) = {E}_{QMF} ( {Ω}_{1} , … , {Ω}_{4} ) + {\frac{μ}{2} [ {S}_{QMF}^{2} ( {Ω}_{1} , … , {Ω}_{4} ) - {S}^{2} ]}^{2} \qquad ( E32 )$$

where:
S is a total spin that may be constrained to be zero; and
μ is a penalty parameter, and in some non-limiting examples, may be at least about 1.

While spin operators and a number operator are provided as non-limiting examples of constraints, those having ordinary skill in the relevant art will appreciate that other operators may be used as a constraint. In some non-limiting examples, operators that commute with the qubit Hamiltonian may be used as a constraint. In some non-limiting examples, a commutator itself may be used as a constraint.

In some non-limiting examples, in action 520, an expression may be generated for the qubit Hamiltonian based on the at least one operator and a target eigenvalue thereof. In some non-limiting examples, the eigendecomposition of the qubit Hamiltonian H may be described as:

$$H = {\sum }_{i} {E}_{i} \vert {ψ}_{i} 〉 〈 {ψ}_{i} \vert \qquad ( E33 )$$

where:
   |ψᵢ [symbol] is a common set of eigenfunctions possessed by the generated operator that commutes the qubit Hamiltonian,
Eᵢ is a target eigenvalue of the generated operator.

In some non-limiting examples, in action 530, a qubit Hamiltonian constrained by the generated operator and the eigenvalue thereof may be derived.

In some non-limiting examples, the derived constrained qubit Hamiltonian Hₐᵢ may be generalized as:

$${H}_{ai} = H - {H ( A - {a}_{i} )}^{2} - {( A - {a}_{i} )}^{2} H \qquad ( E34 )$$

where:
A is the generated operator, and
aᵢ is the target eigenvalue of the operator A.

In some non-limiting examples, the form of operator A may be, at most, quadratic.

In some non-limiting examples in which a spin operator is used, Equation (E34) may be reduced to:

$${S}^{2} H = {\sum }_{i} {S}_{i} ( {S}_{i} + 1 ) {E}_{i} \vert {ψ}_{i} 〉 〈 {ψ}_{i} \vert , S = 0 , 1 , … 20 \qquad ( E35 )$$

In some non-limiting examples, if a singlet state is selected in such that S=0, the qubit Hamiltonian may be further represented as:

$${H}_{S = 0} = H - {HS}^{2} - {S}^{2} H \qquad ( E36 )$$

In some non-limiting examples, the eigendecomposition of Equation (E36) may result:

$${H}_{S = 0} = {\sum }_{i} {E}_{i} \vert {ψ}_{i} 〉 〈 {ψ}_{i} \vert + {\sum }_{i} - {E}_{i} [ 2 {S}_{i} ( {S}_{i} + 1 ) - 1 ] \vert {ψ}_{i} 〉 〈 {ψ}_{i} \vert \qquad ( E37 )$$

It has now been found that, in some non-limiting examples, Equation (E37) may cause non-singlet eigenstates of the qubit Hamiltonian (including without limitation, the target eigenstates), to be shifted to positive energies for the ground state and low-lying states. In some non-limiting examples, such shift may improve the accuracy of VQE-style algorithms that sample nearby negative energy states.

### Selection of Entanglers

### DIS Method

Under the VQE framework, in order to find a target eigenvalue by minimizing the expectation value of the Hamiltonian, a full optimization for the amplitudes rand the Bloch angles Ω may, in some non-limiting examples, be called for, for each one of a total of 4^{Nq}−3N_{q}−1 possible entanglers, which, in some non-limiting examples, may be computationally expensive for a large system and be hampered by available quantum resources. In some non-limiting examples, there may be a call to screen for a set of entanglers that contribute non-trivially to a qubit Hamiltonian based on certain measures.

FIG. 6 shows a non-limiting example method 600 of selecting entanglers for a qubit Hamiltonian using a Direct Interaction Set (DIS) method according to an example. In some non-limiting examples, the entanglers may be selected from a DIS based on the ranking of the entanglers by their contribution to a target eigenstate of the qubit Hamiltonian. In some non-limiting examples, the action 320 of selecting entanglers of the method 300 in FIG. 3 may employ the method 600, whereupon the highest ranked entangler(s) may be selected for use in action 330. The method 600 comprises actions of: generating a set of candidate entanglers 610, performing a Taylor series expansion to expand an QCC expectation value functional 620, evaluating derivatives for each candidate entangler 630, pre-screening to select entanglers that meet the derivative condition 640, and selecting DIS entanglers that rank high for optimization 650.

In some non-limiting examples, in action 610, a set of candidate entanglers may be generated. In some non-limiting examples, the set of candidate entanglers may comprise a set of multi-qubit operators. In some non-limiting examples, the generated candidate entanglers may at least one of: comprise Pauli words Pₖ, and be comprised of products of Pauli words. In some non-limiting examples, the Pauli word entanglement operators may be generated based on a number of qubits, such that the length may be in a range of between about 2 to the number of qubits. In some non-limiting examples, the set of candidate entanglers may be generated directly from the qubit Hamiltonian itself. In some non-limiting examples, the candidate entanglers may be generated by selecting a set of entanglers using various selecting methods disclosed herein, including without limitation, methods 800, 900 described herein.

In some non-limiting examples, the candidate entanglers may be generated at a classical computing system.

In some non-limiting examples, in action 620, a Taylor series expansion may be performed to expand an QCC expectation value functional. In some non-limiting examples, starting from a QCC wavefunction constructed by the QCC ansatz, including without limitation, that represented by Equation (E15), the QCC expectation value may be given by:

$$E [ τ ; {\hat{P}}_{k} ] = {min}_{Ω} 〈 Ω \vert {e}^{i τ {\hat{P}}_{k} / 2} \hat{H} {e}^{- i τ {\hat{P}}_{k} / 2} \vert Ω 〉 \qquad ( E38 )$$

In some non-limiting examples, the QCC expectation value functional may generate an expansion via the Taylor series expansion, which in some non-limiting examples, may yield a three-term equation, when truncated at second order, as represented by Equation (E39):

$${{E [ τ ; {\hat{P}}_{k} ] = {E}_{QMF} + τ \frac{dE [ τ ; {\hat{P}}_{k} ]}{d τ} \vert}_{τ = 0} + \frac{{τ}^{2}}{2} \frac{{d}^{2} E [ τ ; {\hat{P}}_{k} ]}{d {τ}^{2}} \vert}_{τ = 0} \qquad ( E39 )$$

where:

E_{QMF} is a QMF expectation value.

Equation (E39) may generate the first and second derivatives (also referred to as gradients) with respect to the amplitude τ, taken τ=0, given respectively by:

$${\frac{dE [ τ ; {\hat{P}}_{k} ]}{d τ} \vert}_{τ = 0} = 〈 {Ω}_{min} \vert - \frac{i}{2} [ H , {\hat{P}}_{k} ] \vert {Ω}_{min} 〉 \qquad ( E40 )$$

$${{\frac{{d}^{2} {E}_{e} ( τ )}{d {τ}^{2}} \vert}_{τ = 0} = \frac{{\partial }^{2} {E}_{e}}{\partial {τ}^{2}} \vert}_{\begin{matrix}τ = 0 \\ {φ}_{i} = {φ}_{i}^{0}\end{matrix}} - {c}^{T} {D}^{- 1} c \qquad ( E41 )$$

$$where :$$

$${\frac{{\partial }^{2} {E}_{e}}{\partial {τ}^{2}} \vert}_{\begin{matrix}τ = 0 \\ {φ}_{i} = {φ}_{i}^{0}\end{matrix}} = 〈 {Ω}_{min} \vert \frac{i}{2} \hat{P} [ \hat{H} , \hat{P} ] \vert {Ω}_{min} 〉 \qquad ( E42 )$$

$${c}_{i} = 〈 \frac{\partial {Ω}_{min}}{\partial {φ}_{i}} \vert - \frac{i}{2} [ \hat{H} , \hat{P} ] \vert {Ω}_{min} 〉 + 〈 {Ω}_{min} \vert - \frac{i}{2} [ \hat{H} , \hat{P} ] \vert \frac{\partial {Ω}_{min}}{\partial {φ}_{i}} 〉 \qquad ( E43 )$$

$${D}_{ij} = 〈 \frac{{\partial }^{2} {Ω}_{min}}{\partial {φ}_{i} \partial {φ}_{j}} \vert \hat{H} \vert {Ω}_{min} 〉 + 〈 \frac{\partial {Ω}_{min}}{\partial {φ}_{i}} \vert \hat{H} \vert \frac{\partial {Ω}_{min}}{\partial {φ}_{j}} 〉 + 〈 \frac{\partial {Ω}_{min}}{\partial {φ}_{j}} \vert \hat{H} \vert \frac{\partial {Ω}_{min}}{\partial {φ}_{i}} 〉 + 〈 {Ω}_{min} \vert \hat{H} \vert \frac{{\partial }^{2} {Ω}_{min}}{\partial {φ}_{i} \partial {φ}_{j}} 〉 \qquad ( E44 )$$

In some non-limiting examples, in action 630, the derivatives generated during the Taylor Series expansion may be evaluated for each candidate entangler. In some non-limiting examples, the derivatives may be calculated on a classical computer.

In some non-limiting examples, only the first derivatives may be evaluated. In some non-limiting examples, for those entanglers that have one of: zero, and close-to-zero, values in the first derivative, the second derivatives may also be evaluated.

In some non-limiting examples, in action 640, the candidate entanglers may be pre-screened to select the entanglers that meet the derivative condition. In some non-limiting examples, the number of entanglers may be truncated based on the value of at least one of: the first, and second, derivatives.

In some non-limiting examples, candidate entanglers that have non-zero values in the first derivative may be selected. In some non-limiting examples, candidate entanglers that have non-close-to-zero values in the first derivative may be selected. In some non-limiting examples, among the candidate entangles that have one of: zero, and close-to-zero, values in the first derivative, those having a negative second derivative may be selected.

In some non-limiting examples, candidate entanglers that result in an absolute value in the first derivative of one of at least about: 0.01 a.u., 0.001 a.u., 0.0001 a.u., 0.0001 a.u., and 0.00001 a.u., may be considered to be acting as an entangler. In some non-limiting examples, candidate entanglers that have an absolute value in the first derivative that is no more than about 0.001 a.u., and have a negative second derivative, may be considered to be acting as an entangler.

In some non-limiting examples, a set of all entanglers with non-zero absolute gradients evaluated on the qubit Hamiltonian may be referred to as a DIS. In some non-limiting examples, the DIS may be constructed on a classical computer given the qubit Hamiltonian.

As used herein, a DIS entangler may be referred to as any entangler that meets the derivative condition, where, depending on the criteria of the derivative condition, a DIS entangler may be, without limitation, at least one of: entanglers having a non-zero value in the first derivative, entanglers having a non-close-to-zero value in the first derivative, and entanglers having one of: a zero, and close-to-zero, value in the first derivative, while having a negative value in the second derivative.

In some non-limiting examples, in action 650, DIS entanglers that rank highly may be selected for optimization. In some non-limiting examples, the DIS entanglers may be ranked based on their contribution to the qubit Hamiltonian, including without limitation, lowering a target eigenvalue, including without limitation, a ground-state energy. In some non-limiting examples, the ranking may be performed based on an overall correlation energy.

It has now been found that in some non-limiting examples, the selected entanglers that comprise Pauli words, including without limitation, those minimizing the individual QCC expectation value, may avoid breaking fermionic symmetry.

In some non-limiting examples, the DIS method 600 may be used with the QCC/iQCC method 300 as described in FIG. 3, such that the selected entanglers that rank highly may be integrated into the qubit Hamiltonian, to yield an estimate for a target eigenvalue, by minimizing the expectation value, with respect to the amplitudes τ and angles in Ω, as discussed herein.

Without wishing to be bound any particular theory, it has now been found, in some non-limiting examples, that the DIS method may be efficient in lowering the expectation value fast per entangler, and thus a fast convergence to an exact target eigenvalue may be achieved by building the QCC ansatz using the top-ranked DIS entanglers, even with a small number of top-ranked entanglers, including without limitation, a single top-ranked DIS entangler.

In some non-limiting examples, the QMF expectation value E_{QMF} present in the Taylor Series expansion given by Equation (E39) may be obtained by minimizing the expectation value functional with respect to all Bloch angles Ω, represented as:

$${E}_{QMF} = {min}_{Ω} 〈 Ω \vert \hat{H} \vert Ω 〉 \qquad ( E45 )$$

In some non-limiting examples, a fixed value may be set for the reference QMF state IΩ [symbol] , such that a process of solving a QMF problem to calculate Bloch angles and the QMF expectation value E_{QMF} may be omitted for computational efficiency without considerably compromising the accuracy. In some non-limiting examples, there may be some scenarios calling for solving the QMF problem and an optimized reference QMF state |Ω [symbol] including without limitation, where a complicated QMF problem may be involved, such that a fixed value may become an unacceptable trade-off. However, in some non-limiting examples, searching for a global minimum of QMF eigenvalue may be challenging, and the minimization procedure may lead to a convergence, that may not be called for in some scenarios, to a number of local minima.

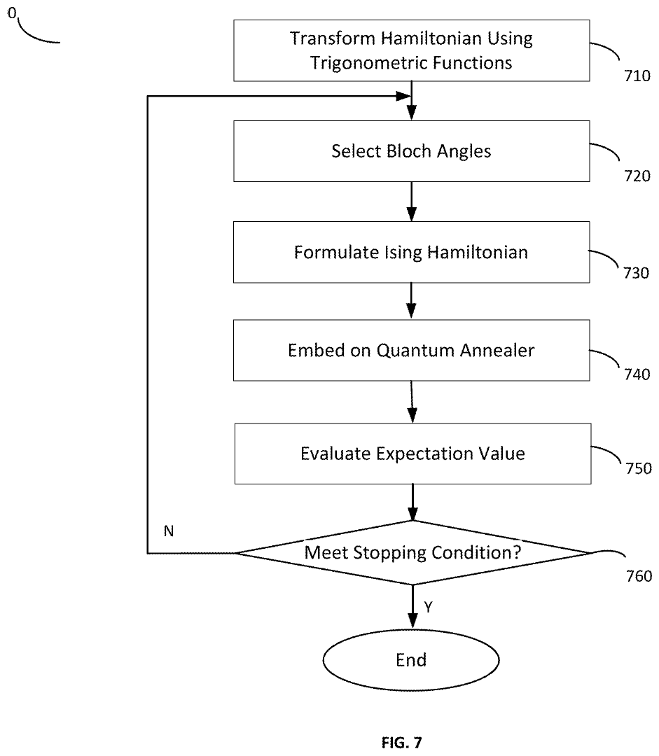

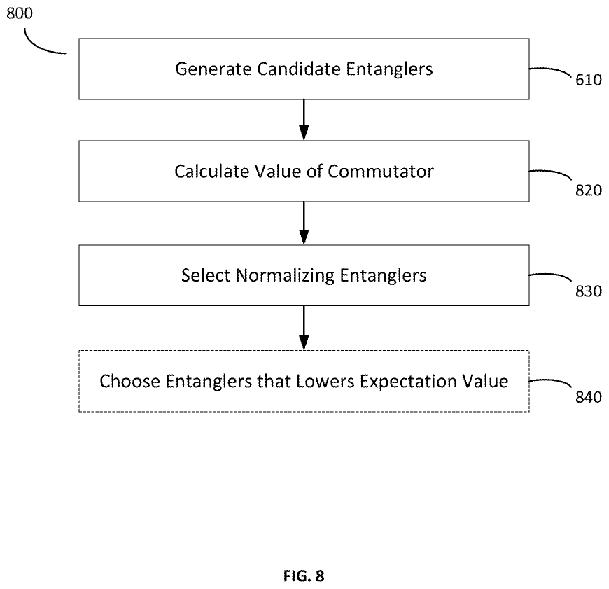

FIG. 7 shows a non-limiting example method 700 of solving a QMF problem using a quantum annealer according to an example. In some non-limiting examples, the solution, which may be a QMF expectation value, obtained as a result of method 700, may be used during the Taylor Series expansion performed in action 620 of the method 600 of FIG. 6. The method 700 comprises actions of: transforming a Hamiltonian using trigonometric functions 710, select Bloch angles in the transformed qubit Hamiltonian 720, formulating an Ising Hamiltonian based on the transformed qubit Hamiltonian and the selected Bloch angles 730, embedding the Ising Hamiltonian on a quantum annealer 740, evaluate an expectation value of the Ising Hamiltonian 750, and determining if a stopping condition has been met 760. If not, processing resumes at action 720. If it is determined at action 760 that the stopping condition has been met, processing is completed.

In some non-limiting examples, in action 710, the Hamiltonian may be transformed using trigonometric functions with a Bloch sphere rotation substitution. In some non-limiting examples, the Hamiltonian may be a qubit Hamiltonian, including without limitation, the qubit Hamiltonian represented by Equation (E20).

In some non-limiting examples, the Hamiltonian, after transformation, may be represented in a sine and cosine form of the Bloch angles. In some non-limiting examples, where the Hamiltonian may comprise Pauli operators, the Pauli operators present in the Hamiltonian may be replaced with functions according to:

$${X}_{i} \to cos {φ}_{i} sin {θ}_{i} \qquad ( E46 )$$

$${Y}_{i} \to sin {φ}_{i} sin {θ}_{i} \qquad ( E47 )$$

$${Z}_{i} \to cos {θ}_{i} \qquad ( E48 )$$

In some non-limiting examples, Bloch angles, including without limitation, azimuthal angles φ, and polar angles θ, in the transformed qubit Hamiltonian may be selected based on fermionic occupation. In some non-limiting examples, the domain for the Bloch angles may be:

$${φ}_{i} ∈ [ 0 , 2 π ) , {θ}_{i} ∈ [ 0 , π ) \qquad ( E49 )$$

where:
i is an index in a range from 1 to a number of qubits.

In some non-limiting examples, in action 730, an Ising Hamiltonian may be formulated by a domain-folding procedure based on the transformed qubit Hamiltonian and the selected Bloch angles, such that a target eigenvalue, including without limitation, the ground-state energy, of the Hamiltonian may be solved using the Ising formulation.

In some non-limiting examples, at least one variable, including without limitation, the angles φ, θ, may be folded to reduce the domain space thereof. In some non-limiting examples, the folding may be performed by encoding the trigonometric factors in the reduced domain by introducing new discrete variables. In some non-limiting examples, the folding may be performed more than once for at least one of the variables.

In some non-limiting examples, the Ising Hamiltonian obtained after the folding may take a general form represented as:

$${H}_{Is} = {Σ}_{i} {h}_{i} {Z}_{i} + {Σ}_{i , j} {J}_{ij} {Z}_{i} {Z}_{j} \qquad ( E50 )$$

where:
Zᵢ is the Pauli Z operator acting on the I^{th} qubit;
hᵢ and Jᵢⱼ are constants, and may, in some non-limiting examples, be independently tuned.

Without wishing to be bound by any particular theory, it has been found that the domain-folding procedure may in some non-limiting examples, reduce the number of local minima, and concomitantly easily locate a global minimum, and shorten convergence times in finding a solution to the QMF problem.

In some non-limiting examples, in action 740, the Ising Hamiltonian obtained, as a result of action 730, may be embedded on a quantum annealer.

In some non-limiting examples, in action 750, an expectation value of the Ising Hamiltonian may be evaluated.

In some non-limiting examples, in action 760, there may be a determination of whether a stopping condition is met. If so, processing is completed. If not, processing resumes at action 720 to optimize the Bloch angles.

In some non-limiting examples, the stopping condition may comprise at least one of: reaching a threshold change of the expectation value of the Ising Hamiltonian between iterations, and a set number of iterations. In some non-limiting examples of fermionic applications, including without limitation, molecular orbital calculations, the threshold change may be in a range of one of between about: 10⁻⁵-10⁻⁹ Hartree, 10⁻⁶-10⁻⁹ Hartree, 10⁻⁷-10⁻⁹ Hartree, and 10⁻⁸-10⁻⁹ Hartree.

### Normalizers

In some non-limiting examples, the intermediate Hamiltonians generated by various iterations of the iQCC procedure may exhibit rapid, including without limitation, exponential, growth, with respect to the number of the entanglers and the number of iterations upon dressing, which, in some non-limiting examples may limit, including without limitation, at least one of: the problem size, and the number of possible iterations. In some non-limiting examples, there may be a call to limit the growth of Hamiltonian upon dressing.

With respect to the dressed Hamiltonian represented by Equation (E22), it has now been found that, in some non-limiting examples, the increased terms may be produced by a commutator [H, T] of the Hamiltonian and an entangler in the second portion, since THT may contain the same terms as H in the third portion, and thus may not introduce new terms.

Without wishing to be bound by any particular theory, it may be postulated that, in some non-limiting examples, a Pauli entangler that commutes with all the terms of a qubit Hamiltonian, may not increase the size of a qubit Hamiltonian upon dressing. Without wishing to be bound by any particular theory, it may be postulated that, in some non-limiting examples, a value of the commutator of the Pauli entangler and the qubit Hamiltonian may be one of: zero, and approximately the dressed qubit Hamiltonian, such that no new terms may be generated in the dressed qubit Hamiltonian:

$$[ {\hat{H}}^{k - 1} , {\hat{T}}_{k} ] = 0 ; or \qquad ( E51 )$$

$${\hat{H}}^{k - 1} α {\hat{H}}^{k} \qquad ( E52 )$$

Such Pauli entanglers may be referred to in the present disclosure as one of: normalizer, and a normalizing entangler. In some non-limiting examples, the coefficients of the Hamiltonian Ĥ^{k-1} may be different than those of Ĥ^{k}, while Ĥ^{k-1} and Ĥ^{k} having the same Pauli terms.

FIG. 8 shows a non-limiting example method 800 of selecting normalizing entanglers for a qubit Hamiltonian according to an example. In some non-limiting examples, the action 320 of selecting entanglers of the method 300 in FIG. 3 may employ the method 800, whereupon the selected normalizing entangler(s) may be selected for use in action 330. The method 800 comprises actions of: generating a set of candidate entanglers 610, calculating a value of a commutator of each candidate entangler with the qubit Hamiltonian 820, and selecting a set of normalizing entanglers 830. In some non-limiting examples, the method 800 may further comprise an action of choosing the entanglers that lowers an expectation value of the qubit Hamiltonian 840.

In some non-limiting examples, the action 840 may be performed after action 830. In some non-limiting examples, the action 840 may be performed between action 610 and 820.

In some non-limiting examples, in action 610, a set of candidate entanglers may be generated.

In some non-limiting examples, the candidate entanglers may be generated by selecting a set of entanglers using various selecting methods disclosed herein, including without limitation, methods 600 and 900 disclosed herein.

Without wishing to be bound by any particular theory, it has now been found that a normalizing entangler may exist in a set of pairwise products of each Pauli term of the qubit Hamiltonian. Therefore, in some non-limiting examples, the set of candidate entanglers may be provided by calculating pairwise products of each Pauli term of the qubit Hamiltonian.

In some non-limiting examples, in action 820, a value of a commutator of each candidate entangler in the set of candidate entanglers with the qubit Hamiltonian may be calculated, such that a set of normalizing entanglers that commute with all the terms of the qubit Hamiltonian may be identified. In some non-limiting examples, the calculation of the value of commutators may be performed at a classical computing system.

In some non-limiting examples, identification of the normalizing entanglers may be performed through a brute force search in all the candidate entanglers, such that each candidate entangler may be compared against the terms in the original qubit Hamiltonian.

In some non-limiting scenarios, where the candidate entanglers are provided by pairwise products of each Pauli term of the qubit Hamiltonian, a search may be performed in all the pairwise products of the Pauli terms of a qubit Hamiltonian based on:

$$H = {\sum }_{i = 1}^{N} {c}_{i} {P}_{i} , H \times H \qquad ( E53 )$$

In some non-limiting examples, in action 830, the set of candidate entanglers may be filtered to select a set of normalizing entanglers. In some non-limiting examples, the set of candidate entanglers may be filtered for those entanglers that satisfy the relation represented by Equation (E53) to prioritize the entanglers that commute with every Pauli word in the qubit Hamiltonian, such that the number of terms N of a dressed Hamiltonian does not change even if c; changes. In some non-limiting examples, selection of the set of normalizing entanglers may be performed at a classical computing system.

It has now been found that in some non-limiting examples, not all the normalizing entanglers may contribute to a convergence by lowering a target eigenvalue of the qubit Hamiltonian. Therefore, in some non-limiting examples, in action 840, among the set of normalizing entanglers, entanglers that lower the expectation value may be chosen. In some non-limiting examples, the entanglers that lower the target eigenvalue may be selected by evaluating the expectation value derivatives as represented by Equations (E40) and (E41).

Although not shown, in some non-limiting examples, rather than performing action 840 after action 830, action 840 may be performed after action 610 and before action 820 to pre-screen the set of candidate entanglers in advance, such that normalizing entanglers may be identified and selected from a set of candidate entanglers that lower the target eigenvalue of the qubit Hamiltonian.

It has now been found that transformations generated by normalizing entanglers upon dressing may assist in the iQCC calculations in that, such transformations may have the potential to converge to an exact eigenvalue of the Hamiltonian without increasing the size of Hamiltonian in a subsequent iteration, and without increasing the depth of the quantum circuit due to their efficient classical handling. In some non-limiting examples, the restricted growth of the size of Hamiltonian may result in at least one of: a reduced memory consumption, and decreased number of measurements to perform a calculation. In some non-limiting examples, the restricted growth of the quantum circuits may decrease at least one of: computational errors, and computational time, by reducing circuit operations.

In some non-limiting examples, the method 800 of selecting normalizing entanglers may be performed at least one of: alone, and in combination with various selecting methods disclosed herein, including without limitation, one of: methods 600, and 900, in iQCC calculations.

By way of non-limiting example, method 800 may be an additional screening step in addition to the DIS method 600 as illustrated in FIG. 6. In some non-limiting examples, an iQCC procedure may employ both the DIS method 600 and the normalizer method 800 to select the entanglers in different iterations. In some non-limiting examples, the normalizer method 800 may be performed one of: before, after, and alternating with, application of the DIS method 600 as illustrated in FIG. 6. In some non-limiting examples, there may be scenarios calling for a variational flexibility in the iQCC procedure, such that the amplitudes for normalizing entanglers and the amplitudes for DIS entanglers may be optimized simultaneously. In some non-limiting examples, there may be scenarios calling for yielding different sets of entanglers using the normalizing method 800 and the DIS method 600, such that the amplitudes for normalizing entanglers and the amplitudes for DIS entanglers may be optimized separately.

FIG. 8A shows a non-limiting example implementation 800A of the QCC/iQCC method for solving a problem using a set of normalizing entanglers. In some non-limiting examples, the set of normalizing entanglers may be selected by the method 800 disclosed herein. The method 800A comprises actions of: providing a qubit Hamiltonian 310, generating a set of candidate entanglers 610, calculating a value of a commutator of each candidate entangler with the qubit Hamiltonian 820, and selecting a set of normalizing entanglers 830, and determining if a first stopping condition has been met 340. If not, processing resumes at action 330. Otherwise, processing is completed. In some non-limiting examples, the method 800A may further comprise, after action 340, an action of determining if a second stopping condition has been met 360. If it is determined at action 360 that a second stopping condition has been met, processing is completed. If not, processing resumes at action 310. In some non-limiting examples, an action of dressing to obtain a transformed Hamiltonian 350 may precede the action 360. In some non-limiting examples, the method 800A may further comprise an action of choosing the entanglers that lowers an expectation value of the qubit Hamiltonian 840. In some non-limiting examples, the action 840 may be performed after action 830. In some non-limiting examples, the action 840 may be performed between action 610 and 820.

### ILC Method

In some non-limiting examples, there may be challenges in amplitude optimization, given that, in some non-limiting examples, a length of the quantum circuits and the computational time may increase with the number of amplitudes. In some non-limiting examples, there may be a call for selecting entanglers that may enable an efficient amplitude optimization.

Without wishing to be bound by any particular theory, it has now been found that in some non-limiting examples, an entangler from an Involutory Linear Combination (ILC) set may provide some computational efficiency in amplitude optimization, in at least some scenarios.

In some non-limiting examples, an ILC set of entanglers may be expressed as A={\hat{T}₁, \hat{T}₂, . . . }, subject to:

$${( {\sum }_{{\hat{T}}_{i} ∈ 𝒜} {α}_{i} {\hat{T}}_{i} )}^{2} = \hat{1} ; and \qquad ( E54 )$$

$${\sum }_{i} {α}_{i}^{2} = 1 \qquad ( E55 )$$

such that the sum of the square of coefficients may constitute a normalized vector and all the entanglers \hat{T}ᵢ∈A may be mutually anti-commutative. In some non-limiting examples, the entangler \hat{T}ᵢ may be a Pauli word.

In some non-limiting examples, the unitary operator U_{ILC} generated from the ILC expression, when acting upon the wavefunction, may take the following form:

$${U}_{ILC} \vert Φ 〉 = exp ( - i τ {\sum }_{{\hat{T}}_{i} ∈ 𝒜} {α}_{i} {\hat{T}}_{i} ) \vert Φ 〉 \qquad ( E56 )$$

Because of the anticommutativity property, the exponent of the ILC may be evaluated as:

$$exp ( - i τ P / 2 ) = cos ( τ / 2 ) - sin ( τ / 2 ) P \qquad ( E57 )$$

$$where :$$

$$P = {\sum }_{{\hat{T}}_{i} ∈ 𝒜} {α}_{i} \hat{{T}_{i}} \qquad ( E58 )$$

The expectation value of a qubit Hamiltonian, which, in some non-limiting examples, may be derived from an electronic Hamiltonian, but not limited thereto, may be expressed as:

$$〈 ϕ \vert {U}_{ILC}^{†} \hat{ℋ} {U}_{ILC} \vert φ 〉 = 〈 φ \vert {cos}^{2} ( τ ) \hat{H} - \frac{i}{2} sin ( 2 τ ) {\sum }_{i = 1}^{N} {α}_{i} [ \hat{H} , {\hat{T}}_{i} ] + {sin}^{2} ( τ ) {\sum }_{i , j = 1}^{N} {α}_{i} {α}_{j} {\hat{T}}_{i} \hat{H} {\hat{T}}_{j} ] \vert φ 〉 \qquad ( E59 )$$

Without wishing to be bound by any particular theory, it has now been found that, in some non-limiting examples, the linearity of unitary ILCs may allow for intermediate optimizations to be efficiently performed on a classical computer, and concomitantly, further relieve quantum resources. In some non-limiting examples, a reduced computational time may be used for each ILC entangler, such that an increased number of entanglers may be optimized per iteration.

A qubit Hamiltonian dressed with an ILC entangler may be found from the above equation and may take the form:

$${U}_{ILC}^{†} \hat{ℋ} {U}_{ILC} = {cos}^{2} ( τ ) \hat{H} - \frac{i}{2} sin ( 2 τ ) {\sum }_{i = 1}^{N} {α}_{i} [ \hat{H} , {\hat{T}}_{i} ] + {sin}^{2} ( τ ) {\sum }_{i , j = 1}^{N} {α}_{i} {α}_{j} {\hat{T}}_{i} \hat{H} {\hat{T}}_{j} ] \qquad ( E60 )$$

Without wishing to be bound by any particular theory, it has now been found that, in some non-limiting examples, dressing a qubit Hamiltonian with ILC entanglers may lower the expansion of the Hamiltonian upon dressing, and in some non-limiting examples, may lead to, at most, a quadratic increase in the size of the Hamiltonian.

FIG. 9 shows a non-limiting example method 900 of selecting ILC entanglers for a qubit Hamiltonian according to an example. In some non-limiting examples, the action 320 of selecting entanglers of the method 300 in FIG. 3 may employ the method 900, whereupon the selected normalizing entangler(s) may be selected for use in action 330.

The method 900 comprises actions of: generating a set of candidate entanglers 610, identifying anticommuting entanglers for a candidate entangler 920, and checking each candidate entangler against other entanglers that were determined to be anticommuting 930.

In some non-limiting examples, the candidate entanglers may be generated by selecting a set of entanglers using various methods disclosed herein, including without limitation, the methods 600, and 800 described herein.

In some non-limiting examples, in action 920, any one of the set of candidate entanglers may be picked to identify entanglers that are anticommuting with it by evaluating the anti-commuting relation based on Equations (E54), and (E55).

In some non-limiting examples, in action 930, each candidate entangler of the set may be checked for anti-commuting relation against the entanglers that were identified to be anticommuting as a result of action 920. In some non-limiting examples, the entanglers that are determined to be anticommuting may constitute a set of ILC entanglers.

In some non-limiting examples, method 900 of selecting ILC entanglers may be performed alone, or in combination with various methods disclosed herein, including without limitation, methods 600, and 800, disclosed herein, in iQCC calculations.

By way of non-limiting example, the ILC method 900 may be an additional screening step in addition to the DIS method 600 as illustrated in FIG. 6. In some non-limiting examples, the ILC method 900 may be performed one of: before, after, and alternating with, application of the DIS method 600.

In some non-limiting examples, an iQCC procedure may employ both the DIS method 600, and the ILC method 900, to select the entanglers in different iterations. In some non-limiting examples, an DIS iteration and an ILC iteration may be alternated. In some non-limiting examples, an ILC iteration may be followed by a number of DIS iterations. In some non-limiting examples, an ILC iteration may be implemented if a pre-determined condition is met after a DIS iteration. In some non-limiting examples, such condition may comprise:
a change of expectation value of the Hamiltonian between iterations being no more than a threshold value, including without limitation, an energy change that is no more than about 0.001 Ha;
a total sum of the gradients for all DIS entanglers reaching a threshold value, including without limitation, 0.002; and
the growth of the terms in the Hamiltonian reaching a threshold value.

In some non-limiting examples, the number of ILC entanglers per iQCC iteration may be at least the number of the DIS entanglers in the previous iteration. In some non-limiting examples, the number of ILC entanglers may be n times the number of IDS entanglers, where n may be one of at least about: 2, 3, 4, 5, 6, 7, 8, 9, 10, 20, 30, 40, 50, 100, 1,000, 5,000, and 10,000. In some non-limiting examples, the multiple n may be a function of the number of DIS entanglers.

### Factorization of Multi-Qubit Entanglers

In some non-limiting examples, the form of an operator, that a quantum computer may efficiently implement, may be limited. In some non-limiting examples, the maximum number of qubits, that may be entangled by a realizable unitary transformation, may be limited, such that the length of an entangler, including without limitation, a Pauli word, generating the unitary transformation may be limited. In some non-limiting examples, there may be a call to decompose a multi-qubit entangler into a form comprising operators acting on fewer qubits.

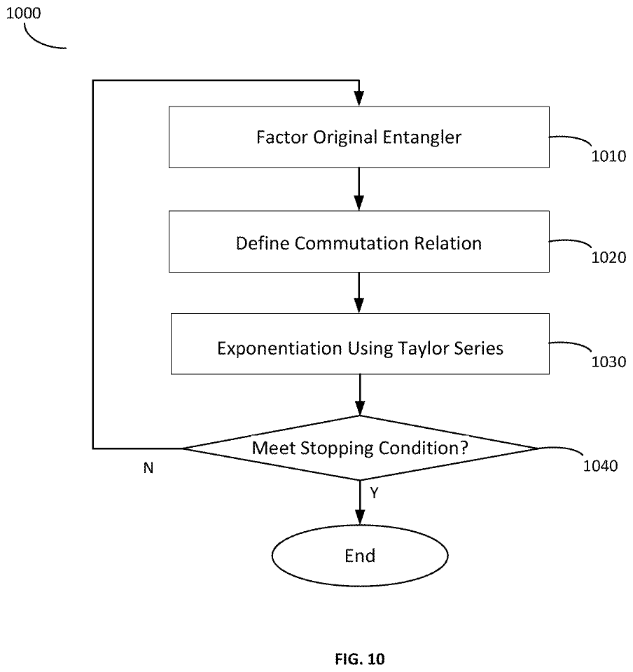

FIG. 10 shows a non-limiting example method 1000 for factorizing a unitary transformation entangling more than two qubits according to an example. In some non-limiting examples, the unitary transformation may be factored into products of unitary transformations involving fewer qubits, including without limitation, two qubits. In some non-limiting examples, the entanglers selected in one of: action 320 of the method 300, and those obtained as a result of the methods 600, 800, and 900, may be used as an original entangler of the method 1000. The method 1000 comprises actions of: factoring an original entangler involving more than two qubits with an elementary operator 1010, defining a commutation relation for the elementary operator 1020, exponentiation of the original entangler using the Taylor series expansion 1030, and determining if a stopping condition has been met 1040. If not, processing resumes at action 1010. Otherwise, processing is completed.

In some non-limiting examples, in action 1010, an original entangler involving more than two qubits may be factored into an elementary operator and two new entanglers each containing fewer qubits than the original entangler. In some non-limiting examples, the original entangler may be a Pauli entangler P with a length of at least about 3, and the length may be the number of Pauli operators in P. The Pauli word to be factored may be represented as:

$$\hat{P} = {\hat{P}}_{1} {ω}_{i} {\hat{P}}_{2} \qquad ( E61 )$$

where:
ωᵢ represents an elementary Pauli operator that corresponds to the I^{th} qubit;
P₁ is a Pauli word that contains all qubit indices lower than \dot{r}, and
P₂ is a Pauli word that contains all qubit indices greater than i.

Without wishing to be bound by any particular theory, it may be postulated that in some non-limiting examples, \hat{P}₁, \hat{P}₂, and ωᵢ may be all mutually commutative, since they may act on non-overlapping sets of qubits.

In some non-limiting examples, in action 1020, a commutation relation may be defined for the elementary operator:

$$[ {\hat{ω}}_{i}^{′} , {\hat{ω}}_{i}^{″} ] = 2 i {\hat{ω}}_{i} \qquad ( E62 )$$

Substituting Equation (E62) into the Pauli word of Equation (E61) yields the relation:

$$\hat{P} = - \frac{1}{2} [ {\hat{P}}_{1} {\hat{ω}}_{i}^{′} , {\hat{ω}}_{i}^{″} {\hat{P}}_{2} ] \qquad ( E63 )$$

$$Therefore :$$

$$\hat{P} = {e}^{i ( \frac{π}{4} ) {\hat{ω}}_{i}^{″} {\hat{P}}_{2}} {\hat{P}}_{1} {\hat{ω}}_{i}^{′} {e}^{- i ( \frac{π}{4} ) {\hat{ω}}_{i}^{″} {\hat{P}}_{2}} \qquad ( E64 )$$

In some non-limiting examples, in action 1030, exponentiation of P may be obtained as:

$${\hat{P}}^{n} = {{e}^{i ( \frac{π}{4} ) {\hat{ω}}_{i}^{″} {\hat{P}}_{2}} ( {\hat{P}}_{1} {\hat{ω}}_{i}^{′} )}^{n} {e}^{- i ( \frac{π}{4} ) {\hat{ω}}_{i}^{″} {\hat{P}}_{2}} \qquad ( E65 )$$

Subsequently, exponentiation of P using the Taylor series expansion may yield the factorization, which may represent the unitary transformation generated by an entangler P as a product of three unitary transformations generated by three unitary transformations:

$${e}^{- it \hat{P}} = {e}^{i ( \frac{π}{4} ) {\hat{ω}}_{i}^{″} {\hat{P}}_{2}} {e}^{- it {\hat{P}}_{1} {\hat{ω}}_{i}^{′}} {e}^{- i ( \frac{π}{4} ) {\hat{ω}}_{i}^{″} {\hat{P}}_{2}} \qquad ( E66 )$$

In some non-limiting examples, in action 1040, there may be a determination of whether a stopping condition is met. If so, processing is completed. If not, processing resumes at action 1010, where the new entanglers generated in the previous iteration may be substituted for the original entangler of action 1010. In some non-limiting examples, the stopping condition may be: each new entangler containing a predetermined number of qubits.

### Binary Encoding for Pauli Words

A Pauli polynomial, in general form, may be a formal linear combination of operators with numerical coefficients as generally given by:

$$Pauli Polynomial = {C}_{0} + {\sum }_{i} {C}_{i} {\hat{P}}_{i} + {\sum }_{ij} {C}_{ij} {\hat{P}}_{ij} + … \qquad ( E67 )$$

where:
C is a coefficient which may, in some non-limiting examples, be a real number, and
P is an operator comprised of Kronecker product combinations of Pauli matrices and an identity matrix that act upon a qubit and therefore has the same general form as a Pauli word represented as Equation (E1). In some non-limiting examples, the operator P may be represented as:

$$\hat{P} … jkl = … x 2 y 1 z 0 \qquad ( E 68 )$$

In some non-limiting examples, the representation of an operator Pin the form of a Pauli word having a length n in a matrix format may have a dimension 2ⁿ×2ⁿ.

In some non-limiting examples, this representation may introduce an exponential scaling 2²ⁿ with n, and thus may result in reduced applicability in terms of memory storage and efficiency as the length n of operator increases. By way of non-limiting example, in scenarios of simulation of fermions in molecular systems where the length n may be linearly proportional to the spin orbitals, a large system utilizing such representation may exhibit reduced efficiency.

In some non-limiting examples, classical computers may be employed in practical implementations of quantum computing, including without limitation, computing and storing portions of a quantum computation. Accordingly, efficient representation of portions of a quantum computation on a classical computer may have applicability in some scenarios for simulation of quantum computations on classical computers as well as for computations that may be at least partially implemented on a quantum computer.

As a result of foregoing, there may be an aim to encode the quantum information in a representation that may reduce the storage and enable fast calculations in quantum computing, including without limitation, quantum calculation comprising a Pauli polynomial.

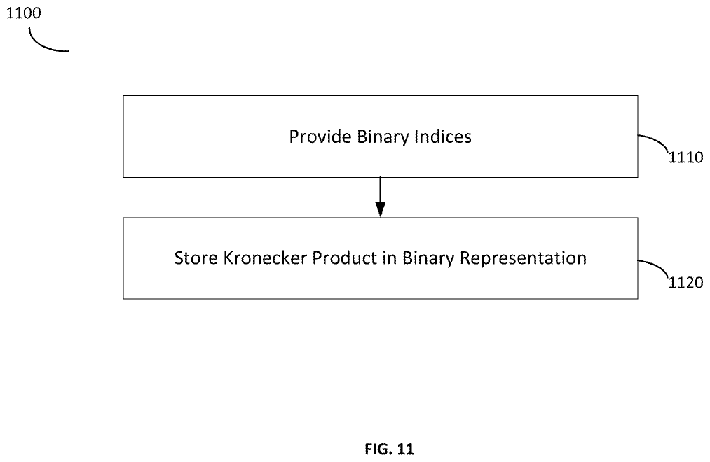

FIG. 11 shows a non-limiting example of a method 1100 for encoding quantum information comprising at least one Kronecker product of a plurality of terms selected from: an identity matrix e and Pauli X, Y, Z matrices, on a classical computer according to an example, wherein the at least one Kronecker product may comprise a phase term. The encoding method 1100 may adopt a bit representation. The method 1100 comprises actions, at a classical computer, of: providing binary indices for each of: Pauli X, Y, Z matrices, the identity matrix e, and for a phase term of the Kronecker product 1110, and storing the Kronecker product in a binary representation using the binary indices 1120.

In some non-limiting examples, in action 1110, binary indices may be provided for each of: Pauli X, Y, Z matrices matrix, the identity matrix e, and a phase term, of the Kronecker product at the classical computer.

In some non-limiting examples, Pauli X, Y, Z matrices and the identity matrix e may be represented by:

$$x = [ \begin{matrix}0 & 1 \\ 1 & 0\end{matrix} ] \qquad ( E 69 )$$

$$y = [ \begin{matrix}0 & - i \\ i & 0\end{matrix} ] \qquad ( E 70 )$$

$$z = [ \begin{matrix}1 & 0 \\ 0 & - 1\end{matrix} ] \qquad ( E 71 )$$

$$e = [ \begin{matrix}1 & 0 \\ 0 & 1\end{matrix} ] \qquad ( E 72 )$$

Without wishing to be bound by any particular theory, it has now been found that, in some non-limiting examples, at least one of: symmetry, including without limitation, tri-diagonal symmetry, of the Kronecker product, and sparsity exhibited in a number of items within the resultant matrix of the Kronecker product may contribute to a compact memory form of the Kronecker product, and reduce the storage demand.

In some non-limiting examples, rather than forming a matrix of size 2ⁿ×2ⁿ, the Kronecker product may be expressed only by two integer data types that are each of length n, by assigning a two-digit code to each of Pauli matrices and the identity matrices as the binary index, such that quantum information that comprises the Kronecker product may be encoded in a bit representation. In some non-limiting examples, each digit in the code may be one of 0 and 1, such that each of Pauli X, Y, Z matrices, and identity matrix e may be assigned a different binary index that is a code selected from:

$$\begin{matrix}1 \\ 0\end{matrix} , \begin{matrix}1 \\ 1\end{matrix} , \begin{matrix}0 \\ 1\end{matrix} , and \begin{matrix}0 \\ 0\end{matrix} .$$

By way of non-limiting example, a non-limiting example combination of the binary indices may be given as:

$$x = \begin{matrix}1 \\ 0\end{matrix} \qquad ( E 73 )$$

$$y = \begin{matrix}1 \\ 1\end{matrix} \qquad ( E 74 )$$

$$z = \begin{matrix}0 \\ 1\end{matrix} \qquad ( E 75 )$$

$$e = \begin{matrix}0 \\ 0\end{matrix} \qquad ( E 76 )$$

While a non-limiting example combination of the binary indices, assigned to Pauli X, Y, Z matrices, and identity matrix e, is provided, those having ordinary skill in the relevant art will understand that the assignment of the binary indices is not limited to a particular combination, provided that any two of Pauli X, Y, Z matrices, and identity matrix e do not share a common binary index.

Without wishing to be bound by any particular theory, it may be postulated that a first digit and a second digit of the binary index of the Pauli Xmatrix, and the Pauli Z matrix may be different. In some non-limiting examples, assigning such binary indices to Pauli X, Z matrices may provide further reduction in storage demand and additional convenience for computation, since the binary indices for Pauli Y matrix and identity matrix e may be derived therefrom. By way of non-limiting example, the binary index for Pauli Xmatrix may be one of

$$\begin{matrix}1 \\ 0\end{matrix} and \begin{matrix}0 \\ 1\end{matrix} ,$$

and the binary index for Pauli Z matrix may be the other of

$$\begin{matrix}1 \\ 0\end{matrix} and \begin{matrix}0 \\ 1\end{matrix} .$$

In some non-limiting examples, the phase term of the Kronecker product may be one of: positive (+), negative (−), imaginary (i), and negative imaginary (−i). In some non-limiting examples, a two-digit code may be provided for the phase term as a binary index. In some non-limiting examples, each digit in the code may be one of 0 and 1, such that each phase term may be assigned a different binary index that is a code selected from:

$$\begin{matrix}1 \\ 0\end{matrix} , \begin{matrix}1 \\ 1\end{matrix} , \begin{matrix}0 \\ 1\end{matrix} , and \begin{matrix}0 \\ 0\end{matrix} .$$

By way of non-limiting example, the binary index for a phase term may be provided as follows:

$$\begin{matrix}0 \\ 0\end{matrix} may be provided for a positive ( + ) phase ;$$

$$\begin{matrix}1 \\ 1\end{matrix} may be provided for a negative imaginary ( - i ) phase ;$$

$$\begin{matrix}0 \\ 1\end{matrix} may be provided for a negative ( - ) phase ; and$$

$$\begin{matrix}1 \\ 0\end{matrix} may be provided for an imaginary ( i ) phase .$$

While a non-limiting example combination of the binary indices assigned to the phase terms is provided, those having ordinary skill in the relevant art will understand that the assignment of the binary indices is not limited to a particular combination, provided that any two of the possible phases do not share a common binary index.

In some non-limiting examples, in action 1120, a Kronecker product in a binary representation comprising a set of the binary indices may be stored at the classical computer, wherein the binary index for the phase term is present in the set. In some non-limiting examples, the binary index for the phase term may be stored as a first one in the set.

In some non-limiting examples, when stored in memory on the classical computer, a binary representation of the Kronecker product may comprise a first array and a second array, wherein elements of the first array correspond to a first digit, and corresponding elements of the second array correspond to a second digit, of the codes for the Pauli matrices and the identity matrix. By way of non-limiting example, a first digit, which in some non-limiting examples, may be the top digit, of the two-digit codes for the Pauli matrices and the identity matrix may be considered to be part of an X string, and a second digit, which in some non-limiting examples, may be the bottom digit, may be considered to part of a Z string, such that a binary representation of the Kronecker product may comprise arrays X, Z In some non-limiting examples, the array may take a form of a vector.

By way of non-limiting example, if a Kronecker product was defined by: ‘xzexyy’, two arrays, represented as shown in Table 1, would each employ six bits for the terms x y, z, e without an associated phase factor. By comparison, this would, in some non-limiting examples, employ one of: a float-32, and a float-64 variable to hold the continuous variable.

TABLE 1

| | x | z | e | x | y | y |
|---|---|---|---|---|---|---|
| X | 1 | 0 | 0 | 1 | 1 | 1 |
| Z | 0 | 1 | 0 | 0 | 1 | 1 |

As disclosed herein, an additional bit for the phase term may be added to both X and Z In some non-limiting examples, the bit for the phase term may be kept at the most left-hand side of the table. Therefore, for the example provided in Table 1 above, if the phase is positive (+), the final table with a phase factor may be as represented in Table 2.

TABLE 2

| | Phase | x | z | e | x | y | y |
|---|---|---|---|---|---|---|---|
| X | 0 | 1 | 0 | 0 | 1 | 1 | 1 |
| Z | 0 | 0 | 1 | 0 | 0 | 1 | 1 |

If the phase is negative imaginary (−i), the final table with a phase factor may be as represented in Table 3.

TABLE 3

| | Phase | x | z | e | x | y | y |
|---|---|---|---|---|---|---|---|
| X | 1 | 1 | 0 | 0 | 1 | 1 | 1 |
| Z | 1 | 0 | 1 | 0 | 0 | 1 | 1 |

If the phase is negative (−), the final table with a phase factor may be as represented in Table 4.

TABLE 4

| | Phase | x | z | e | x | y | y |
|---|---|---|---|---|---|---|---|
| X | 0 | 1 | 0 | 0 | 1 | 1 | 1 |
| Z | 1 | 0 | 1 | 0 | 0 | 1 | 1 |

If the phase is imaginary (i), the final table with a phase factor may be as represented in Table 5.

TABLE 5

| | Phase | x | z | e | X | y | y |
|---|---|---|---|---|---|---|---|
| X | 1 | 1 | 0 | 0 | 1 | 1 | 1 |
| Z | 0 | 0 | 1 | 0 | 0 | 1 | 1 |

While the present disclosure contemplates a transformation from a matrix representation into a binary representation, those having ordinary skill in the relevant art will appreciate that, in some non-limiting examples, the binary encoding scheme may also be used to transform a binary representation back to a matrix representation, since in some non-limiting examples, a matrix representation may have applicability in some scenarios.

Without wishing to be bound by any particular theory, it has now been found that in some non-limiting examples, the binary representation may allow an eXclusive OR (XOR) operation, in at least certain scenarios, to multiply two Pauli terms together instead of multiplying two matrices together.

Those having ordinary skill in the relevant art may reasonably expect that a phase term may be ignored in a bit representation, in certain circumstances, as it reduces a bit of information per representation for the sake of improving scaling, as described in Bravyi, S. et al, “Tapering Off Qubits to Simulate Fermionic Hamiltonians”, arXiv:1701.08213v1 [quant-ph]27 Jan. 2017, which is incorporated herein by reference in its entirety.

However, it has now been found that storing and computing a phase factor may have applicability in at least some scenarios. Without wishing to be bound by any particular theory, multiplication of two Pauli terms may change the phase. By way of non-limiting example, the multiplication of X and X, which both have a phase of 1, may result in iY, which may have a phase of i. In some non-limiting examples, the change of phase may affect a value of the final Pauli multiplication, and thus affect the expectation value of the Pauli word and the VQE minimization. In some non-limiting examples, there may be scenarios calling for proper, including without limitation, accurate, preservation of commuting sets of qubit operators, which, in some non-limiting examples, may facilitate determining a set of entanglers that minimizes the number of terms in the Hamiltonian per entangler. As a result of the foregoing, the phase may be stored and computed when two Pauli terms are multiplied together using XOR operation.

In some non-limiting examples, the binary encoding scheme described herein may be used to transform a portion of a quantum computation from a matrix representation into a binary representation, resulting in a reduced storage load.

In some non-limiting examples, the binary encoding scheme described herein may be used to transform a qubit Hamiltonian in a general form of a linear equation comprising Pauli words, including without limitation, as represented by Equation (E20), from a matrix representation into a binary representation.

By way of non-limiting example, the representation of fermionic degrees of freedom by Pauli word, including without limitation, as discussed with respect to method 400 in FIG. 4, may be transformed from a matrix representation into a binary representation. By way of non-limiting example, a Hamiltonian with N qubits may generate O(N⁴) terms after one of: the J-W, and B-K, transformation, and each term may be stored in 2(N+1) bits, such that the memory scaling of the Hamiltonian of O(N⁴) in a binary representation may significantly reduce the storage demands compared with a scaling of O(2^{N}) for a matrix representation, leading to a more efficient and less expensive computation.

In some non-limiting examples, the binary encoding scheme described herein may be used to encode a Pauli entangler, including without limitation, those selected by implementing, including without limitation, the action 320 of the method 300 and the methods 600, 800, and 900, in a binary representation.

In some non-limiting examples, the binary encoding scheme described herein may be used to perform an Ising decomposition, and a compression of information may be obtained in the binary representation of an Ising-decomposed Hamiltonian. In some non-limiting examples, the Ising decomposition may utilize the structure of electronic Hamiltonians, including without limitation, a first-quantized Hamiltonian and a second-quantized Hamiltonian. In some non-limiting examples, the Ising decomposition may identify that the coefficients in a qubit Hamiltonian derived from the electronic Hamiltonian may be real and any Pauli Term may have one of: 0, and an even number of, Pauli Y operators. In some non-limiting examples, a general form of the qubit Hamiltonians, after Ising decomposition, may be represented as:

$$H = {I}_{0} + {Σ}_{k = 0} {I}_{k} ( Z ) {X}_{k} \qquad ( E 77 )$$

where:
Iₖ(Z) is a qubit Hamiltonian in a Pauli polynomial form containing only Pauli Z terms, which may be denoted as an Ising Hamiltonian, and
Xₖ is a Pauli X string containing all X Pauli terms.

By way of non-limiting example, a qubit Hamiltonian of an H₂ molecule with a bond distance of 0.95 Å in an STO-3G basis, converted via the J-W transformation, may have the form:

$$H = - 0.295739 + 0.142945 {z}_{0} + \qquad ( E 78 )$$

$$0.142945 {z}_{1} + 0.15 \; 8845 {z}_{0} {z}_{1} - 0.14 \; 4851 {z}_{2} + 0.108905 {z}_{0} {z}_{2} + 0.157317 {z}_{1} {z}_{2} -$$

$$0.048413 {y}_{0} {y}_{1} {x}_{2} {x}_{3} + 0.048412 {x}_{0} {y}_{1} {y}_{2} {x}_{3} + 0.048413 {y}_{0} {x}_{1} {x}_{2} {y}_{3} -$$

$$0.048413 {x}_{0} {x}_{1} {y}_{2} {y}_{3} - 0.144851 {z}_{3} + 0.157317 {z}_{0} {z}_{3} + 0.108905 {z}_{1} {z}_{3} +$$

$$0.165293 {z}_{2} {z}_{3}$$

It may be seen that this Hamiltonian may comprise 15 terms and may make use of 15 coefficients and 14 non-trivial Pauli terms. In some non-limiting examples, 15×64+14×(2×64)=2752 bytes may be employed to store this Hamiltonian using, by way of non-limiting example, 64-bit double precision for coefficients and two 64-bit words per term.

An Ising-decomposed Hamiltonian may have the following form:

$$H = {I}_{0} ( Z ) + {I}_{1} ( Z ) {x}_{0} {x}_{1} {x}_{2} {x}_{3} \qquad ( E 79 )$$

It may be seen that the Ising decomposition in the resulting Hamiltonian may comprise two general terms I₀(Z), and I₁(Z), having a form of an 11-term Ising Hamiltonian, and a 4-term Ising Hamiltonian, respectively:

$${I}_{0} ( Z ) = - 0.295739 + 0.14 \; 2945 {z}_{0} + 0.14 \; 2945 {z}_{1} + 0.158845 {z}_{0} {z}_{1} - \qquad ( E 80 )$$

$$0.144851 {z}_{2} + 0.108905 {z}_{0} {z}_{2} + 0.15 \; 7317 {z}_{1} {z}_{2} - 0.14 \; 4851 {z}_{3} +$$

$$0.157317 {z}_{0} {z}_{3} + 0.108905 {z}_{1} {z}_{3} + 0.165293 {z}_{2} {z}_{3}$$

$${I}_{1} ( Z ) = 0.048413 {z}_{0} {z}_{1} - 0.04 \; 8413 {z}_{1} {z}_{2} - 0.04 \; 8413 {z}_{0} {z}_{3} + \qquad ( E 81 )$$

$$0.04 8413 {z}_{2} {z}_{3}$$

It would be appreciated by those having ordinary skill in the relevant art that the compression for X terms may be optional since the two general terms in the form of Ising Hamiltonians comprise only Z terms. Therefore, this may employ 15 real coefficients, a single X term of X₁=x₀x₁x₂x₃, and 15 terms of the Ising Hamiltonians I₀(Z) and I₁(Z) to be stored, resulting in a memory load of 15×64 (coefficients)+15×64 (Z parts)+1×64 (X part)=1984 bytes of memory. Taking into account that the lengths of the Ising Hamiltonians may also be stored, which in this non-limiting example, would employ two 32-bit objects, resulting in a total of only 2048 bytes to store the Ising-decomposed Hamiltonian.

In some non-limiting examples, it has now been found that, the binary encoding scheme may enable a compact memory form that may be readily stored in a memory of a classical computer, including without limitation, a cache, leading to a large amount of information to be stored, and a speed-up of at least certain portions of the quantum computation, including without limitation, QCC calculations, and an optimization of amplitudes, including without limitation, as described in method 300.

In some non-limiting examples, in some scenarios where a commuting calculation comprising multiplication of Pauli operators may be performed, including without limitation, during the operation of prioritizing entanglers that commute with every Pauli product in the qubit Hamiltonian while using the iQCC method, such binary encoding may allow the binary XOR operations to replace computation of the entire relationship.

In some non-limiting examples, the brute force search for a set of ILC entangler using the method 900 may be time-consuming, and in some non-limiting examples, may involve more than 4^{N} operations, since each candidate entangler, of which there may be a total of 4^{N}−2N−1, will be checked against other candidate entanglers that were determined to be anticommuting.

In some non-limiting examples, the binary encoding scheme may provide an alternative way of generating the anticommuting set, which in some non-limiting examples, may shorten the computational time.

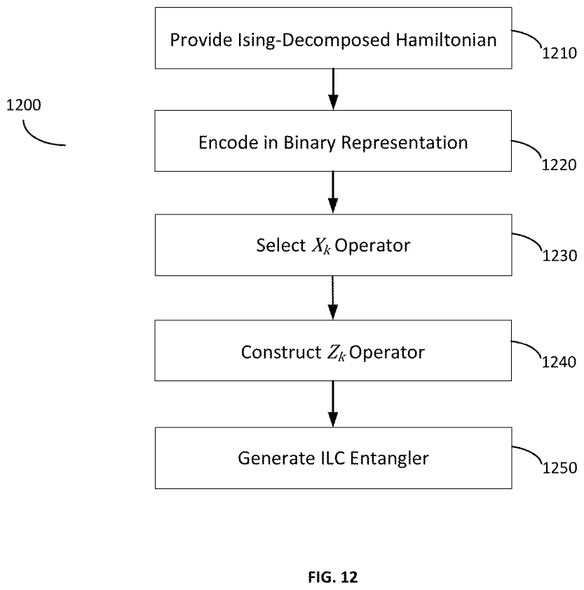

FIG. 12 shows a non-limiting example of a method 1200 for generating a set of ILC entanglers for a qubit Hamiltonian using the binary encoding according to an example. In some non-limiting examples, the qubit Hamiltonian may take a form of an Ising-decomposed Hamiltonian. In some non-limiting examples, the action 320 of selecting entanglers of the method 300 in FIG. 3 may employ the method 1200, whereupon the selected ILC entangler(s) may be selected for use in action 330. The method 1200 comprises actions of: providing an Ising-decomposed Hamiltonian 1210, encoding Pauli words contained in the Hamiltonian in a binary representation 1220, selecting at least one Xₖ operator 1230, constructing at least one Zₖ operator 1240, and generating the ILC entanglers 1250 from the at least one Xₖ operator and the at least one Zₖ operator.

In some non-limiting examples, in action 1210, an Ising-decomposed Hamiltonian, including without limitation, as represented by Equation (E77), may be provided.

In some non-limiting examples, in action 1220, Pauli words contained in the Ising-decomposed Hamiltonian may be encoded in a binary representation, such that the Pauli words may be mapped to vectors of length n with 0 and 1. In some non-limiting examples, the operators of Xₖ may be arranged into a matrix M, such that the columns of the matrix M may be the bit strings for the operators of Xₖ.

In some non-limiting examples, in action 1230, at least one Xₖ operator, which may be a Pauli X string comprising only X Pauli terms, may be selected by converting the matrix M to a reduced row-echelon form M_{rref}, since the at least one Xₖ operator to be selected may exist in certain columns of M_{rref}. In some non-limiting examples, the rows of the matrix M may be converted into a set of Pauli elementary operators.

By way of non-limiting example, the matrix M may be converted using CNOT and SWAP operations. By way of non-limiting example, the reduced row-echelon form M_{rref} may be converted using Gauss-Jordan elimination.

In some non-limiting examples, the columns of M_{rref} that may correspond to the at least one Xₖ operator to be selected, may be classified as primary and secondary columns. In some non-limiting examples, the primary and secondary columns may be identified using Table 6, to select the at least one Xₖ operator that corresponds to primary and secondary column indices.

TABLE 6

| Type | Class | Operator | Example of columns |
|---|---|---|---|
| X | Primary | Xᵢ | (0, . . . 1ᵢ, . . . ) |
| X | Secondary | X₀Xᵢ | (1, . . . 1ᵢ, . . . ) |
| Z | Primary | Πⱼ₌₀ⁱ Zⱼ | (1 . . . 1ᵢ, 0 . . . 0) |
| Z | Secondary | Πⱼ₌₀ⁿ Zⱼ | (0 . . . 0, 1ᵢ . . . 1) |

In some non-limiting examples, in action 1240, at least one Zₖ operator may be constructed in an operator form using binary encoding. In some non-limiting examples, the at least one Zₖ operator may be constructed based on the at least one Xₖ operator selected. In some non-limiting examples, binary vectors of at the least one Zₖ operator may be built for each primary and secondary column in M_{rref} using Table 6 and changed back to its operator form in a matrix representation using the binary encoding.

In some non-limiting examples, ILC entanglers for the Ising-decomposed Hamiltonian may be generated by deriving from the at least one Xₖ and the at least one Zₖ operator obtained as a result of actions 1230 and 1240.

While the present disclosure contemplates an Ising-decomposed Hamiltonian to set up the calculation, those having ordinary skill in the relevant art will appreciate that a qubit Hamiltonian in other forms, including without limitation, as represented by Equation (E20), may be adopted.

FIG. 12A shows a non-limiting example implementation 1200A of the QCC/iQCC method for solving a problem using a set of ILC entanglers. In some non-limiting examples, the set of ILC entanglers may be provided by the method 1200 disclosed herein. The method 1200A comprises actions of: providing an Ising-decomposed Hamiltonian 1210, encoding Pauli words contained in the Hamiltonian in a binary representation 1220, selecting at least one Xₖ operator 1230, constructing at least one Zₖ operator 1240, generating the ILC entanglers 1250 from the at least one Xₖ operator and the at least one Zₖ operator 1250, determining corresponding amplitudes of the entanglers 330, and determining if a first stopping condition has been met 340. If not, processing resumes at action 330. Otherwise, processing is complete. In some non-limiting examples, the method 1200A may further comprise, after action 340, an action of determining if a second stopping condition has been met 360. If it is determined at action 360 that a second stopping condition has been met, processing is completed. If not, processing resumes at action 310. In some non-limiting examples, an action of dressing to obtain a transformed Hamiltonian 350 may precede the action 360.

In some non-limiting examples, the iQCC procedure may be implemented by employing ILC entanglers and other types of entanglers, including without limitation, DIS entanglers, and normalizing entangler, in different iterations, such as discussed above.

### EXAMPLES

In some non-limiting examples, a number of terms of a qubit Hamiltonian may grow from iteration to iteration without selection of a set of entanglers. By way of non-limiting example, a large number, including without limitation, one of: 100,000, a million, and a billion, of terms in Hamiltonian may be obtained even after a small number of iterations, by way of non-limiting example, at one of: the 10^{th}, 20^{th}, and 30^{th} iteration. In some non-limiting examples, it has now been found that in some non-limiting examples, truncation of entanglers used in the qubit Hamiltonian by selecting a set of entanglers may contribute to a computationally efficient calculation.

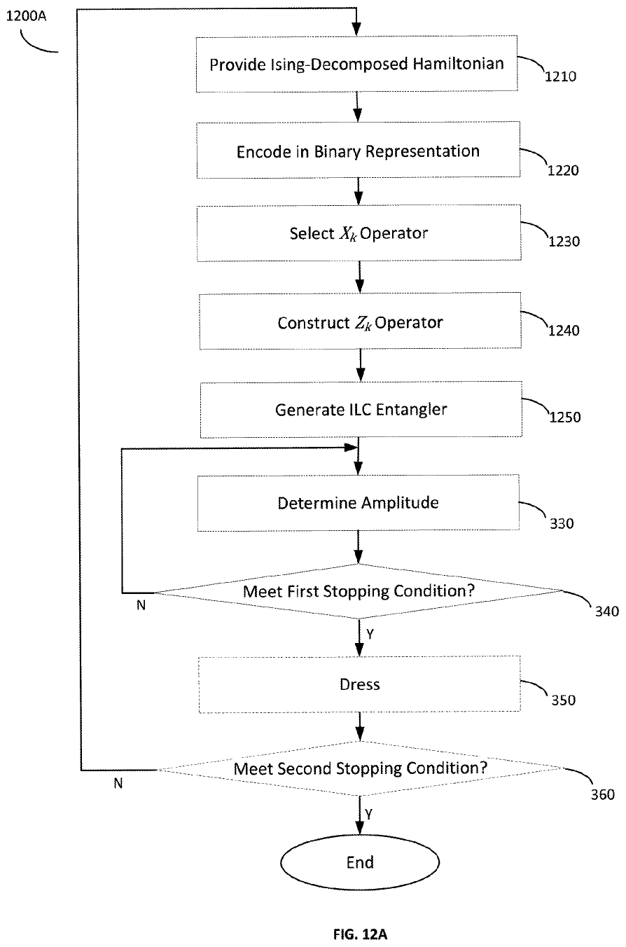

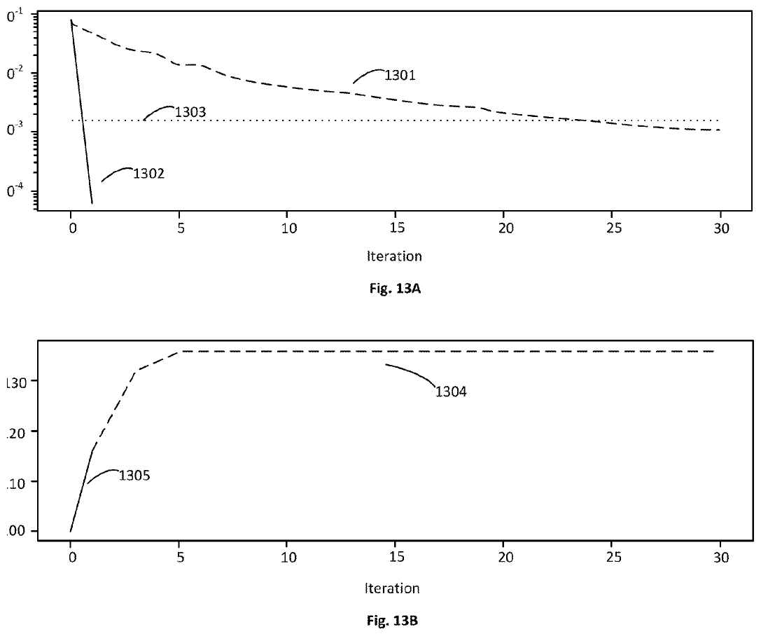

FIGS. 13A and 13B show comparison of iQCC procedures using nₑₙₜ=1 for CAS (2e,3o) LiH at an R=2.9 Å bond length in the STO-3G basis. Entanglers that commute with the Hamiltonian were selected based on a greatest lowering in energy. One entangler was selected per iteration.

FIG. 13A shows energy error relative to experiment, in Hartrees, as a function of iteration. The curve 1301 shows the calculation without normalizers. The curve 1302 shows the calculation with normalizers. The dotted line 1303 shows a one kcal/mol error. As shown, an error below 1 kcal/mol may be achieved in two iterations when normalizers were used, while it was found that over 20 iterations were needed without normalizers.

FIG. 13B shows a number of entanglers (Pauli terms) in the Hamiltonian, as a function of iteration. The curve 1304 for the calculation without normalizers and the curve 1305 for the calculation with normalizers overlap, indicating similar scaling behavior. The scaling behavior per iteration may be improved over methods without selection of entanglers.

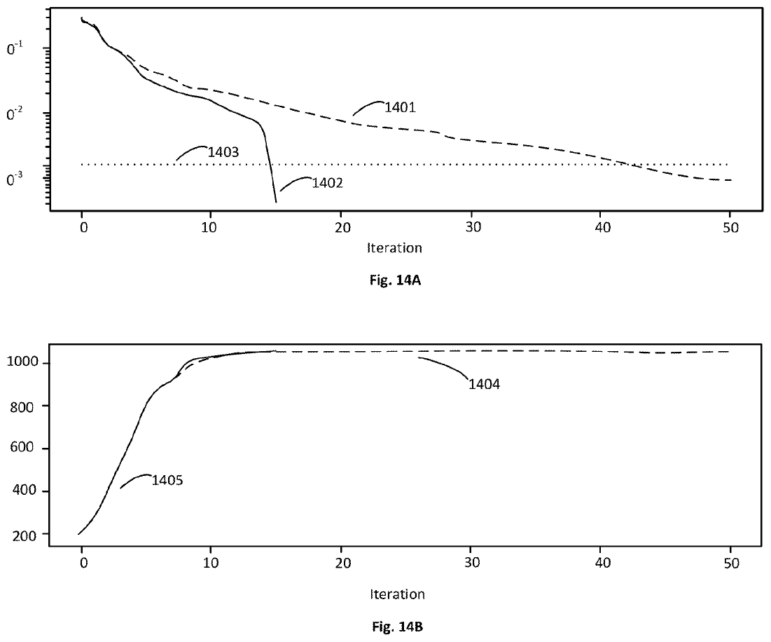

FIGS. 14A and 14B show a comparison of iQCC procedures using nₑₙₜ=1 for CAS (4e,4o) H₂O at a symmetric bond length of R=2.35 Å bond length in the 6-31 G basis. Entanglers that commute with the Hamiltonian were selected based on a greatest lowering in energy. One entangler was selected per iteration.

FIG. 14A shows energy error relative to experiment, in Hartrees, as a function of iteration. Curve 1401 shows the calculation without normalizers. Curve 1402 shows the calculation with normalizers. The dotted line 1403 shows a one kcal/mol error. As shown, an error below 1 kcal/mol may be achieved in 13 iterations when normalizers were used, while it was found that over 40 iterations were needed without normalizers.

FIG. 14B shows a number of entanglers (Pauli terms) in the Hamiltonian as a function of iteration. The curve 1404 for the calculation without normalizers and the curve 1405 for the calculation with normalizers overlap, indicating similar scaling behavior. The scaling behavior per iteration may be improved over methods without selection of entanglers.

### Classical and Quantum Computer Systems for Performing Method Actions

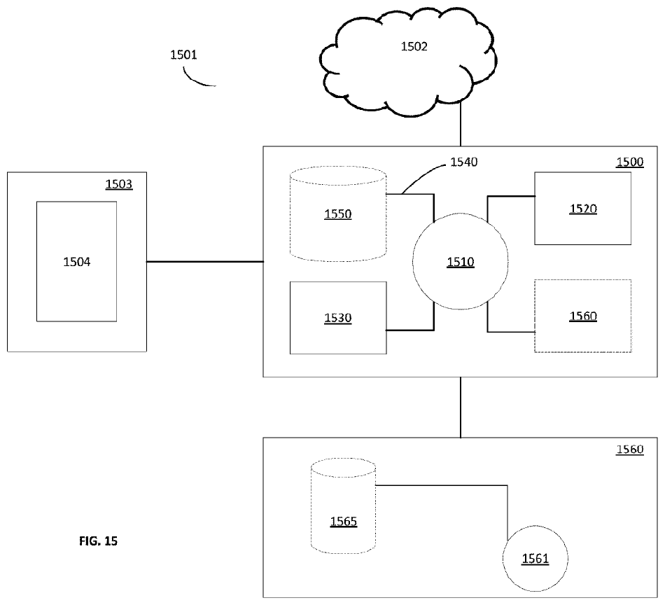

FIG. 15 is a simplified block diagram of a classical computer system 1500 and a quantum computer system 1560 illustrated within a computing and communications environment 1501, according to an example, that may be used for implementing the devices and methods disclosed herein.

In some non-limiting examples, the classical computer system 1500 may comprise a processor 1510, a memory 1520, a communication interface 1530, and a bus 1540. In some non-limiting examples, the device 1500 may comprise a storage unit 1550.

In some non-limiting examples, the classical computer system 1500 may utilize one of: all of the components shown, and only a subset thereof, and levels of integration may vary from device to device.

In some non-limiting examples, the classical computer system 1500 may comprise a plurality of instances of a component.

In some non-limiting examples, the processor 1510 may comprise a CPU, which in some non-limiting examples, may be one of: a single core processor, a multiple core processor, and a plurality of processors for parallel processing, and in some non-limiting examples, may comprise at least one of: a general-purpose processor, a dedicated application-specific specialized processor, including without limitation, a multiprocessor, a microcontroller, a RISC, a DSP, a GPU, and the like, and a shared-purpose processor. In some non-limiting examples, the processor 1510 may comprise at least one of: dedicated hardware, and hardware capable of executing software. In some non-limiting examples, the processor 1510 may be part of a circuit, including without limitation, an integrated circuit. In some non-limiting examples, at least one other component of the classical computer system 1500 may be embodied in the circuit. In some non-limiting examples, the circuit may be one of: an ASIC, and an FPGA.

The processor 1510 controls the general operation of the classical computer system 1500, in some non-limiting examples, by sending at least one of: data, and control signals, to the communication interface 1530, and by retrieving at least one of: data, and instructions, from at least one of: the memory 1520, and the storage unit 1550, to execute methods disclosed herein. Such instructions may be executed in at least one of: simultaneous, serial, and distributed fashion, by at least one processor 1510.

In some non-limiting examples, the processor 1510 may execute a sequence of one of: machine-readable, and machine-executable, instructions, which may be embodied in one of: a program, and software. In some non-limiting examples, the program may be stored in one of: the memory 1520, and the storage unit 1550. In some non-limiting examples, the program may be retrieved from one of: the memory 1520, and the storage unit 1550, and stored in the memory 1520 for ready access, and execution, by the processor 1510. The program may be directed to the processor 1510, which may subsequently configure the processor 1510 to implement methods of the present disclosure. Non-limiting examples of operations performed by the processor 1510 include at least one of: fetch, decode, execute, and writeback.

In some non-limiting examples, the program may be one of: pre-compiled, and configured for use with a machine having a processor adapted to execute the instructions and may be compiled during run-time. In some non-limiting examples, the program may be supplied in a programming language that may be selected to enable the instructions to execute in one of: a pre-compiled, interpreted, and an as-compiled, fashion.

However configured, the hardware of the processor 1510 may be configured so as to be capable of operating with sufficient software, processing power, memory resources, and network throughput capability, to handle any workload placed upon it.

The memory 1520 is a storage device configured to store data, programs, in the form of one of: machine-readable, and machine-executable, instructions, and other information accessible within the classical computer system 1500, along the bus 1540.

The memory 1520 may comprise any type of transitory and non-transitory memory, including without limitation, at least one of: persistent, non-persistent, and volatile storage, including without limitation, system memory, readable by the processor 1510, including without limitation, semiconductor memory devices, including without limitation, random access memory (RAM), static RAM (SRAM), dynamic RAM (DRAM), synchronous DRAM (SDRAM), read-only memory (ROM), programmable ROM (PROM), erasable PROM (EPROM), and electrically erasable PROM (EEPROM), and at least one buffer circuit including without limitation, at least one of: latches and flip flops. In some non-limiting examples, the memory 1520 may comprise a plurality of types of memory, including without limitation, ROM for use at boot-up, and DRAM for program and data storage for use while executing programs.

The communications interface 1530 allows the device 1500 to communicate with remote entities, including without limitation, external input and output (I/O) devices, including without limitation, across at least one of: a telecommunications network, and a data network (network) 1502, including without limitation, at least one of: the Internet, an intranet, including without limitation, one in communication with the Internet, and an extranet, including without limitation, one in communication with the Internet. In some non-limiting examples, the communications interface 1530 may comprise one of: a video adapter, including without limitation, an electronic display adapter, for coupling with I/O devices, including without limitation, a display 1503, a monitor, a liquid crystal display (LCD), and a light-emitting diode (LED), an I/O interface, including without limitation, at least one of: a parallel interface, and a serial interface, including without limitation, a universal serial bus (USB) interface, for coupling with other I/O devices, including without limitation, an input part of the display 1503, a touch screen, a printer, a keyboard, a keypad, a switch, a dial, a mouse, a trackball, a track pad, a biometric recognition (and input) device, a card reader, a paper tape reader, a camera, a sensor, a peripheral device, and a memory 1520, and a network interface, including without limitation, a network adapter, a wired network interface, including without limitation, a local area network (LAN) card, including without limitation, an ethernet card, a token ring card, and a fiber distributed data interface (FDDI) card, and a wireless network interface, including without limitation, a WIFI network interface, a modem, a modem bank, and a wireless LAN (WLAN) card, and a radio access network (RAN) interface, including without limitation, a radio transceiver card, to connect to other devices over a radio link.

In some non-limiting examples, the network 1502 may comprise at least one computer server, which may, in some non-limiting examples, comprise at least one of: a classical computer system 1500, and a quantum computer system 1560, and which, in some non-limiting examples, may enable distributed computing, including without limitation, cloud computing. In some non-limiting examples, the network 1502, with the aid of the classical computer system 1500, may implement a peer-to-peer network, which may enable devices coupled with at least one of: the classical computer system 1500, and the quantum computer system 1560, to behave as one of: a client, and a server.

In some non-limiting examples, the classical computer system 1500 may be a stand-alone device, while in some non-limiting examples, the classical computer system 1500 may be resident within a data centre. A data centre, as will be apparent to those having ordinary skill in the relevant art, is a collection of computing resources typically in the form of services) that can be used as a collective computing and storage resource. Within a data centre, a plurality of services may be coupled together to provide a computing resource pool upon which virtualized entities may be instantiated.

Data centres may be coupled with each other to form networks consisting of pooled computing and storage resources coupled with each other by connectivity resources.

The connectivity resources may take the form of physical connections such as Ethernet and optical communication links, and in some instances may comprise wireless communication channels as well. If a plurality of different data centres are coupled by a plurality of different communication channels, the links may be combined using any number of techniques, including without limitation, the formation of link aggregation groups (LAGs).

In some non-limiting examples, at least some of the computing, storage, and connectivity resources (along with other resources within the network 1502) may be divided between different sub-networks, in some cases in the form of a resource slice.

If the resources across a number of connected at least one of: data centres, and collections of nodes, are sliced, different network slices may be created.

The classical computer system 1500 may, in some non-limiting examples, be schematically thought of, and described, in terms of a number of functional units each of which has been described in the present disclosure.

In some non-limiting examples, the classical computer system 1500 may communicate with at least one remote computer system, which may, in some non-limiting examples, comprise at least one of: the classical computer system 1500, and the quantum computer system 1560, through the network 1502. In some non-limiting examples, the remote computer system may access the classical computer system 1500, and thus the quantum computer system 1560, via the network 1502.

In some non-limiting examples, the display 1503 may comprise a user interface (UI) 1504, including without limitation, a graphical user interface (GUI), and a web-based UI, for managing and organizing at least one of: inputs provided to, and outputs generated by the display 1503, including without limitation, at least one of: results, and solutions to the problems described herein.

The bus 1540 couples the components of the classical computer system 1500 to facilitate the exchange of data, programs, and other information, within the classical computer system 1500 between components thereof. The bus 1540 may comprise at least one type of bus architecture, including without limitation, a memory bus, a memory controller, a peripheral bus, a video bus, and a motherboard.

The storage unit 1550 is one of: a storage device that may, in some non-limiting examples, comprise at least one of: a solid-state memory device, a FLASH memory device, a solid-state drive, a hard disk drive, a magnetic disk drive, a magneto-optical disk, an optical memory, and an optical disk drive, and a data repository, for storing at least one of: data, including without limitation, user data, including without limitation, at least one of: user preferences, and user programs, and files, including without limitation, at least one of: drivers, libraries, and saved programs.

In some non-limiting examples, the storage unit 1550 may be distinguished from the memory 1520 in that it may perform storage tasks compatible with at least one of: higher latency, and lower volatility. In some non-limiting examples, the storage unit 1550 may be integrated with a heterogeneous memory 1520. In some non-limiting examples, the storage unit 1550 may be external to, and remote from, the classical computer system 1500, and accessible through use of the communications interface 1530.

In some non-limiting examples, the classical computer system 1500 may be embodied as at least (part of) one of: a personal computer (PC), a desktop computer, a computer workstation, a mini computer, a mainframe computer, a laptop, and a mobile electronic device, including without limitation, a tablet (slate) PC (including without limitation, at least one of: Apple® iPad and Samsung® Galaxy Tab), a mobile telephone (including without limitation, a smartphone (including without limitation, at least one of: Apple® iPhone, Android-enabled device, and Blackberry® device), an e-reader, and a personal digital assistant).

In some non-limiting examples, the quantum computer system 1560 may comprise a quantum processing unit 1561, and a quantum storage unit 1565.

In some non-limiting examples, the quantum computer system 1560, including without limitation, the quantum processing unit 1561, may comprise a number of qubits which number may be, without limitation, at least one of: 1, 2, 5, 10, 20, 50, 100, 1,000, 10,000, 100,000, 1 million, 1 billion, 1 trillion, and any number of qubits defined by a range between any two of the preceding values.

In some non-limiting examples, the quantum processing unit 1560 may execute a sequence of one of: machine-readable, and machine-executable, instructions, which may be embodied in one of: a program, and software. In some non-limiting examples, the instructions may be stored in one of: the memory 1520 and the storage unit 1550, of the classical computer system 1500, and the quantum storage unit 1565. In some non-limiting examples, the program may be directed to the quantum processing unit 1561, which may subsequently configure the quantum processing unit 1561 to implement methods of the present disclosure.

In some non-limiting examples, the quantum processing unit 1561 may be part of a circuit, including without limitation, a quantum logic circuit. In some non-limiting examples, at least one other component of at least one of: the classical computer system 1500, and the quantum computer system 1560, may be comprised in the circuit.

In some non-limiting examples, the quantum storage unit 1565 may be configured to store quantum information. In some non-limiting examples, the quantum storage unit 1565 may comprise additional qubits.

In some non-limiting examples, the classical computer system 1500 may be operably coupled with the quantum computer system 1560. In some non-limiting examples, the classical computer system 1500 may be one of: programmed, and otherwise configured, to control operation of one of: the quantum computer 1560, and a quantum processing unit 1561 within the quantum computer 1560.

In some non-limiting examples, the classical computer system 1500 may regulate various aspects of the quantum computer 1560 of the present disclosure, including without limitation, implementing a method of solving a quantum chemistry problem, including without limitation, an electronic structure problem described herein.

In some non-limiting examples, the classical computer system 1500 may perform at least one classical computation, which may comprise at least one of: precursor, intermediate, and post-processing, steps to the methods described herein.

In some non-limiting examples, the classical computer system 1500 may facilitate embedding at least one part of the Hamiltonian onto the quantum computer 1560. In some non-limiting examples, the classical computer system 1500 may do one of: set, and determine, at least one of: the bias, and the coupling, for each qubit.

In some non-limiting examples, operation of the methods and systems described herein that do not directly depend on the quantum nature of the qubit may be delegated to a classical computer as necessary.

In some non-limiting examples, the classical computer system 1500 may simulate a quantum computer.

Other components, as well as related functionality, of at least one of: the classical computer system 1500, and the quantum computer system 1560, may have been omitted in order not to obscure the concepts presented herein.

In general terms each functional unit of the present disclosure may be implemented in at least one of: hardware, software, and firmware, as the context dictates. At least one of: the processor 1510, and the quantum processing unit 1561, may thus be arranged to fetch instructions from at least one of: the memory 1520, and the storage unit 1550, (and in the case of the quantum processing unit 1561, the quantum storage unit 1565), as provided by a functional unit of the present disclosure, to execute these instructions, thereby performing any of at least one of: an action, and an operation, as were described herein.

Aspects of the systems and methods provided herein, including without limitation, the classical computer system 1500, may be embodied in programming. Various aspects of the technology may be thought of as one of: “products”, and “articles of manufacture”, typically in the form of at least one of: machine-executable instructions, including without limitation, processor-executable instructions, and associated data, that is one of: carried on, and embodied in, a type of machine-readable medium.

In some non-limiting examples, “storage”-type media may include at least one of: the tangible memory of at least one of: the classical computer system 1500, including without limitation, the processor 1510, the quantum computer system 1560, including without limitation, the quantum processor 1561, and associated modules thereof, including without limitation, at least one of: various semiconductor memories, tape drives, and disk drives, of at least one of the memory 1520, the storage unit 1550, and the quantum storage unit 1565, which may provide non-transitory storage at any time for the software programming. In some non-limiting examples, one of: all, and parts, of the software may at times be communicated through the network 1502. In some non-limiting examples, such communications may enable loading of the software from one computer, including without limitation, a processor thereof, including without limitation, one of: the classical computer system 1500, including without limitation, the processor 1510, and the quantum computer system 1560, including without limitation, the quantum processor 1561, into another computer, including without limitation, a processor thereof, including without limitation, from one of: a management server, and a host computer, into the computer platform of an application server.

In some non-limiting examples, “storage”-type media that may bear the software elements of at least one functional unit of the present disclosure, may include at least one of: optical, electrical, and electromagnetic (EM) signals, including without limitation, such signals, including without limitation, waves, used across physical interfaces between local devices, through at least one of: wired, including without limitation a baseband signal, and optical, landline networks, and over various air-links, including without limitation, a signal embodied in a carrier wave. The physical elements that carry such signals, including without limitation, at least one of: the wired links, including without limitation, electrical conductors, including without limitation, coaxial cables, and waveguides, wireless links, including without limitation, those propagating through at least one of: the air, and free space, and optical links, including without limitation, optical media, including without limitation, optical fibre, also may be considered as “storage”-type media bearing the software.

As used herein, unless expressly restricted to non-transitory, tangible “storage” media, terms, including without limitation, one of: “computer-readable medium”, and “machine-readable medium” may refer to any medium that participates in providing instructions to a processor 1510, 1561 for execution. Such signals, including without limitation, other types of signals, including without limitation, those currently used and hereafter developed, referred to herein as the transmission medium, may be generated according to several well-known methods.

In some non-limiting examples, the information contained in such signals may be ordered according to different sequences, suitable for at least one of: processing, and generating the information, and receiving the information.

In some non-limiting examples, a machine-readable medium, including without limitation, computer-executable code, may take many forms, including without limitation, at least one of: a tangible storage medium, a carrier wave medium, and a physical transmission medium.

In some non-limiting examples, non-volatile storage media may comprise one of: optical, and magnetic, disks, including without limitation, any of the storage devices 1520, 1550, 1565 in any computer system(s) 1500, 1560, including without limitation, one that may be used to implement the databases and at least some other associated components shown in the drawings.

In some non-limiting examples, volatile storage media may comprise dynamic memory, including without limitation, main memory 1520 of such a computer system 1500, 1560.

In some non-limiting examples, tangible transmission media may comprise at least one of: coaxial cables, copper wire, and fiber optics, including without limitation, the wires that comprise a bus 1540 within a computer system 1500, 1560.

In some non-limiting examples, carrier-wave transmission media may take the form of one of: electric signals, electromagnetic signals, acoustic waves, and light waves, including without limitation, those generated during radio frequency (RF) and infrared (IR) data communication.

Non-limiting example forms of computer-readable media include at least one of: a floppy disk, a flexible disk, a hard disk, a magnetic tape, any other magnetic medium, a CD-ROM, a DVD, a DVD-ROM, any other optical medium, punch cards, paper tape, any other physical storage medium with patterns of holes, a RAM, a ROM, a PROM, an EPROM, an EEPROM, a FLASH-EPROM, any other one of: a memory chip, and cartridge, a carrier wave transporting one of: data, and instructions, one of: cables, and links, transporting such a carrier wave, and any other medium from which a computer system 1500, 1560 may read one of: programming code, and data. In some non-limiting examples, many of these forms of computer-readable media may be involved in carrying at least one sequence of at least one instruction to a processor 1510, 1561 for execution.

### Definitions

In the present disclosure, it will be appreciated by those having ordinary skill in the relevant art that an organic material may comprise, without limitation, a wide variety of organic molecules, /polymers. Further, it will be appreciated by those having ordinary skill in the relevant art that organic materials that are doped with various inorganic substances, including without limitation, elements, /inorganic compounds, may still be considered organic materials. Still further, it will be appreciated by those having ordinary skill in the relevant art that various organic materials may be used, and that the processes described herein are generally applicable to an entire range of such organic materials. Still further, it will be appreciated by those having ordinary skill in the relevant art that organic materials that contain at least one of: metals, and other organic elements, may still be considered as organic materials. Still further, it will be appreciated by those having ordinary skill in the relevant art that various organic materials may be at least one of: molecules, oligomers, and polymers.

As used herein, an organic-inorganic hybrid material may generally refer to a material that may comprise both an organic component and an inorganic component. In some non-limiting examples, such organic-inorganic hybrid material may comprise an organic-inorganic hybrid compound that may comprise an organic moiety and an inorganic moiety. In some non-limiting examples, the organic-inorganic hybrid material comprises a plurality of organic moieties and a plurality of inorganic moieties.

In some non-limiting examples, the plurality of inorganic moieties may be bonded together to form a backbone, and the plurality of organic moieties may be bonded to the backbone. Non-limiting examples of such organic-inorganic hybrid compounds include those in which an inorganic scaffold is functionalized with at least one organic functional group. Non-limiting examples of such organic-inorganic hybrid materials include those comprising at least one of: a siloxane group, a silsesquioxane group, a polyhedral oligomeric silsesquioxane (POSS) group, and a phosphazene group.

In the present disclosure, a semiconductor material may be described as a material that generally exhibits a band gap. In some non-limiting examples, the band gap may be formed between a highest occupied molecular orbital (HOMO) and a lowest unoccupied molecular orbital (LUMO) of the semiconductor material. Semiconductor materials thus generally exhibit electrical conductivity that is no more than that of a conductive material (including without limitation, a metal), but that is at least that of an insulating material (including without limitation, a glass). In some non-limiting examples, the semiconductor material may comprise an organic semiconductor material. In some non-limiting examples, the semiconductor material may comprise an inorganic semiconductor material.

As used herein, an oligomer may generally refer to a material which includes at least two monomer units/monomers. As would be appreciated by a person skilled in the art, an oligomer may differ from a polymer in at least one aspect, including without limitation: (1) the number of monomer units contained therein; (2) the molecular weight; and (3) other material properties, /characteristics. In some non-limiting examples, further description of polymers and oligomers may be found in Naka K. (2014) Monomers, Oligomers, Polymers, and Macromolecules (Overview), and in Kobayashi S., Mullen K. (eds.) Encyclopedia of Polymeric Nanomaterials, Springer, Berlin, Heidelberg. As used herein, a polymer may generally refer to a material that has at least 20 repeating monomer units contained therein, whereas an oligomer may generally refer to a material that has no more than 20 repeating monomer units contained therein. In some non-limiting examples, a polymer may be considered to be a material in which removal/addition of a monomer unit has no material impact on at least one property of the material, whereas in an oligomer, removal/an addition of a monomer unit may significantly impact at least one property of the material.

An oligomer/polymer may generally include monomer units that may be chemically bonded together to form a molecule. Such monomer units may be substantially identical to one another such that at least one of: the molecule is primarily formed by repeating monomer units, and the molecule may comprise plurality different monomer units. Additionally, the molecule may comprise at least one terminal unit, which may differ from the monomer units of the molecule. An oligomer/polymer may be at least one of: linear, branched, cyclic, cyclo-linear, and cross-linked. An oligomer/polymer may comprise a plurality of different monomer units which are arranged in at least one of: a repeating pattern, and in alternating blocks of different monomer units.

In the present disclosure, an inorganic substance may refer to a substance that primarily comprises an inorganic material. In the present disclosure, an inorganic material may comprise any material that is not considered to be an organic material, including without limitation, at least one of: metals, glasses, and minerals.

In the present disclosure, the term “fullerene” may refer generally to a material comprising C molecules. Non-limiting examples of fullerene molecules comprise carbon cage molecules, including without limitation, a three-dimensional skeleton that comprises multiple C atoms that form a closed shell, and which may be, without limitation, spherical, /semi-spherical in shape. In some non-limiting examples, a fullerene molecule may be designated as Cₙ, where n may be an integer corresponding to several C atoms included in a C skeleton of the fullerene molecule. Non-limiting examples of fullerene molecules include Cₙ, where n may be in the range of 50 to 250, such as, without limitation, C₆₀, C₇₀, C₇₂, C₇₄, C₇₆, C₇₈, C₈₀, C₈₂, and C₉₄.

Additional non-limiting examples of fullerene molecules include C molecules in a tube, /cylindrical shape, including without limitation, at least one of: single-walled C nanotubes, and multi-walled C nanotubes.

### Terminology

References in the singular form may include the plural and vice versa, unless otherwise noted.

As used herein, relational terms, such as “first” and “second”, and numbering devices such as “a”, “b” and the like, may be used solely to distinguish one entity/element from another entity/element, without necessarily requiring/implying any physical/logical relationship/order between such entities/elements.

The terms “including” and “comprising” may be used expansively and in an open-ended fashion, and thus should be interpreted to mean “including, but not limited to”. The terms “example” and “exemplary” may be used simply to identify instances for illustrative purposes and should not be interpreted as limiting the scope of the invention to the stated instances. In particular, the term “exemplary” should not be interpreted to denote/confer any laudatory, beneficial, and other quality to the expression with which it is used, whether in terms of design, performance and otherwise.

Further, the term “critical”, especially when used in the expressions “critical nuclei” “critical nucleation rate”, “critical concentration” “critical cluster” “critical monomer”, “critical particle structure size”, and “critical surface tension” may be a term familiar to those having ordinary skill in the relevant art, including as relating to/being in a state in which a measurement/point at which some at least one of: quality, property and phenomenon undergoes a definite change. As such, the term “critical” should not be interpreted to denote/confer any significance/importance to the expression with which it is used, whether in terms of design, performance, and otherwise.

The terms “couple” and “communicate” in any form may be intended to mean either a direct/indirect connection through some interface, device, intermediate component, /connection, whether optically, electrically, mechanically, chemically, and otherwise.

The terms “on” and “over”, when used in reference to a first component relative to another component, and at least one of: “covering” and which “covers” another component, may encompass situations where the first component is directly on (including without limitation, in physical contact with) the other component, as well as cases where at least one intervening component is positioned between the first component and the other component.

Directional terms such as “upward”, “downward”, “left” and “right” may be used to refer to directions in the drawings to which reference is made unless otherwise stated. Similarly, words such as “inward” and “outward” may be used to refer to directions toward and away from, respectively, the geometric center of the device, area, volume and designated parts thereof. Moreover, all dimensions described herein may be intended solely to be by way of example of purposes of illustrating certain examples and may not be intended to limit the scope of the disclosure to any examples that may depart from such dimensions as may be specified.

As used herein, the terms “substantially”, “substantial”, “approximately”, and “about” may be used to denote and account for small variations. When used in conjunction with an event/circumstance, such terms may refer to instances in which the event/circumstance occurs precisely, as well as instances in which the event/circumstance occurs to a close approximation. In some non-limiting examples, when used in conjunction with a numerical value, such terms may refer to a range of variation of no more than about ±10% of such numerical value, such as at least one of no more than about: ±5%, ±4%, ±3%, ±2%, ±1%, ±0.5%, ±0.1%, and ±0.05%.

As used herein, the phrase “consisting substantially of” may be understood to include those elements specifically recited and any additional elements that do not materially affect the basic and novel characteristics of the described technology, while the phrase “consisting of” without the use of any modifier, may exclude any element not specifically recited.

Whenever the term “at least” precedes the first numerical value in a series of a plurality numerical values, the term “at least” may apply to each of the numerical values in that series of numerical values. In some non-limiting examples, at least one of: 1, 2, and 3 may be equivalent to at least one of: at least 1, at least 2, and at least 3.

Whenever the term “no more than” precedes the first numerical value in a series of a plurality of numerical values, the term “no more than” may apply to each of the numerical values in that series of numerical values. In some non-limiting examples, no more than: 3, 2, and 1 may be equivalent to no more than 3, no more than 2, and no more than 1.

Certain examples herein contemplate numerical ranges. When ranges are present, the ranges may include the range endpoints. Additionally, every sub-range and value within the range may be present as if explicitly written out. The term “about” or “approximately” may mean within an acceptable error range for the particular value, which will depend in part on how the value is measured or determined, including without limitation, the limitations of the measurement system. In some non-limiting examples, “about” may mean within one of: 1, and more than 1, standard deviation, per the practice in the relevant art. In some non-limiting examples, “about” may mean a range of one of no more than about: 20%, 10%, 5%, and 1% of a given value. Where particular values are described in the application and claims, unless otherwise stated the term “about” meaning within an acceptable error range for the particular value may be assumed.

As will be understood by those having ordinary skill in the relevant art, for any and all purposes, particularly in terms of providing a written description, all ranges disclosed herein may also encompass any and all possible sub-ranges, and combinations of sub-ranges thereof. Any listed range may be easily recognized as sufficiently describing, /enabling the same range being broken down at least into equal fractions thereof, including without limitation, halves, thirds, quarters, fifths, tenths etc. As a non-limiting example, each range discussed herein may be readily broken down into a lower third, middle third, and upper third, etc.

As will be understood by those having ordinary skill in the relevant art, for any and all purposes, particularly in terms of providing a written description, all values/ranges disclosed herein that are described in terms of at least one decimal value, should be interpreted as encompassing a value/range that includes rounding error as would be understood by those having ordinary skill in the art, as determined based on the number of significant digits expressed by such decimal value. For greater certainty, the presence/absence of any additional decimal value, in the present disclosure, the same paragraph, and even the same sentence, as the first decimal value, which may have a greater/lesser number of significant digits than the first decimal value, should not be used to limit the value/range encompassed by such first decimal value, in any fashion that limits the value/range so encompassed, to a value/range that is no more than one that includes rounding error based on the number of significant digits expressed thereby.

As will also be understood by those having ordinary skill in the relevant art, all language, /terminology such as “up to”, “at least”, “at least”, “no more than”, “no more than”, and the like, may include, /refer the recited range(s) and may also refer to ranges that may be subsequently broken down into sub-ranges as discussed herein.

As will be understood by those having ordinary skill in the relevant art, a range may include each individual member of the recited range.

### General

The purpose of the Abstract is to enable the relevant patent office and the public generally, and specifically, persons of ordinary skill in the art who are not familiar with patent/legal terms/phraseology, to quickly determine from a cursory inspection, the nature of the technical disclosure. The Abstract is neither intended to define the scope of this disclosure, nor is it intended to be limiting as to the scope of this disclosure in any way.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to one of: supersede, and take precedence over, any such contradictory material.

Incorporation by reference is expressly limited to the technical aspects of the materials, systems, and methods described in the mentioned publications, patents, and patent applications and may not extend to any lexicographical definitions from the publications, patents, and patent applications. Any lexicographical definition appearing in the publications, patents, and patent applications that is not also expressly repeated in the instant disclosure should not be treated as such and should not be read as defining any terms appearing in the accompanying claims.

The structure, manufacture and use of the presently disclosed examples have been discussed above. The specific examples discussed are merely illustrative of specific ways to make and use the concepts disclosed herein, and do not limit the scope of the present disclosure. Rather, the general principles set forth herein are merely illustrative of the scope of the present disclosure.

It should be appreciated that the present disclosure, which is described by the claims and not by the implementation details provided, and which can be modified by varying, omitting, adding, replacing, and in the absence of, any element(s), at least one of: limitation(s) with alternatives, and equivalent functional elements, whether specifically disclosed herein, will be apparent to those having ordinary skill in the relevant art, and may be made to the examples disclosed herein, and may provide many applicable inventive concepts that may be embodied in a wide variety of specific contexts, without straying from the present disclosure.

In particular, features, techniques, systems, sub-systems and methods described and illustrated in at least one of the above-described examples, whether described and illustrated as discrete/separate, may be combined/integrated in another system without departing from the scope of the present disclosure, to create alternative examples comprised of a (sub-)combination of features that may not be explicitly described above, including without limitation, where certain features may be omitted/not implemented. Features suitable for such combinations and sub-combinations would be readily apparent to persons skilled in the art upon review of the present application as a whole. Other examples of changes, substitutions, and alterations are easily ascertainable and could be made without departing from the spirit and scope disclosed herein.

All statements herein reciting principles, aspects, and examples of the disclosure, as well as specific examples thereof, are intended to encompass both structural and functional equivalents thereof and to cover and embrace all suitable changes in technology. Additionally, it is intended that such equivalents include both currently known equivalents as well as equivalents developed in the future, i.e., any elements developed that perform the same function, regardless of structure.

Accordingly, the specification and the examples disclosed therein are to be considered illustrative only, with a true scope of the disclosure being disclosed by the following numbered claims:

1. A method for encoding, on a classical computer, quantum information comprising at least one Kronecker product of a plurality of terms selected from: an identity matrix e, a Pauli Xmatrix, a Pauli Y matrix, and a Pauli Z matrix, wherein the at least one Kronecker product comprises a phase term, comprising actions of:
providing binary indices for each of: the Pauli Xmatrix, the Pauli Y matrix, the Pauli Z matrix, and the identity matrix e, and for the phase term, and
storing the Kronecker product in a binary representation using the binary indices.

2. The method of claim 1, wherein the phase term is selected from one of: positive (+), negative (−), imaginary (i), and negative imaginary (−i).

3. The method of claim 1, wherein the action of providing comprises assigning a two-digit code, wherein each digit in the code is one of 0 and 1.

4. The method of claim 1, wherein each of the Pauli Xmatrix, the Pauli Y matrix, the Pauli Z matrix, and the identity matrix e is assigned a different binary index that is a code selected from:
$$\begin{matrix}1 \\ 0\end{matrix} , \begin{matrix}1 \\ 1\end{matrix} , \begin{matrix}0 \\ 1\end{matrix} , and \begin{matrix}0 \\ 0\end{matrix} .$$

5. The method of claim 3, wherein a first digit and a second digit of the binary index of the Pauli Xmatrix, and the Pauli Z matrix are different.

6. The method of claim 1, wherein the binary index for Pauli Xmatrix is one of
$$\begin{matrix}1 \\ 0\end{matrix} and \begin{matrix}0 \\ 1\end{matrix} ,$$
and the binary index for Pauli Z matrix is the other of
$$\begin{matrix}1 \\ 0\end{matrix} and \begin{matrix}0 \\ 1\end{matrix} .$$

7. The method of claim 1, wherein the binary indices for the Pauli Xmatrix, the Pauli Y matrix, the Pauli Z matrix, and the identity matrix e are respectively assigned as:
$$x = \begin{matrix}1 \\ 0\end{matrix}$$
$$y = \begin{matrix}1 \\ 1\end{matrix}$$
$$z = \begin{matrix}0 \\ 1\end{matrix}$$
$$e = \begin{matrix}0 \\ 0\end{matrix}$$

8. The method of claim 2, wherein each of a positive (+) phase, a negative (−) phase, a imaginary (i) phase, and a negative imaginary (−i) phase is assigned a different binary index that is a code selected from:
$$\begin{matrix}1 \\ 0\end{matrix} , \begin{matrix}1 \\ 1\end{matrix} , \begin{matrix}0 \\ 1\end{matrix} , and \begin{matrix}0 \\ 0\end{matrix} .$$

9. The method of claim 2, wherein the binary index for the phase term is assigned as:
$$\begin{matrix}0 \\ 0\end{matrix} for a positive ( + ) phase ;$$
$$\begin{matrix}1 \\ 1\end{matrix} for a negative imaginary ( - i ) phase ;$$
$$\begin{matrix}0 \\ 1\end{matrix} for a negative ( - ) phase ; and$$
$$\begin{matrix}1 \\ 0\end{matrix} for an imaginary ( i ) phase .$$

10. The method of claim 3, wherein the binary representation comprises a set of the binary indices of the Kronecker product, including the binary index of the phase term thereof.

11. The method of claim 10, wherein the binary index of the phase term is stored as a first one in the set.

12. The method of claim 10, wherein a binary representation of the Kronecker product comprises a first array and a second array, wherein elements of the first array correspond to a first digit, and corresponding elements of the second array correspond to a second digit, of the codes for the Pauli matrices and the identity matrix.

13. The method of claim 1, further comprising actions of:
generating a set of candidate entanglers for a qubit Hamiltonian,
wherein at least one of the qubit Hamiltonian and the candidate entanglers comprises the at least one Kronecker product, such that the at least one of the qubit Hamiltonian and the candidate entanglers is encoded in the binary representation.

14. The method of claim 13, wherein the qubit Hamiltonian is in a form of a linear equation comprising at least one Pauli operator.

15. The method of claim 13, wherein the qubit Hamiltonian is an Ising-decomposed Hamiltonian.

16. The method of claim 13, wherein the set of candidate entanglers comprises at least one Pauli entangler.

17. The method of claim 13, wherein the candidate entanglers are pairwise products of each Pauli term of the qubit Hamiltonian.

18. The method of claim 13, wherein the candidate entanglers comprise a set of Involutory Linear Combination (ILC) entanglers expressed as A={\hat{T}₁, \hat{T}₂, . . . }, subject to:
$${( {\sum }_{{\hat{T}}_{i} ϵ 𝒜} {α}_{i} {\hat{T}}_{i} )}^{2} = \hat{1} ;$$
$$and$$
$${Σ}_{i} {α}_{i}^{2} = 1$$
where:
a sum of the square of coefficients constitutes a normalized vector,
all the entanglers \hat{T}ᵢ∈A are mutually anti-commutative, and
the entangler \hat{T}ᵢ is a Pauli word.

19. A method of generating a set of Involutory Linear Combination (ILC) entanglers using a classical computer, comprising actions of:
providing a provided Hamiltonian comprising Pauli words;
encoding the Pauli words in a binary representation provided by claim 1;
selecting at least one Xₖ operator, where Xₖ is a Pauli X string comprising only X Pauli terms;
constructing at least one Zₖ operator; and
generating the set of ILC entanglers from the at least one Xₖ operator and the at least one Zₖ operator;
wherein the provided Hamiltonian is an Ising-decomposed Hamiltonian.

20. The method of claim 19, wherein the set of ILC entanglers is expressed as A={\hat{T}₁, \hat{T}₂, . . . }, subject to:
$${( {\sum }_{{\hat{T}}_{i} ϵ 𝒜} {α}_{i} {\hat{T}}_{i} )}^{2} = \hat{1} ;$$
$$and$$
$${Σ}_{i} {α}_{i}^{2} = 1$$
where:
a sum of the square of coefficients constitutes a normalized vector,
all the entanglers \hat{T}ᵢ∈A are mutually anti-commutative, and
the entangler \hat{T}ᵢ is a Pauli word.

21. The method of claim 20, wherein the Ising-decomposed Hamiltonian is given by:
$$H = {I}_{0} + {Σ}_{k = 0} {I}_{k} ( Z ) {X}_{k}$$
where:
Iₖ(Z) is a qubit Hamiltonian in a Pauli polynomial form comprising only Pauli Z terms.

22. The method of claim 21, wherein the action of encoding comprises an action of mapping the Pauli words to vectors of 0 and 1.

23. The method of 22, wherein the action of encoding comprises an action of arranging the operators of Xₖ in the binary representation into a matrix M, such that the columns of M are bit strings for the operators of Xₖ.

24. The method of claim 23, wherein the action of selecting comprises an action of converting the matrix M to a reduced row-echelon form M_{rref}.

25. The method of claim 24, wherein the action of converting comprises converting rows of the matrix M into a set of Pauli elementary operators.

26. The method of claim 19, wherein the action of constructing comprises constructing the at least one Zₖ operator in an operator form.

27. The method of claim 19, wherein the action of constructing is based on the at least one Xₖ operators selected.

28. The method of claim 19, wherein the action of constructing comprises actions of:
building binary vectors of the at least one Zₖ operator for each primary and secondary column in M_{rref}, and
changing the binary vectors back to its operator form in a matrix representation using the binary encoding.

29. The method of claim 19, wherein the action of generating comprises an action of: deriving the ILC entanglers from the at least one selected Xₖ operator and the at least one constructed Zₖ operator.

30. The method of claim 19, wherein the Ising-decomposed Hamiltonian provides a variational upper bound for a target eigenvalue thereof; the method further comprising actions of:
determining, at a quantum computer operably coupled with the classical computer, corresponding amplitudes of the ILC entanglers, as a first iteration of the method;
repeating the first iteration of the action of determining, until a first stopping condition has been met.

31. The method of claim 30, wherein the action of determining comprises an action of, if the first stopping condition has been met, obtaining a first expectation value of the provided Hamiltonian based on the set of ILC entanglers and the determined amplitude obtained in a current instance of the first iteration, and wherein the first expectation value gives an estimate of the target eigenvalue of the provided Hamiltonian.

32. The method of claim 30, further comprising actions of:
dressing the provided Hamiltonian, at the classical computer, to obtain a transformed Hamiltonian using the set of ILC entanglers and the determined amplitudes, wherein the transformed Hamiltonian forms the provided Hamiltonian, wherein at least the actions of providing, encoding, selecting, constructing, generating, determining; repeating, and dressing form a second iteration of the method; and
restarting the second iteration by returning to the action of providing, using the transformed Hamiltonian as the provided Hamiltonian, until a second stopping condition has been met.

33. The method of claim 32, wherein the action of restarting comprises an action of, if the second stopping condition has been met, calculating a second expectation value of the provided Hamiltonian based on the transformed Hamiltonian obtained in a current instance of the second iteration, and wherein the second expectation value gives an estimate of the target eigenvalue of the provided Hamiltonian.

34. A method for selecting a set of normalizing entanglers for a provided Hamiltonian comprising at least one Pauli term, the method comprising, at a classical computing system, actions of:
generating a set of candidate entanglers,
calculating a value of a commutator of each candidate entangler with the qubit Hamiltonian, and
selecting a set of normalizing entanglers,
wherein the provided Hamiltonian is a qubit Hamiltonian.

35.-47. (canceled)

48. A method of solving a problem using a quantum computer operably coupled with a classical computing system, comprising actions of:
providing, at the classical computing system, a provided Hamiltonian, wherein an expectation value of the provided Hamiltonian provides a variational upper bound for a target eigenvalue thereof;
selecting, at the classical computing system, a set of entanglers;
determining, at the quantum computer, corresponding amplitudes of the entanglers, as a first iteration of the method;
repeating the first iteration of the action of determining, until a first stopping condition has been met;
wherein the provided Hamiltonian is a qubit Hamiltonian.

49.-76. (canceled)

77. A quantum computer comprising:
a plurality of qubits;
a qubit Hamiltonian; and
a quantum circuit comprising a set of quantum logic gates to perform gate operations;
wherein the quantum logic gates are constructed based at least on a set of entanglers comprising at least one of:
at least one entangler selected from a Direct Interaction Set (DIS);
at least one entangler that commutes with every term of the Hamiltonian; and
at least one entangler selected from an Involutory Linear Combination (ILC) set.

78.-79. (canceled)
